(19) United States
(12) Patent Application Publication
(10) Pub. No.: US 2024/0156091 A1
(43) Pub. Date: May 16, 2024

(54) WATER DISPERSIBLE GRANULE ACYLHYDRAZONE APYRASE INHIBITOR FORMULATION

(71) Applicant: Texas Crop Science, Inc., Austin, TX (US)

(72) Inventors: Jeffrey D. Fowler, Austin, TX (US); Simon Hiebert, Austin, TX (US)

(21) Appl. No.: 18/384,266

(22) Filed: Oct. 26, 2023

Related U.S. Application Data
(60) Provisional application No. 63/419,635, filed on Oct. 26, 2022.

(51) Int. Cl. A01N 37/28; A01N 25/04; A01N 25/12; A01N 25/24; A01P 3/00

(52) U.S. Cl. CPC A01N 37/28; A01N 25/04; A01N 25/12; A01N 25/24; A01P 3/00

(57) ABSTRACT

Disclosed herein are embodiments of a water-dispersible granule (and compositions/formulations thereof), comprising a first active compound having a structure

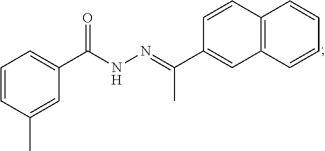 [SMILES: C/C(=N\NC(=O)c1cccc(C)c1)c1ccc2ccccc2c1]

a dispersant, and optionally, a dust suppressant.

### CROSS REFERENCE TO RELATED APPLICATION

This application claims the benefit of the earlier filing date of U.S. provisional patent application No. 63/419,635, filed Oct. 26, 2022, which is incorporated herein by reference in its entirety.

### FIELD

The present disclosure relates to a water dispersible granule comprising an apyrase inhibitor and methods for its use, in particular in the treatment of crops susceptible to pathogens.

### BACKGROUND

Crops are plagued worldwide by a variety of pathogens. Pathogens, such as insects, mites, nematodes, weeds and fungi have developed an array of mechanisms for surviving pesticides, such as by sequestering, exporting or detoxifying them. There is a need for formulations to potentiate the efficacy of pesticides by blocking certain mechanisms of resistance.

### SUMMARY

Disclosed herein is a water-dispersible granule, comprising: particles of a first agriculturally active compound having a structure

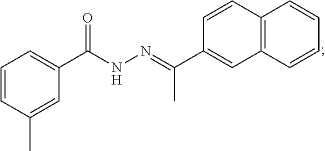 [SMILES: C/C(=N\NC(=O)c1cccc(C)c1)c1ccc2ccccc2c1]

a dispersant; and
optionally a dust suppressant; wherein the particles of the first active compound have a volume-weighted median particle size ranging from greater than 0.01 microns to 20 microns.

In one embodiment, the water-dispersible granule includes particles of the first agriculturally active compound that are present in an amount ranging from 5 wt % to 90 wt %, 0.5 wt % to 15 wt %, from 30 wt % to 85 wt %, from 30 wt % to 40 wt %, or from 70 wt % to 85 wt %.

In one embodiment of the disclosed water-dispersible granule, the dispersant is present in an amount ranging from 1 wt % to 30 wt %, such as from about 2 wt % to about 15 wt %, or from about 3 wt % to about 20 wt %, in particular, about 1 wt % about 3 wt %, about 5 wt %, about 10 wt %, or about 20 wt %.

In certain embodiments, the dispersant is a high molecular weight dispersant.

In one embodiment of the disclosed water-dispersible granule, the dispersant has a molecular weight ranging from 400 Daltons to 2,000,000 Daltons, such as a molecular weight ranging from 1,000 Daltons to 100,000 Daltons. Suitable dispersants for use in the present water-dispersible granule include anionic dispersants, cationic dispersants, non-ionic dispersants, and combinations thereof. In certain embodiments, the dispersant is selected from a homo-polymeric dispersant, a random or statistical copolymer, a block copolymer, or a combination thereof. In particular examples, the dispersant is selected from polyacrylic acid, polyvinyl alcohol, polyvinyl pyrrolidone, polystyrene sulfonate, polyvinyl sulfonate, polyethyleneimine, polyethylene glycol/polyisobutylene succinic acid, vinylpyrrolidone/vinylcaprolactam, polyethyleneoxide/polypropyleneoxide, fatty acid/polyethyleneoxide, polyethoxylated alcohols, polyethoxylated diamines, naphthalene sulfonate formaldehyde condensate, lignosulfonate, ethoxylated lignosulfonate, or a combination thereof.

In one embodiment of the disclosed water-dispersible granule, a dust suppressant is included. In one such embodiment, the dust suppressant is a liquid or a low-melting point solid. In particular embodiments, the dust suppressant is selected from a surfactant, a wax, a natural oil, a chemically-modified natural oil, a low-volatility organic solvent, or a combination thereof.

In further embodiments, the water-dispersible granule disclosed herein may additionally include a binding agent. By way of example, the binding agent in some embodiments is present in an amount ranging from 5 wt % to 30 wt %, such as from 10 wt % to 25 wt %. In one embodiment, the water-dispersible granule includes a binding agent is selected from a compound having a melting point above 100° C. and that is fully dissolved in water during the granulation process.

Exemplary embodiments of a water-dispersible granule also optionally include one or more inert carriers, diluents, or combinations thereof. In certain such embodiments, the inert carrier or diluent is included in an amount sufficient to make up a weight balance of the water-dispersible granule to a total of 100 wt %. In particular embodiments, the inert carrier or diluent is selected from starch, wood flour, cellulose, chemically-modified cellulose, or a mineral material. Suitable mineral materials include clay, mica, perlite, talc, gypsum, silica, alumina, chalk, diatomaceous earth alone or in combination with other mineral materials, other carriers or diluents, or both.

In certain embodiments, the water-dispersible granule contains an antifoam. In certain such embodiments, the antifoam is an emulsion of silicone oil. In an embodiment of the water-dispersible granule disclosed herein, the antifoam is present in an amount ranging from 0.01 wt % to 1 wt %.

In one embodiment of the water-dispersible granule, the particles of the first agriculturally active compound are milled prior to granulation such that the particles have a volume-weighted median particle size ranging from greater than 0.01 microns to 10 microns. In one embodiment, the particle size is measured by light scattering after dilution and dispersion of the particles into water, ranging from greater than 0.01 microns to 10 microns, such as from greater than 0.01 microns to 5 microns, or from greater than 0.01 microns to 2 microns. In one embodiment, the particle size is about 1 micron or less, such as less then about 1 micron, from 0.01 micron to about 15 microns, such as from about 1 micron to about 15 microns, or from about 1 micron to about 7 microns.

In one embodiment of the water-dispersible granule disclosed herein, the granule includes
(a) particles of a first agriculturally active compound having a structure

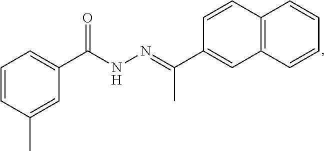 [SMILES: C/C(=N\NC(=O)c1cccc(C)c1)c1ccc2ccccc2c1]

the particles being present in an amount ranging from 5 wt % to 85 wt %; and
(b) 0.5 wt % to 15 wt % of a dust-suppressant selected from a surfactant, a wax, a natural oil, a chemically-modified natural oil, a low-volatility organic solvent, or a combination thereof. In a further embodiment of such a water-dispersible granule, the granule comprises from 3 wt % to 20 wt % of a high molecular weight dispersant. In embodiments of such water-dispersible granules the particles of the first agriculturally active compound have a volume-weighted median particle size below 20 microns, such as about 15 microns or below, about 10 microns or below, about 7 microns or below, such as below about 2 microns, such as those particles having a volume-weighted median particle size of about 1 micron.

The water-dispersible granule disclosed herein in some embodiments further includes an additional agriculturally active compound. Examples of an additional agriculturally active compound may be selected from a fungicide, pesticide, herbicide, insecticide, molluscicide, nematocide. And in particular embodiments, more than one additional agriculturally active compound is included in the disclosed water-dispersible granule, such that combinations of additional agriculturally active compounds are included.

By way of example, in certain embodiments, an additional agriculturally active compound included in a water-dispersible granule disclosed herein is a fungicide, such as a fungicide selected from a benzimidazole fungicide, a dicarboximide fungicide, a phenylpyrrole fungicide, an anilinopyrimidine fungicide, a hydroxyanilide fungicide, a carboxamide fungicide, a phenyl amide fungicide, a phosphonate fungicide, a cinnamic acid fungicide, an oxysterol binding protein inhibitor (OSBPI) fungicide, a triazole carboxamide fungicide, a carbamate fungicide, a Group 27 fungicide, a benzamide fungicide, a demethylation-inhibiting piperazine fungicide, a demethylation inhibiting pyrimidine fungicide, a demethylation inhibiting azole fungicide, a morpholine fungicide, a Group U6 fungicide, a Group 50 fungicide, a strobilurin fungicide, quinoline fungicide, an inorganic fungicide, a copper ammonium complex fungicide, a sulfur fungicide, a lime sulfur fungicide, an ethylenebisdithiocarbamate (EBDC) fungicide, an EBDC-like fungicide, an aromatic hydrocarbon fungicide, a chloronitrile fungicide, a phthalimide fungicide, a Qol fungicide, a Oil fungicide, a guanidine fungicide, a polyoxin fungicide, a Group 29 fungicide, a thiazolidine fungicide, or a combination thereof.

More particularly when an additional agriculturally active compound included in the present water-dispersible granule is a fungicide, particularly useful fungicides for use include those selected from benomyl, thiabendazole, thiophanate-methyl, iprodione, vinclozolin, fludioxonil, cyprodinil, pyrimethanil, fenhexamid, fenpyrazamine, boscalid, carboxin, fluopyram, flutolanil, fluxapyroxad, inpyrfluxam, isofetamid, oxycarboxin, penthiopyrad, pydiflumetofen, solatenol (benzovindiflupyr), mefenoxam, metalaxyl, oxadixyl, aluminum tris, Phosphorous Acid, dimethomorph, mandipropamid, oxathiapiprolin, ethaboxam, cymoxanil, propamocarb, fluopicolide, triforine, fenarimol, imazalil, triflumizole, cyproconazole, difenoconazole, fenbuconazole, flutriafol, mefentrifluconazole, metconazole, ipconazole, myclobutanil, propiconazole, prothioconazole, tebuconazole, tetraconazole, triadimefon, triadimenol, triticonazole, piperalin, spiroxamine, cyflufenamid, metrafenone, pyriofenone, azoxystrobin, famoxadone, fenamidone, fluoxastrobin, kresoxim-methyl, mandestrobin, picoxystrobin, pyraclostrobin, trifloxystrobin, quinoxyfen, bordeaux, copper ammonium complex, copper hydroxide, copper oxide, copper oxychloride, copper sulfate, sulfur, Ca polysulfides, mancozeb, maneb, metiram, ferbam, thiram, ziram, dicloran (DCNA), etridizole, pentachloronitrobenzene, chlorothalonil, captan, dodine, cyazofamid, polyoxin, fluazinam, flutianil, or a combination thereof.

In particular embodiments, water is added to the water-dispersible granule disclosed herein. In one embodiment the water-dispersible granule is present in the composition in an amount sufficient to enhance the biological effect of the additional agriculturally active compound, such that the total amount of the additional agriculturally active compound in the composition that is applied to crops or agricultural produce is lower than would typically be required and/or recommended to provide the same biological effect in a composition that does not comprise the water-dispersible granule.

Particularly useful in the compositions and methods disclosed herein are additional agriculturally active compounds that are fungicides, such as those selected from a benzimidazole fungicide, a dicarboximide fungicide, a phenylpyrrole fungicide, an anilinopyrimidine fungicide, a hydroxyanilide fungicide, a carboxamide fungicide, a phenyl amide fungicide, a phosphonate fungicide, a cinnamic acid fungicide, an oxysterol binding protein inhibitor (OSBPI) fungicide, a triazole carboxamide fungicide, a carbamate fungicide, a Group 27 fungicide, a benzamide fungicide, a demethylation-inhibiting piperazine fungicide, a demethylation inhibiting pyrimidine fungicide, a demethylation inhibiting azole fungicide, a morpholine fungicide, a Group U6 fungicide, a Group 50 fungicide, a strobilurin fungicide, quinoline fungicide, an inorganic fungicide, a copper ammonium complex fungicide, a sulfur fungicide, a lime sulfur fungicide, an ethylenebisdithiocarbamate (EBDC) fungicide, an EBDC-like fungicide, an aromatic hydrocarbon fungicide, a chloronitrile fungicide, a phthalimide fungicide, a Qol fungicide, a guanidine fungicide, a polyoxin fungicide, a Group 29 fungicide, a thiazolidine fungicide, or a combination thereof.

The disclosed compositions typically are applied to a plant, a part of a plant, a seed, soil where a plant is or will be growing, or soil where a seed has been or will be sown. In one embodiment the application site is selected as being at risk of fungal growth or already has fungal growth.

In one embodiment, the water-dispersible granules disclosed herein comprise particles of the first active compound having a volume-weighted median particle size, as measured by light scattering after dilution and dispersion of the WDG into water, ranging from greater than 0.01 to 20 microns. The water-dispersible granules may also comprise an inert carrier and/or a diluent. Also disclosed are agricultural compositions comprising the water-dispersible granules and methods of using the same. The compositions may also comprise an agriculturally active compound, such as a an acaricide, antimicrobial, fungicide, herbicide, insecticide, molluscicide, or nematicide, or a combination thereof; and an antifoam.

The foregoing and other objects, features, and advantages of the present disclosure will become more apparent from the following detailed description, which proceeds with reference to the accompanying figures.

### DETAILED DESCRIPTION

### I. Overview of Terms

The following explanations of terms and methods are provided to better describe the present disclosure and to guide those of ordinary skill in the art in the practice of the present disclosure. The singular forms “a,” “an,” and “the” refer to one or more than one, unless the context clearly dictates otherwise. The term “or” refers to a single element of stated alternative elements or a combination of two or more elements, unless the context clearly indicates otherwise. As used herein, “comprises” means “includes.” Thus, “comprising A or B,” means “including A, B, or A and B,” without excluding additional elements. All references, including patents and patent applications cited herein, are incorporated by reference in their entirety, unless otherwise specified.

Unless otherwise indicated, all numbers expressing quantities of components, molecular weights, percentages, temperatures, times, and so forth, as used in the specification or claims, are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is expressly recited.

Unless explained otherwise, all technical and scientific terms used herein have the same meaning as commonly understood by one of ordinary skill in the art to which this disclosure pertains. Although methods and materials similar or equivalent to those described herein can be used in the practice or testing of the present disclosure, suitable methods and materials are described below. The materials, methods, and examples are illustrative only and not intended to be limiting.

“Administering” refers to any suitable mode of administration, to control a pathogen, such as a fungal pathogen, including, treatment of an extant crop, seeds, soil or combination thereof.

“In combination with” refers to the administration of compounds either simultaneously in a single administration, or sequentially in two or more different administrations, that may be separated either in time, location, or method.

“Control” with reference to a pathogen, such as a fungal pathogen, means block, inhibit and/or eradicate a pathogen and/or prevent the pathogen from damaging a crop. In one embodiment, control refers to the reduction of one or more pathogen, such as a fungi, to undetectable levels, or to the reduction or suppression of a pathogen to acceptable levels as determined by one of ordinary skill in the art (for example, a crop grower). Determinations of acceptable levels of pathogen reduction are based on a number of factors, including to the crop, pathogen, severity of the pathogen, use restrictions, economic thresholds and other factors known to those of ordinary skill in the art.

As used herein, the term “potentiator” refers to a compound or compounds disclosed herein that enhance the effects of a pesticide. Without limitation to theory, potentiator compounds disclosed herein may function by blocking one or more pathways by which a pathogen, such as a fungal pathogen, evades toxicity, such as by detoxifying, sequestering or transporting a pesticide. In certain embodiments, potentiator compounds disclosed herein inhibit enzymatic apyrase activity which leads to the enhancement, accentuation or potentiation of a pesticide, such as an acaricide, antimicrobial, fungicide, herbicide, insecticide, molluscicide and/or nematicide. For example, when the potentiator compound is used in conjunction with a fungicide, the combination of the potentiator and the fungicide enhances the fungicidal effect of the fungicide and/or renders a fungus that has become resistant to the fungicide susceptible to the fungicide as a result of the activity of the potentiator. Most often, these potentiators do not themselves inhibit the growth of a pathogen, such as a fungus, itself, nor do they have a detrimental effect on a living organism that is (or could be) infected with a pathogen.

As used herein, the term “treatment” refers to a method used to administer or apply an effective amount of a disclosed compound or formulation thereof to a target area of a field and/or plant. The treatment method can be, but is not limited to, aerosol spray, pressure spray, fogging, chemigation, direct watering, and dipping. Target areas of a plant could include, but are not limited to, the leaves, roots, stems, buds, flowers, fruit, seed of the plant, and bulbs of the plant including bulb, corm, rhizoma, stem tuber, root tuber and rhizophore. Treatment can include a method wherein a plant is treated in one area (for example, the root zone or foliage) and another area of the plant becomes protected (for example, foliage is treated when a disclosed compound is applied in the root zone or new growth when applied to foliage).

As used herein, the term “water dispersible granules,” or “WDGs,” refers to dry, solid formulations that are in granular form and comprise a potentiator compound as disclosed herein. WDGs typically have larger average particle sizes than particles of a wettable powder and thus emit less dust and are flowable. WDGs disperse and/or dissolve when added to water to provide a fine particle suspension of the potentiator compound. WDGs can be stored as formulations and can be provided to the market and/or end user without further processing. In practical application, WDGs are prepared for application by the end user. Typically, WDGs are mixed with water in the end user's spray tank to provide a fine particle suspension at a concentration suitable for the particular application. The concentration can vary by crop, pathogen, time of year, geography, local regulations, and intensity of infection among other factors. Once mixed with water at the desired concentration, the resulting fine particle suspension can be applied, such as by spraying.

### II. Formulation

A common goal for formulators of agricultural products is to maximize the biological activity of the active ingredient. In wettable powders and WDGs, typical types of solid formulation, this is particularly challenging because the solid state of the active ingredient tends to limit biological availability and/or such powders are inhalation hazards and/or are not easily applied. Without being limited by a theoretical understanding, it currently is believed that factors that can determine biological activity include the solubility in water (including how that varies with temperature, salinity and pH at the site of application), the solubility in hydrophobic domains (including within waxy leaf cuticles and any micellar surfactant domains), the crystal lattice energy, the density of the active ingredient crystals and therefore their tendency to sediment, the existence of crystal polymorphs and metastable states, the diffusivity in water, the ability of the active ingredient to diffuse through the plant cuticle, the location of the site where the active ingredient acts, and the required concentration of the active ingredient at that site. A large number of modifications are potentially discoverable by the formulator to overcome limitations in biological activity, and many of these modifications have influences that are dependent upon each other (meaning that testing each of them separately does not adequately inform about outcomes when each are varied simultaneously) and it is therefore not feasible to explore the entire experimental space.

Amongst formulations tested during work described in the present disclosure, the inventors have discovered that aqueous suspensions of (E)-3-methyl-N′-(1-(naphthalen-2-yl) ethylidene)benzohydrazide generally have poor biological activity. It has been further discovered that, with water dispersible granules (or “WDGs”) containing the components described herein, the biological activity is greatly improved by controlling the particle size of the (E)-3-methyl-N′-(1-(naphthalen-2-yl) ethylidene)benzohydrazide within a particular size range.

A common requirement for the formulator of agricultural products is to achieve acceptable stability, both in the sense of chemical stability (meaning that no significant chemical degradation occurs of the active ingredient) and also in the sense of physical stability (meaning that in commonly-available product containers stored in conditions commonly-encountered in the supply chain, the product remains in a state similar to that in which it was manufactured and the product is suitable and convenient for use by the end-user). Whether a particular active ingredient is susceptible to chemical degradation is not predictable because of the large number of factors that can determine its behavior. These include the solubility of the active ingredient in any liquid phases present (including the hydrophobic phases of any surfactant micellar structures), the presence within those liquid phases of chemical species that may catalyze degradation, any tendency for the active ingredient to undergo auto-catalysis whereby the breakdown products accelerate further reaction, the presence of chemical bonds within the active ingredient that are susceptible to cleavage and the influence of neighboring groups upon their susceptibility. Physical stability also must be assessed empirically, although it is known in the art that certain small-scale laboratory tests can often adequately represent behavior at larger scale in commercial use.

Amongst formulations tested during work described in the present disclosure, the inventors discovered that aqueous suspensions of (E)-3-methyl-N′-(1-(naphthalen-2-yl) ethylidene)benzohydrazide generally have unacceptable chemical stability. It was further discovered that, with WDGs containing the required components described below, acceptable chemical stability is obtained by controlling the pH within a particular range and by controlling the concentrations of certain components that appear to catalyze degradation. Additionally, it was discovered that WDGs containing the components described herein have adequate physical stability and remain suitable for use even when subjected to stress testing at elevated temperatures, including temperatures that might be experienced by a commercial product during transport, storage, and use.

Disclosed herein are WDGs (and formulations thereof) comprising a first agriculturally active compound having a structure

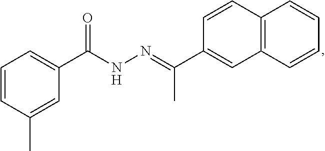 [SMILES: C/C(=N\NC(=O)c1cccc(C)c1)c1ccc2ccccc2c1]

also known as (E)-3-methyl-N′-(1-(naphthalen-2-yl) ethylidene)benzohydrazide.

In some embodiments, the WDGs comprise the first agriculturally active compound in addition to a dispersant and a dust-suppressant. In yet additional embodiments, the WDGs can be formulated to comprise a binding agent, an inert carrier, an antifoam, a diluent, or combinations thereof.

In some embodiments, the WDGs are formulated to provide a fine particle suspension upon mixing with water, such as by an end user. In particular embodiments, the first agriculturally active compound and the dispersant are intimately mixed together to provide a matrix forming the WDGs. The first agriculturally active compound can be fully or partially covered with the dispersant. A dust suppressant can also be present within the matrix or it can exist as a coating on the WDGs.

A. First Agriculturally Active Compound

The WDGs comprise the first agriculturally active compound, (E)-3-methyl-N′-(1-(naphthalen-2-yl) ethylidene)benzohydrazide, in an amount sufficient such that, when prepared for use (such as when combined with water), the first agriculturally active compound is present in an amount sufficient to potentiate the efficacy of one or more agricultural active compounds that may be applied in combination with the first agriculturally active compound. In some embodiments, the WDGs comprise an amount of the first agriculturally active compound ranging from 1 wt % to 90 wt % or more of the first agriculturally active compound, such as 5 wt % to 90 wt %, or 5 wt % to 85 wt %, or 10 wt % to 85 wt %, or 20 wt % to 85 wt %, or 30 wt % to 85 wt %. In particular embodiments, the WDGs comprise an amount of the first agriculturally active compound ranging from 5 wt % to 90 wt %, such as 30 wt % to 85 wt %, or 30 wt % to 40 wt %, or 70 wt % to 85 wt %.

In some embodiments, at least a portion of the first agriculturally active compound is present as particles in the WDGs. Particles of the first agriculturally active compound that are present in the WDGs can have a volume-weighted median particle size, as measured by light scattering after dilution and dispersion of the WDG into water, ranging from greater than zero microns to 40 microns, such as 0.01 microns to 40 microns, or 0.01 microns to 30 microns, 0.01 microns to 25 microns, 0.01 microns to 20 microns, 0.01 microns to 15 microns, 0.01 microns to 10 microns, 0.01 microns to 5 microns, or 0.01 microns to 2 microns. In particular embodiments, particles of the first agriculturally active compound that are present in the WDGs can have a volume-weighted median particle size, as measured by light scattering after dilution and dispersion of the WDG into water, ranging from 1 micron to 20 microns, such as 1 micron to 15 microns, or 2 microns to 10 microns, or 4 microns to 8 microns.

B. Dispersant

The dispersant used to form the WDGs of the present disclosure typically is a high molecular weight dispersant. In some embodiments, the dispersant can have a molecular weight of 400 Daltons or more, such as from 400 Daltons to 2,000,000 Daltons, or from 500 Daltons to 1,000,000 Daltons, or from 750 Daltons to 750,000 Daltons, or from 750 Daltons to 500,000 Daltons, or from 1,000 Daltons to 250,000 Daltons, or from 1,000 to 100,000 Daltons. In particular embodiments, the dispersant has a molecular weight ranging from 1,000 to 100,000 Daltons.

In some embodiments, the WDGs comprise from greater than zero to 40 wt % of the dispersant, such as 0.1 wt % to 40 wt % or more, or from 0.5 wt % to 35 wt %, or from 1 wt % to 30 wt %, or from 3 wt % to 20 wt % of the dispersant. In particular embodiments, the dispersant is present in an amount ranging from 1 wt % to 30 wt %, such as from 3 wt % to 20 wt %.

In any embodiments, the dispersant can be selected from anionic dispersants, cationic dispersants, non-ionic dispersants, or combinations thereof. In some embodiments, the dispersant is, or comprises, an anionic dispersant. In other embodiments, the dispersant is, or comprises, a non-ionic dispersant. In any embodiments, the dispersant may be a low-metal content dispersant, such as a low sodium dispersant, low calcium dispersant, low potassium dispersant, or a combination thereof. In yet additional embodiments, the dispersant may be a low-metal content non-ionic dispersant, such as a low sodium non-ionic dispersant, low calcium non-ionic dispersant, low potassium non-ionic dispersant, or a combination thereof.

In any embodiments, the dispersant may be selected from one or more of the following:
homo-polymeric dispersants, such as, but not limited to, polyacrylic acid, polyvinyl alcohol, polyvinyl pyrrolidone, polystyrene sulfonate, polyvinyl sulfonate, polyethyleneimine, or a combination thereof;
random or statistical copolymers, such as, but not limited to, polyethylene glycol/polyisobutylene succinic acid, vinylpyrrolidone/vinylcaprolactam, or a combination thereof;
block copolymers, such as, but not limited to, polyethyleneoxide/polypropyleneoxide, fatty acid/polyethyleneoxide, polyethoxylated alcohols, polyethoxylated diamines, or a combination thereof;
naphthalene sulfonate formaldehyde condensate;
lignosulfonate;
ethoxylated lignosulfonate;
or any combination of the above-mentioned components.

C. Dust Suppressant

One optional component of the presently disclosed WDGs is a dust suppressant. The dust suppressant used in the WDGs typically is in the form of a liquid or a low-melting point solid. In some embodiments, the low-melting point solid is a compound that exists as a solid at ambient temperature but that exists as a liquid at temperatures above ambient temperature, such as at temperatures above 30° C., or temperatures above 35° C., or temperatures above 40° C. In particular embodiments, the dust suppressant can be selected from a surfactant, a wax, a natural oil, a chemically-modified natural oil, or a low-volatility organic solvent.

Dust suppressant surfactants useful in the present WDGs can be a low molecular weight surfactant, such as a surfactant having a molecular weight ranging from 150 Daltons to less than 1,200 Daltons.

The dust suppressant surfactant may be an anionic surfactant, a cationic surfactant, a nonionic surfactant, a quaternary ammonium surfactant, a zwitterionic surfactant, or a combination thereof. In some embodiments, the surfactant is an anionic surfactant, a cationic surfactant, a nonionic surfactant, or a combination thereof.

In any embodiments, the anionic surfactant is a citrate, carbonate, phosphate, phosphonate, sulfate, or sulfonate. The anionic surfactant may be an ester of an alcohol, alcohol alkoxylate (for example, an alcohol ethoxylate and/or alcohol propoxylate), tristyryl phenol ethoxylate, fatty acid, natural oil, or a combination thereof. In certain embodiments, the anionic surfactant is a citrate, carbonate, phosphate, phosphonate, sulfate, or sulfonate ester of an alcohol, alcohol alkoxylate, tristyryl phenol ethoxylate, fatty acid, or natural oil, or any combination thereof. In a particular embodiment, the dust suppressant surfactant includes a lignosulfonate, such as dust suppressant surfactants including a mixture of lignosulfate and urea.

Suitable cationic surfactants for use as dust suppressants may include an ethoxylated amine, such as an ethoxylated amine of a natural oil, alcohol, fatty acid, or a combination thereof.

Suitable nonionic surfactants may include an alkoxylate of an alcohol, natural oil, synthetic oils, or a combination thereof, such as an ethoxylate and/or propoxylate of an alcohol, oil, or a combination thereof.

Suitable quaternary ammonium surfactants may comprise at least one chain having at least 6 carbon atoms attached to the quaternary ammonium head group, such as from 6 to 20 carbon atoms, or from 6 to 12 carbon atoms.

And in some embodiments, a zwitterionic surfactant used as a dust suppressant herein comprises a positively charged group, such as a quaternary ammonium group, and a negatively charged group, such as a carboxylic acid moiety, sulfonic acid moiety, or a phosphoric acid moiety. An example of a zwitterionic surfactant is cocamidopropyl betaine.

In certain embodiments, the surfactant is an anionic surfactant, and may be selected from a phosphate, phosphonate, sulfate, or sulfonate ester of an alcohol, alcohol ethoxylate, tristyryl phenol ethoxylate, fatty acid, or natural oil, or any combination thereof.

In other embodiments, the surfactant is a nonionic surfactant, and may be selected from an alkoxylate of an alcohol, natural oil, or a combination thereof.

Particularly with respect to surfactants, a person of ordinary skill in the art understands that an alkoxylate group (for example, ethoxylate or propoxylate) may include one or more than one alkoxy moiety (i.e., may be polyalkoxylated), such as from 1 to 200 or more alkoxy moieties. And in some embodiments, an alkoxylate group includes from more than one to 200 alkoxy groups, such as from 4 to 200, or from 4 to 150 alkoxy groups.

Additional dust suppressants useful in the presently disclosed WDGs include waxes, such as, but not limited to, a petroleum wax or a natural or plant-based wax, natural oils, such as, but not limited to, a vegetable oil or an animal-based oil. In certain embodiments the natural oil used as a dust suppressant is soybean oil, corn oil, olive oil, cotton seed oil, rapeseed oil, linseed oil or any other seed or nut oil, castor oil, pine oil, tallow or any combination thereof. Additional oils useful as dust suppressants in the presently disclosed WDGs include chemically-modified oils, such as, but not limited to, methylated soybean oil, methyl oleate or any combination thereof.

Low-volatility organic solvents also are useful as dust suppressants herein. Examples of such low-volatility organic solvents include, without limitation, paraffin or other mineral oils, tris-ethyl-hexyl phosphate, methyl-, ethyl-, propyl- or butyl-benzoate, or any other known plasticizer, or any combination thereof.

Without limitation to theory, it is understood that the mechanism of action of the dust suppressant is that while in a liquid state, the dust suppressant physically absorbs and weakly binds any fine particles onto the larger granule particles. Although the fine particles are therefore not strictly part of the granules and can be physically removed using special equipment such as an air-jet sieve, they are substantially prevented from forming airborne dust. Airborne dust may be monitored by one of several ways known to one skilled in the art, such as by an air-jet sieve, or by observing or collecting the amount of material left suspended in air when a sample of WDG is allowed to fall in a container or air-column.

The dust suppressant can be present in the WDGs in an amount ranging from greater than zero to 25 wt %, such as 0.1 wt % to 20 wt %, or 0.5 wt % to 20%, or 0.5 wt % to 15 wt %. In particular embodiments, the dust suppressant is present in an amount ranging from 0.5 wt % to 15 wt % or from about 0.1 wt % to about 2 wt %.

D. Optional Additives

In some embodiments, the WDGs themselves, or the WDG formulation, can further comprise one or more additional components, such as a binding agent, an antifoam, an inert carrier, a diluent, or a combination thereof.

Suitable binding agents can include, but are not limited to, compounds that typically exist as solids at room temperature and that have a melting point greater than 100° C. Binding agents also typically are fully dissolved in water during the granulation process. In some embodiments, a dispersant as described herein can also serve as a binding agent. In some such embodiments, two (or more) dispersant compounds can be used, or a single dispersant can be used. In yet additional embodiments, a binding agent that is not a dispersant can be used. In such embodiments, sugars (e.g., ribose, xylose, glucose, fructose, mannose, sucrose, maltose, isomaltose, trehalose, xylitol, mannitol, sorbitol, dextrose, galactose, lactose, maltodextrin, saccharose, or a combination thereof), cellulose derivatives, synthetic and natural gums, synthetic polymers, and the like can be used as the binding agent. In some embodiments, the binding agent can be selected from polyvinyl acetate, methyl cellulose, hydroxy methyl cellulose or other modified forms of cellulose, animal protein glue, guar gum or modified guar gum, or a combination thereof in particular embodiments, such binding agents can be used in amounts ranging from 5 wt % to 30 wt %, such as 5 wt % to 25 wt %, or 10 wt % to 25 wt %.

Suitable inert carriers and diluents can include, but are not limited to, compounds that typically exist as solid materials (e.g., fine powders) and that have a melting point greater than 100° C. In some embodiments, inert carriers and diluents are not appreciably soluble in water and do not influence biological activity. Exemplary inert carriers and diluents can be selected from starch, wood flour, cellulose, chemically-modified cellulose, minerals (e.g., clay, mica, perlite, talc, gypsum, silica, alumina, chalk, diatomaceous earth, and the like), and combinations thereof. Inert carriers and/or diluents can be used in an amount sufficient to make up a weight balance of the water-dispersible granule to a total of 100 wt %.

In some embodiments, the formulation comprises one or more antifoam. The antifoam may be selected to reduce or prevent foaming during manufacture, handling, and/or use of the formulation. In some embodiments, the antifoam is an emulsion of a silicone oil. In some embodiments, the antifoam is present in an amount ranging from 0.01 wt % to 1.0 wt %.

E. Additional Agriculturally Active Compound and Compositions

The WDG formulation may further comprise an additional agriculturally active compound (that is, in addition to the (E)-3-methyl-N′-(1-(naphthalen-2-yl) ethylidene)benzohydrazide included in the WDGs). Additionally, or alternatively, the WDGs may be used in combination with one or more agriculturally active compounds, typically as part of an agricultural composition for application to a crop, seeds that may be sown to produce a crop, harvested produce, and/or soil into which a crop has been or may be planted or sown. The agricultural composition may be a fine particle suspension composition, formed, at least in part, by combining the disclosed WDGs (or formulation thereof) with a suitable solvent or mixture of solvents, such as (but not limited to) water.

Embodiments of the disclosed WDGs are useful for enhancing the effect of a variety of agriculturally active compounds, including fungicides, antiviral agents, bactericides, herbicides, insecticidal/acaricidal agents, molluscicides, nematicides, pesticides, plant control agents, synergistic agents, fertilizers, and soil conditioners.

In one embodiment, the presently disclosed WDGs are useful for enhancing the fungicidal effect of a variety of fungicides. Fungicides for use with the disclosed WDGs can include, without limitation, those set forth by class in Table 1.

TABLE 1

| Family & Group # | Common Names | Trade Names (Combination Products) |
|---|---|---|
| Benzimidazole (Group 1) | benomyl | Benlate, Tersan 1991 |
| | thiabendazole | Arbotect 20-S, Decco Salt No. 19, LSP |
| | | Flowable Fungicide, Mertect 340-F |
| | thiophanate-methyl | Cavalier, Cleary's 3336, OHP 6672, Regal |
| | | SysTec, Tee-Off, |
| | | T-Methyl 4.5F AG, TM 85, Topsin M |
| Dicarboximide (Group 2) | iprodione | Epic 30, Ipro, Meteor, Nevado, OHP Chipco |
| | | 26019, Rovral, (Interface) |
| | vinclozolin | Curalan, Ronilan |
| Phenylpyrroles (Group 12) | fludioxonil | Cannonball, Emblem, Maxim, Medallion, |
| | | Mozart, Scholar, Spirato, (Academy, Miravis |
| | | Prime, Palladium, Switch) |
| Anilinopyrimidines (Group 9) | cyprodinil | Vangard (Palladium, Switch, Inspire Super) |
| | pyrimethanil | Penbotec, Scala, (Luna Tranquility) |
| Hydroxyanilide (Group 17) | fenhexamid | Decree, Elevate, Judge |
| | fenpyrazamine | Protexio |
| Carboxamide (Group 7) | boscalid | Emerald, Endura, (Encartis, Honor, Pageant, |
| | | Pristine) |
| | carboxin | Vitavax |
| | fluopyram | Luna Privilege, Velum Prime (Broadform, |
| | | Luna Experience, Luna Sensation, Luna |
| | | Tranquility, Propulse) |
| | flutolanil | Contrast, Moncut, ProStar |
| | fluxapyroxad | (Lexicon, Merivon, Orkestra) |
| | inpyrfluxam | Excalia |
| | isofetamid | Kenja |
| | oxycarboxin | Carboject, Plantvax |
| | penthiopyrad | Fontelis, Velista, Vertisan |
| | pydiflumetofen | Miravis, Posterity, Miravis Ace A (Miravis |
| | | Neo, Miravis Prime, Miravis Duo, Miravis Top) |
| | solatenol | Aprovia (Contend A, Elatus, Mural) |
| | (benzovindiflupyr) | |
| Phenylamide (Group 4) | mefenoxam | Apron, Ridomil Gold, Subdue MAXX, |
| | | (Quadris Ridomil Gold, Uniform) |
| | metalaxyl | Acquire, Allegiance, MetaStar, Ridomil, |
| | | Sebring, Subdue |
| | oxadixyl | Anchor |
| Phosphonate (Group P7) | aluminum tris | Aliette, Flanker, Legion, Signature, Areca |
| | Phosphorous Acid | Agri-Fos, Alude, Appear, Fiata, Fosphite, |
| | | Phospho Jet, Phostrol, Rampart, Reload |
| Cinnamic acid (Group 40) | dimethomorph | Forum, Stature, (Orvego, Zampro) |
| | mandipropamid | Micora, Revus, (Revus Top) |
| OSBPI (Group 49) | oxathiapiprolin | Segovis |
| Triazoles carboxamide | ethaboxam | V-10208 |
| (Group 22) | | |
| Group 27 | cymoxanil | Curzate, (Tanos) |
| Carbamate (Group 28) | propamocarb | Banol, Previcur, Proplant, Tattoo |
| Benzamide (Group 43) | fluopicolide | Adorn, Presidio |

Demethylation-inhibiting (Group 3)

| | | |
|---|---|---|
| Piperazines | triforine | Funginex, Triforine |
| Pyrimidines | fenarimol | Focus, Rubigan, Vintage |
| Imidazole | imazalil | Fungaflor, (Raxil MD Extra) |
| | triflumizole | Procure, Terraguard, Trionic |
| Triazoles | cyproconizole | Sentinel |
| | difenoconazole | Dividend, Inspire, (Academy, Briskway, |
| | | Contend A, Inspire Super, Quadris Top, |
| | | Revus Top) Miravis Duo |
| | fenbuconazole | Enable, Indar |
| | flutriafol | Topguard, (Topguard EQ) |
| | mefentrifluconazole | Maxtima (Navicon) |
| | metconazole | Quash, Tourney |
| | ipconazole | Rancona |
| | myclobutanil | Eagle, Hoist, Immunox, Laredo, Nova, Rally, |
| | | Sonoma, Systhane |
| | propiconazole | Alamo, Banner, Break, Bumper, Infuse, |
| | | Kestrel Mex, Miravis Ace B, PropiMax, |
| | | ProPensity, Strider, Tilt, Topaz, (Aframe Plus, |
| | | Concert, Contend B, Headway, Quilt Xcel, |
| | | Stratego) |
| | prothioconazole | Proline (Propulse) |
| | tebuconazole | Bayer Advanced, Elite, Folicur, Lynx, Mirage, |
| | | Orius, Raxil, Sativa, Tebucon, |
| | | Tebuject, Tebusha, Tebustar, Toledo, |
| | | (Absolute, Luna Experience, |
| | | Unicorn), etc. |
| | tetraconazole | Mettle |
| | triadimefon | Bayleton, Strike, (Armada, Tartan, Trĺigo) |
| | triadimenol | Baytan |
| | triticonazole | Charter, Trinity, (Pillar) |
| Morpholine (Group 5) | piperalin | Pipron |
| | spiroxamine | Accrue |
| Group U6 | cyflufenamid | Torino |
| Group 50 | metrafenone | Vivando |
| | pyriofenone | Prolivo |
| Qol Strobilurins (Group 11) | azoxystrobin | Abound, Aframe, Dynasty, Heritage, Protété, |
| | | Quadris, Quilt, (Aframe Plus, |
| | | Briskway, Contend B, Dexter Max, Elatus, |
| | | Headway, Mural, Quadris Top, |
| | | Quilt Xcel, Renown, Topguard EQ, Uniform) |
| | femoxadone | (Tanos) |
| | fenamidone | Fenstop, Reason |
| | fluoxastrobin | Aftershock, Disarm, Evito, Fame |
| | kresoxim-methyl | Cygnus, Sovran |
| | mandestrobin | Intuity, Pinpoint |
| | picoxystrobin | Aproach |
| | pyraclostrobin | Cabrio, Empress, Headline, Insignia, |
| | | Stamina, (Honor, Lexicon, Merivon, |
| | | Navicon, Orkestra, Pageant, Pillar, Pristine) |
| | trifloxystrobin | Compass, Flint, Gem, (Absolute, Armada, |
| | | Broadform, Interface, Luna Sensation, |
| | | Stratego, Tartan, Trigo) |
| Quinoline (Group 13) | quinoxyfen | Quintec |

Inorganic Compounds

| | | |
|---|---|---|
| Coppers (Group M1) | bordeaux | None |
| | copper ammonium | Copper Count-N |
| | complex | |
| | copper hydroxide | Champ, Champion, Kalmor, Kentan, Kocide, |
| | | Nu-Cop |
| | copper oxide | Nordox |
| | copper oxychloride | C—O—C—S, Oxycop |
| | copper sulfate | Cuprofix Disperss, many others |
| Sulfur (Group M2) | sulfur | Cosavet, Kumulus, Microthiol |
| | | Disperss, Thiosperse |
| Lime sulfur | Ca polysulfides | Lime Sulfur, Sulforix |
| Ethylenebisdithiocarbamates | mancozeb | Dithane, Fore, Penncozeb, Protect, Manex, |
| (EBDC) (Group M3) | | Manzate, Roper, Wingman, (Dexter Max, |
| | | Gavel) |
| | maneb | Maneb |
| | metiram | Polyram |
| EBDC-like (Group M3) | ferbam | Carbamate, Ferbam |
| | thiram | Difiant, Spotrete, Thiram |
| | ziram | Ziram |
| Aromatic Hydrocarbon | dicloran (DCNA) | Allisan, Botran |
| (Group 14) | etridizole | Terrazole, Truban |
| | pentachloronitrobenzene | Autilus, Defend, Engage, PCNB, Terraclor, |
| | | (Premion) |
| Chloronitrile (Group M5) | chlorothalonil | Bravo, Daconil, Docket, Echo, Ensign, |
| | | Exotherm Termil, Funginil, Legend, |
| | | Manicure, Pegasus, Terranil, (Concert, |
| | | Spectro) |
| Phthalimides (Group M4) | captan | Captan |
| Guanidines (Group U12) | dodine | Syllit |
| Qil fungicides (Group 21) | cyazofamid | Ranman, Segway |
| Polyoxin (Group 19) | polyoxin | Affirm, Endorse, Oso, Ph-D, Tavano, Veranda |
| Group 29 | fluazinam | Omega, Secure |
| Thiazolidine (U13) | flutianil | Gatten |

Fungicides are cataloged more broadly by the Fungicide Resistance Action Committee (FRAC) in the FRAC Code List 2022 and reproduced in Appendix 1 and which is incorporated herein by reference in its entirety.

In one embodiment, the disclosed WDGs are used in combination with one or more compound from the Families or Groups set forth in Table 1, Appendix 1, or both. In certain embodiments, the WDGs are used in combination with one or more fungicides recited in column 1 of Table 1.

In particular embodiments, the disclosed WDGs are used in combination with one or more fungicides selected from a benzimidazole fungicide, a dicarboximide fungicide, a phenylpyrrole fungicide, an anilinopyrimidine fungicide, a hydroxyanilide fungicide, a carboxamide fungicide, a phenyl amide fungicide, a phosphonate fungicide, a cinnamic acid fungicide, an oxysterol binding protein inhibitor (OSBPI) fungicide, a triazole carboxamide fungicide, a carbamate fungicide, a Group 27 fungicide, a benzamide fungicide, a demethylation-inhibiting piperazine fungicide, a demethylation inhibiting pyrimidine fungicide, a demethylation inhibiting azole fungicide, a morpholine fungicide, a Group U6 fungicide, a Group 50 fungicide, a strobilurin fungicide, quinoline fungicide, an inorganic fungicide, a copper ammonium complex fungicide, a sulfur fungicide, a lime sulfur fungicide, an ethylenebisdithiocarbamate (EBDC) fungicide, an EBDC-like fungicide, an aromatic hydrocarbon fungicide, a chloronitrile fungicide, a phthalimide fungicide, a Oil fungicide, a guanidine fungicide, a polyoxin fungicide, a Group 29 fungicide, a thiazolidine fungicide, or a combination thereof.

Particular fungicides that are potentiated by being used in combination with the disclosed WDGs according to the methods herein can include benomyl, thiabendazole, thiophanate-methyl, iprodione, vinclozolin, fludioxonil, cyprodinil, pyrimethanil, fenhexamid, fenpyrazamine, boscalid, carboxin, fluopyram, flutolanil, fluxapyroxad, inpyrfluxam, isofetamid, oxycarboxin, penthiopyrad, pydiflumetofen, solatenol (benzovindiflupyr), mefenoxam, metalaxyl, oxadixyl, aluminum tris, Phosphorous Acid, dimethomorph, mandipropamid, oxathiapiprolin, ethaboxam, cymoxanil, propamocarb, fluopicolide, triforine, fenarimol, imazalil, triflumizole, cyproconazole, difenoconazole, fenbuconazole, flutriafol, mefentrifluconazole, metconazole, ipconazole, myclobutanil, propiconazole, prothioconazole, tebuconazole, tetraconazole, triadimefon, triadimenol, triticonazole, piperalin, spiroxamine, cyflufenamid, metrafenone, pyriofenone, azoxystrobin, famoxadone, fenamidone, fluoxastrobin, kresoxim-methyl, mandestrobin, picoxystrobin, pyraclostrobin, trifloxystrobin, quinoxyfen, bordeaux, copper ammonium complex, copper hydroxide, copper oxide, copper oxychloride, copper sulfate, sulfur, Ca polysulfides, mancozeb, maneb, metiram, ferbam, thiram, ziram, dicloran (DCNA), etridizole, pentachloronitrobenzene, chlorothalonil, captan, dodine, cyazofamid, polyoxin, fluazinam, flutianil, or a combination thereof.

In some embodiments, the combined treatment with a selected fungicide and the disclosed WDGs provides synergistic fungicidal activity against plant pathogenic fungi.

In some embodiments, the disclosure provides compositions and methods of treating plants or plant seeds infected with or at risk of being infected with a fungal pathogen. In some such embodiments, compositions of the present disclosure comprise a formulation of a fungicide, the disclosed WDGs, and a phytologically acceptable carrier. In another embodiment, the fungicide and WDGs are administered in separate compositions. In further embodiments, an agricultural or horticultural fungicide is used in combination with other compounds in addition to the disclosed WDGs. Such other compounds can be administered in the same or separate compositions as the fungicide and/or the WDGs. Examples of the other components include known carriers to be used to conduct formulation. Additional examples thereof include herbicides known in the art, insecticidal/acaricidal agents, nematodes, soil pesticides, plant control agents, synergistic agents, fertilizers, soil conditioners, and animal feeds. In one embodiment, the inclusion of such other components yields synergistic effects on crop growth.

In particular embodiments, the disclosed WDGs are used to potentiate the effect of an herbicide. Exemplary herbicides for use in combination with the formulation are known to those in the art and include, without limitation, those described in Appendix 2. By way of example, suitable herbicides for use in combination with the disclosed WDGs include, but are not limited to, inhibitors of acetyl CoA synthase, inhibitors of acetolactate synthesis, inhibitors of microtubule assembly, inhibitors of microtubule organization, auxin mimics, photosynthesis inhibitors, deoxy-D-xylulose phosphate synthase inhibitors, enolpyruvyl shikimate phosphate synthase inhibitors, phytoene desaturase inhibitors, glutamine synthetase inhibitors, dihydropteroate synthesis inhibitors, protoporphyrinogen oxidase inhibitors, cellulose synthesis inhibitors, uncouplers, hydroxyphenyl pyruvate dioxygenase inhibitors, fatty acid thioesterase inhibitors, serine-threonine protein phosphatase inhibitors, solanesyl diphosphate synthase inhibitors, inhibitors of very long-chain fatty acid synthesis, homogentisate solanesyltransferase inhibitors, lycopene cyclase inhibitors, and combinations thereof.

In some embodiments, the disclosed WDGs are used to potentiate the effect of an insecticide. Exemplary insecticides for use in combination with the disclosed WDGs are known in the art and include, without limitation, those described in Appendix 3.

### III. Methods

Embodiments of a method for using the disclosed WDGs comprise combining the WDGs (or formulation and/or agricultural composition thereof) with a solvent, such as water, to form an agricultural composition suitable for application to a plant, part of a plant, a seed, soil where a plant is or will be growing, or soil where a seed has been or will be sown. The method may further comprise applying the agricultural composition to a plant, part of a plant, a seed, soil where a plant is or will be growing, or soil where a seed has been or will be sown.

In some embodiments, the disclosed agricultural composition comprises one or more agriculturally active compounds and the agricultural composition is formed by diluting the agricultural composition with a suitable solvent, such as water, to a concentration suitable for agricultural application. Optionally, one or more additional agriculturally active compounds may be added before, during, and/or after adding the water to the agricultural composition. In some embodiments, the WDG may be formulated to comprise the agriculturally active compound.

In particular embodiments, the WDGs do not comprise an agriculturally active compound, and the agricultural composition is formed by combining the WDGs with a suitable solvent, such as water, to provide a concentration suitable for agricultural use. In such embodiments, forming the agricultural composition may further comprise adding one or more agriculturally active compounds, either to water before the WDGs are added, concurrently while the WDGs are combined with water, and/or subsequently to a water-containing mixture comprising the WDGs.

In certain non-limiting embodiments, the disclosed WDGs are combined with water to provide a composition suitable for agricultural application in an amount sufficient to provide the first active compound in an amount ranging from 0.01% to 80% weight to weight in a final composition, or from 25% to 55%, such as from 30% to 50%, from 35% to 45%, such as 0.01, 0.05, 0.1, 0.5, 1.0, 1.1, 1.2, 1.3, 1.4, 1.5, 1.6, 1.7, 1.8, 1.9, 2.0, 2.5, 3.0, 4.0, 5.0, 7.5, 10, 20, 30, 40, 50, 55, 60 or 80% weight to weight in a final composition. In one embodiment the first active compound is provided in an amount ranging from 0.01% to 50%, such as from 15% to 50%, from 20% to 45%, from 25% to 40%, such as 0.01, 0.05, 0.1, 0.5, 1.0, 1.1, 1.2, 1.3, 1.4, 1.5, 1.6, 1.7, 1.8, 1.9, 2.0, 2.5, 3.0, 4.0, 5.0, 7.5, 10, 15, 20, 30, 40 or 50% volume to volume in a final composition comprising the WDGs and water.

In some embodiments, the agriculturally active compound(s) is present in the agricultural composition at a concentration that is less than a concentration of the agriculturally active compound(s) that is recommended for use in the absence of the WDGs disclosed herein, such as in the absence of (E)-3-methyl-N′-(1-(naphthalen-2-yl) ethylidene)benzohydrazide.

In some embodiments, a method of making the agricultural composition comprises adding the WDGs disclosed herein to water in an amount sufficient to potentiate the agriculturally active compound(s), and adding the agriculturally active compound(s) in amounts sufficient to provide a concentration in the agricultural composition that is less than a concentration that is recommended for use in the absence of the disclosed WDGs, such as in the absence of (E)-3-methyl-N′-(1-(naphthalen-2-yl) ethylidene)benzohydrazide. A person of ordinary skill in the art understands that the disclosed WDGs and the agriculturally active compounds may be added to water sequentially in any order, or substantially simultaneously, to form the agricultural composition.

In any embodiments, the one or more agriculturally active compounds may be a fungicide, pesticide, herbicide, insecticide, molluscicide, nematicide, or a combination thereof, as disclosed herein.

Also disclosed herein are embodiments of a method for controlling or preventing fungal growth. The method can comprise applying an agricultural composition described herein to a plant, part of a plant, a seed, soil where a plant is or will be growing, or soil where a seed has been or will be sown.

Crops that can be treated include those plagued by various pathogens, including without limitation, bacteria, viruses, fungal pathogens, mites, nematodes, molluscs, weeds or other pests, as is known to those of ordinary skill in the agricultural arts. By way of example, such agricultural and horticultural crops that can be treated according to the present disclosure include plants, whether genetically modified or not, including their harvested products, such as: cereals; vegetables; root crops; potatoes; trees such as fruit trees, for example banana trees, tea, coffee trees, or cocoa trees; grasses; lawn grass; or cotton.

Agricultural compositions comprising the disclosed WDGs may be applied to each part of plants, such as leaves, stems, patterns, flowers, buds, fruits, seeds, sprouts, roots, tubers, tuberous roots, shoots, or cuttings. The WDGs (including formulations and/or agricultural compositions thereof) may also be applied to improved varieties/varieties, cultivars, as well as mutants, hybrids, and genetically modified embodiments of these plants.

Agricultural compositions comprising the disclosed WDGs may be used to conduct seed treatment, foliage application, soil application, or water application, so as to control various diseases occurring in agricultural or horticultural crops, including flowers, lawns, and pastures.

Agricultural compositions comprising the disclosed WDGs are useful for potentiating the effects of antimicrobial agents. For example, the disclosed WDGs can be used in combination with an antimicrobial agent to combat bacterial and viral infection.

Embodiments of the disclosed WDGs are useful for potentiating the effects of herbicides. For example, the disclosed WDGs can be used in combination with one or more herbicide to control weeds or other unwanted vegetation.

Embodiments of the disclosed WDGs are useful for potentiating the effects of insecticides. For example, the disclosed WDGs can be used in combination with one or more insecticide to control insect infestation.

Embodiments of the disclosed WDGs are useful for potentiating the effects of acaricides or miticides. For example, the disclosed WDGs can be used in combination with one or more acaricidal agent to control mites.

Embodiments of the disclosed WDGs are useful for potentiating the effects of molluscicides. For example, the disclosed WDGs can be used in combination with one or more molluscicide to prevent interference of slugs or snails with a crop.

Embodiments of the disclosed WDGs are useful for potentiating the effects of nematicides. For example, the disclosed WDGs can be used in combination with one or more nematicide to prevent interference of nematodes with a crop.

Embodiments of the disclosed WDGs are particularly useful for potentiating the effects of fungicides against plant fungal pathogens. Examples of pathogens treated according to the present disclosure include, without limitation, Botrytis cinerea, Colletotrichum graminicola, Fusarium oxysporum, Sclerotiana sclerotiorum, Verticillium dahlia, Mycospharella gramincola and Sphacelotheca reliana.

Botrytis cinerea is an airborne plant pathogen with a necrotrophic lifestyle attacking over 200 crop hosts worldwide. It mainly attacks dicotyledonous plant species, including important protein, oil, fiber and horticultural crops, grapes and strawberries and also Botrytis also causes secondary soft rot of fruits and vegetables during storage, transit and at the market. Many classes of fungicides have failed to control Botrytis cinerea due to its genetic plasticity.

The genus Colletotrichum comprises ˜600 species attacking over 3,200 species of monocot and dicot plants. Colletotrichum graminicola primarily infects maize (Zea mays), causing annual losses of approximately 1 billion dollars in the United States alone (Connell et al., 2012).

Fusarium wilt of banana, caused by the soil-borne fungus Fusarium oxysporum f.sp. cubense, is a major threat to banana production worldwide. No fungicides are currently available to effectively control the disease once plants are infected (Peng J et al., 2014).

The white mold fungus Sclerotinia sclerotiorum is known to attack more than 400 host species and is considered one of the most prolific plant pathogens. The majority of the affected crop species are dicotyledonous, along with a number of agriculturally significant monocotyledonous plants. Some important crops affected by S. sclerotiorum include legumes (soybean), most vegetables, stone fruits, and tobacco.

The ascomycete Verticillium dahliae is a soil-borne fungal plant pathogen that causes vascular wilt diseases in a broad range of dicotyledonous host species. V. dahliae can cause severe yield and quality losses in cotton and other important crops such as vegetables, fibers, fruit, nut trees, forest trees and ornamental plants.

The ascomycete fungus Mycospharella gramincola (anamorph: Septoria tritici) is one of the most important foliar diseases of wheat leaves, occurring wherever wheat is grown. Yield losses attributed to this disease range from 25%-50%, and are especially high in Europe, the Mediterranean region and East Africa. Infection by M. gramincola is initiated by air borne ascopores produced on residues of last season's crop. Primary infection usually occurs after seedlings emerge in spring or fall. The mature disease is characterized by necrotic lesions on the leaves and stems of infected plants.

The basidiomycete fungus Sphacelotheca reliana infects corn (Zea mays) systemically, causing Head Smut. Yield loss attributed to the disease is variable and is directly dependent on the incidence of the disease. The fungus overwinters as diploid teliospores in crop debris or soil. Floral structures are converted to sori containing masses of powdery teliospores that resemble mature galls of common smut.

Examples of crops to be treated and plant diseases (pathogens) to be controlled using the presently disclosed compounds and compositions include, without limitation:

Sugar beet: brown spot disease (Cercospora beticola), black root disease (Aphanomyces cochlioides), root rot disease (Thanatephorus cucumeris), leaf rot disease (Thanatephorus cucumeris), and the like.

Peanut: brown spot disease (Mycosphaerella arachidis), leaf mold (Ascochyta sp.), rust disease (Puccinia arachidis), damping-off disease (Pythium debaryanum), rust spot disease (Alternaria alternata), stem rot disease (Sclerotium rolfsii), black rust disease (Mycosphaerella berkelep), and the like.

Cucumber: powdery mildew (Sphaerotheca fuliginea), downy mildew (Pseudoperonospora cubensis), gummy stem blight (Mycosphaerella melonis), wilt disease (Fusarium oxysporum), sclerotinia rot (Sclerotinia sclerotiorum), gray mold (Botrytis cinerea), anthracnose (Colletotrichum orbiculare), scab (Cladosporium cucumerinum), brown spot disease (Corynespora cassiicola), damping-off disease (Pythium debaryanum, Rhizoctonia solani Kuhn), Phomopsis root rot disease (Phomopsis sp.), Bacterial spot (Pseudomonas syringae pv. Lechrymans), and the like.

Tomato: gray mold disease (Botrytis cinerea), leaf mold disease (Cladosporium fulvum), late blight disease (Phytophthora infestans), Verticillium wilt disease (Verticillium albo-atrum, Verticillium dahliae), powdery mildew disease (Oidium neolycopersici), early blight disease (Alternaria solani), leaf mold disease (Pseudocercospora fuligena), and the like.

Eggplant: gray mold disease (Botrytis cinerea), black rot disease (Corynespora melongenae), powdery mildew disease (Erysiphe cichoracearum), leaf mold disease (Mycovellosiella nattrassii), sclerotinia rot disease (Sclerotinia sclerotiorum), Verticillium wilt disease (Verticillium dahlia), Mycosphaerella blight (Phomopsis vexans), and the like.

Strawberry: gray mold disease (Botrytis cinerea), powdery mildew disease (Sphaerotheca humuli), anthracnose disease (Colletotrichum acutatum, Colletotrichum fragariae), phytophthora rot disease (Phytophthora cactorum), soft rot disease (Rhizopus stolonifer), fusarium wilt disease (Fusarium oxysporum), verticillium wilt disease (Verticillium dahlia), and the like.

Onion: neck rot disease (Botrytis allii), gray mold disease (Botrytis cinerea), leaf blight disease (Botrytis squamosa), downy mildew disease (Peronospora destructor), Phytophthora porn disease (Phytophthora porn), and the like.

Cabbage: clubroot disease (Plasmodiophora brassicae), soft rot disease (Erwinia carotovora), black rot disease (Xanthomonas campesrtis pv. campestris), bacterial black spot disease (Pseudomonas syringae pv. maculicola, P.s. pv. alisalensis), downy mildew disease (Peronospora parasitica), sclerotinia rot disease (Sclerotinia sclerotiorum), black spot disease (Alternaria brassicicola), gray mold disease (Botrytis cinerea), and the like.

Common bean: sclerotinia rot disease (Sclerotinia sclerotiorum), gray mold disease (Botrytis cinerea), anthracnose (Colletotrichum lindemuthianum), angular spot disease (Phaeoisariopsis griseola), and the like.

Apple: powdery mildew disease (Podosphaera leucotricha), scab disease (Venturia inaequalis), Monilinia disease (Monilinia mall), black spot disease (Mycosphaerella pomi), valla canker disease (Valsa alternaria blotch disease (Alternaria mall), rust disease (Gymnosporangium yamadae), ring rot disease (Botryosphaeria berengeriana), anthracnose disease (Glomerella cingulata, Colletotrichum acutatum), leaf rot disease (Diplocarpon mall), fly speck disease (Zygophiala jamaicensis), Sooty blotch (Gloeodes pomigena), violet root rot disease (Helicobasidium mompa), gray mold disease (Botrytis cinerea), and the like.

Japanese apricot: scab disease (Cladosporium carpophilum), gray mold disease (Botrytis cinerea), brown rot disease (Monilinia), and the like.

Persimmon: powdery mildew disease (Phyllactinia kakicola), anthracnose disease (Gloeosporium kaki), angular leaf spot (Cercospora kaki), and the like.

Peach: brown rot disease (Monilinia fructicola), scab disease (Cladosporium carpophilum), phomopsis rot disease (Phomopsis sp.), bacterial shot hole disease (Xanthomonas campestris pv. pruni), and the like.

Almond: brown rot disease (Monilinia taxa), spot blotch disease (Stigmina carpophila), scab disease (Cladosporium carpophilum), red leaf spot disease (Polystigma rubrum), alternaria blotch disease (Alternaria alternata), anthracnose (Colletotrichum gloeospoides), and the like.

Yellow peach: brown rot disease (Monilinia fructicola), anthracnose disease (Colletotrichum acutatum), black spot disease (Alternaria sp.), Monilinia kusanoi disease (Monilinia kusanoi), and the like.

Grape: gray mold disease (Botrytis cinerea), powdery mildew disease (Uncinula necator), ripe rot disease (Glomerella cingulata, Colletotrichum acutatum), downy mildew disease (Plasmopara viticola), anthracnose disease (Elsinoe ampelina), brown spot disease (Pseudocercospora vitis), black rot disease (Guignardia bidwellii), white rot disease (Coniella castaneicola), rust disease (Phakopsora ampelopsidis), and the like.

Pear: scab disease (Venturia nashicola), rust disease (Gymnosporangium asiaticum), black spot disease (Alternaria kikuchiana), ring rot disease (Botryosphaeria berengeriana), powdery mildew disease (Phyllactinia mall), Cytospora canker disease (Phomopsis fukushii), brown spot blotch disease (Stemphylium vesicarium), anthracnose disease (Glomerella cingulata), and the like.

Tea: ring spot disease (Pestalotiopsis longiseta, P. theae), anthracnose disease (Colletotrichum theae-sinensis), Net blister blight (Exobasidium reticulatum), and the like.

Citrus fruits: scab disease (Elsinoe fawcettii), blue mold disease (Penicillium italicum), common green mold disease (Penicillium digitatum), gray mold disease (Botrytis cinerea), melanose disease (Diaporthe citri), canker disease (Xanthomonas campestris pv. citri), powdery mildew disease (Oidium sp.), and the like.

Wheat: powdery mildew (Blumeria graminis f. sp. tritici), red mold disease (Gibberella zeae), red rust disease (Puccinia recondita), brown snow mold disease (Pythium iwayamai), pink snow mold disease (Monographella nivalis), eye spot disease (Pseudocercosporella herpotrichoides), leaf scorch disease (Septoria glume blotch disease (Leptosphaeria nodorum), typhula snow blight disease (Typhula incarnata), sclerotinia snow blight disease (Myriosclerotinia borealis), damping-off disease (Gaeumannomyces graminis), ergot disease (Claviceps purpurea), stinking smut disease (Tilletia caries), loose smut disease (Ustilago nuda), and the like.

Barley: leaf spot disease (Pyrenophora graminea), net blotch disease (Pyrenophora teres), leaf blotch disease (Rhynchosporium secalis), loose smut disease (Ustilago tritici, U. nuda), and the like.

Rice: blast disease (Pyricularia oryzae), sheath blight disease (Rhizoctonia solani), bakanae disease (Gibberella fujikuroi), brown spot disease (Cochliobolus miyabeanus), damping-off disease (Pythium graminicola), bacterial leaf blight (Xanthomonas oryzae), bacterial seedling blight disease (Burkholderia plantarii), brown stripe disease (Acidovorax avenae), bacterial grain rot disease (Burkholderia glumae), Cercospora leaf spot disease (Cercospora oryzae), false smut disease (Ustilaginoidea virens), rice brown spot disease (Alternaria alternata, Curvularia intermedia), kernel discoloration of rice (Alternaria padwickii), pink coloring of rice grains (Epicoccum purpurascens), and the like.

Tobacco: sclerotinia rot disease (Sclerotinia sclerotiorum), powdery mildew disease (Erysiphe cichoracearum), phytophthora rot disease (Phytophthora nicotianae), and the like.

Tulip: gray mold disease (Botrytis cinerea), and the like.

Sunflower: downy mildew disease (Plasmopara halstedii), sclerotinia rot disease (Sclerotinia sclerotiorum), and the like.

Bent grass: Sclerotinia snow blight (Sclerotinia borealis), Large patch (Rhizoctonia solani), Brown patch (Rhizoctonia solani), Dollar spot (Sclerotinia homoeocarpa), blast disease (Pyricularia sp.), Pythium red blight disease (Pythium aphanidermatum), anthracnose disease (Colletotrichum graminicola), and the like.

Orchard grass: powdery mildew disease (Erysiphe graminis), and the like.

Soybean: purple stain disease (Cercospora kikuchii), downy mildew disease (Peronospora manshurica), phytophthora rot disease (Phytophthora sojae), rust disease (Phakopsora pachyrhizi), sclerotinia rot disease (Sclerotinia sclerotiorum), anthracnose disease (Colletotrichum truncatum), gray mold disease (Botrytis cinerea), Sphaceloma scab (Elsinoe glycines), melanoses (Diaporthe phaseolorum var. sojae), and the like.

Potato: hytophthora rot disease (Phytophthora infestans), early blight disease (Alternaria solani), scurf disease (Thanatephorus cucumeris), verticillium wilt disease (Verticillium albo-atrum, V. dahlia, V. nigrescens, and the like.

Banana: Panama disease (Fusarium oxysporum), Sigatoka disease (Mycosphaerella fijiensis, M. musicola), and the like.

Rapeseed: sclerotinia rot disease (Sclerotinia sclerotiorum), root rot disease (Phoma lingam), black leaf spot disease (Alternaria brassicae), and the like.

Coffee: rust disease (Hemileia vastatrix), anthracnose (Colletotrichum coffeanum), leaf spot disease (Cercospora coffeicola), and the like.

Sugarcane: brown rust disease (Puccinia melanocephala), and the like.

Corn: zonate spot disease (Gloeocercospora sorghi), rust disease (Puccinia sorghi), southern rust disease (Puccinia polysora), smut disease (Ustilago maydis), brown spot disease (Cochliobolus heterostrophus), northern leaf blight (Setosphaeria turcica), and the like.

Cotton: seedling blight disease (Pythium sp.), rust disease (Phakopsora gossypii), sour rot disease (Mycosphaerella areola), anthracnose (Glomerella gossypii), and the like.

### IV. Process

The disclosed WDGs can be made by combining a first agriculturally active compound according to the present disclosure with a dispersant and optionally a dust suppressant. In particular embodiments, the WDGs are made by combining particles of the first agriculturally active compound with the dispersant to provide granules formed of a matrix comprising the first agriculturally active compound and the dispersant. In particular embodiments, the particles of the first agriculturally active compound are milled and then blended with other optional components, such as the dispersant, followed by granulation of the resulting mixture to provide porous granules. In some other embodiments, the particles of the first agriculturally active compound are milled and granulated to form porous granules, while being bound together by and coated with the dispersant.

In some embodiments, the method comprises providing the first agriculturally active compound, the dispersant, and optionally the dust suppressant and forming the WDGs. Optionally, a binding agent, an inert carrier, a diluent, and/or agriculturally active compound also may be added. In some embodiments, the first agriculturally active compound is milled to a desired particle size, such as particle sizes described herein. A specific particle size or size range for a granule formulation, can be accomplished by milling in aqueous suspension prior to granulation, or, alternatively by a method such as air-jet milling or other methods as is known to those of skill in the art of such formulations. The first agriculturally active compound can then be granulated with the dispersant. In some embodiments, the first agriculturally active compound is granulated as the dispersant is added, followed by addition of the dust suppressant. In yet other embodiments, the first agriculturally active compound is combined with the dispersant and the mixture is granulated followed by combination with the dust suppressant. Optional components may be added at any point in making the WDGs. Any carrier or diluent present may be combined with the first agriculturally active compound before performing the granulation process, and the method of combination may be any one of several known to one skilled in the art, such as by ribbon-blending or milling the components together. The dispersant and any binding agent present may be combined with the first agriculturally active compound before performing the granulation process or may be added during the granulation process. If added before granulation, the addition may be performed by any of several methods known to one skilled in the art, such as by adding a solution or powder during or followed by ribbon-blending or kneading. If added during granulation, the addition will typically be performed by spraying or pouring a solution of the binding agent. A person of ordinary skill in the art understands that the dispersant and dust suppressant, and also any optional components such as an inert carrier, diluent, and/or agriculturally active compound, may be added in any suitable or convenient order.

The granulation process may be performed by one of several methods known to one skilled in the art, such as by extrusion, fluidized bed granulation, or pan granulation. The details of the sequence of component additions can vary as described above and as is convenient, but it is understood by one skilled in the art that fluidized bed granulation proceeds with addition of water or solvent, and subsequent evaporation of at least part of the water or solvent, during the fluidized bed process. It is also understood by one skilled in the art that extrusion and pan granulation result in the formation of granules that contain the water or solvent used during the granulation process, and that these granules require a subsequent drying step.

### V. Overview of Embodiments

Disclosed herein are embodiments of a water-dispersible granule, comprising particles of a first

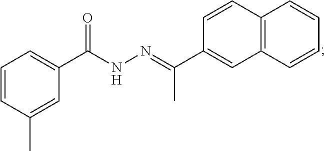 [SMILES: C/C(=N\NC(=O)c1cccc(C)c1)c1ccc2ccccc2c1]

agriculturally active compound having a structure a dispersant; and optionally a dust suppressant; wherein the particles of the first active compound have a volume-weighted median particle size ranging from greater than 0.01 microns to 20 microns. Meaning that the median diameter as measured by light scattering, is from greater than 0.01 microns to 20 microns.

In any or all embodiments, the particles of the first agriculturally active compound are present in an amount ranging from 5 wt % to 90 wt %.

In any or all embodiments, the dust suppressant is present in an amount ranging from 0.5 wt % to 15 w t %.

In any or all embodiments, the dispersant is present in an amount ranging from 1 wt % to 30 wt %.

In any or all embodiments, the particles of the first agriculturally active compound are present in an amount ranging from 30 wt % to 85 wt %.

In any or all embodiments, the particles of the first agriculturally active compound are present in an amount ranging from 30 wt % to 40 wt %.

In any or all embodiments, the particles of the first agriculturally active compound are present in an amount ranging from 70 wt % to 85 wt %.

In any or all embodiments, the dust suppressant is a liquid or a low-melting point solid.

In any or all embodiments, the dust suppressant is selected from a surfactant, a wax, a natural oil, a chemically-modified natural oil, a low-volatility organic solvent, or a combination thereof.

In any or all embodiments, the dispersant is a high molecular weight dispersant.

In any or all embodiments, the dispersant has a molecular weight ranging from 400 Daltons to 2,000,000 Daltons.

In any or all embodiments, the dispersant has a molecular weight ranging from 1,000 Daltons to 100,000 Daltons.

In any or all embodiments, the dispersant is an anionic dispersant, a cationic dispersant, a non-ionic dispersant, or a combination thereof.

In any or all embodiments, the dispersant is an anionic dispersant.

In any or all embodiments, the dispersant is a nonionic dispersant.

In any or all embodiments, the dispersant is selected from a homo-polymeric dispersant, a random or statistical copolymer, a block copolymer, or a combination thereof.

In any or all embodiments, the dispersant is selected from polyacrylic acid, polyvinyl alcohol, polyvinyl pyrrolidone, polystyrene sulfonate, polyvinyl sulfonate, polyethyleneimine, polyethylene glycol/polyisobutylene succinic acid, vinylpyrrolidone/vinylcaprolactam, polyethyleneoxide/polypropyleneoxide, fatty acid/polyethyleneoxide, polyethoxylated alcohols, polyethoxylated diamines, naphthalene sulfonate formaldehyde condensate, lignosulfonate, ethoxylated lignosulfonate, or a combination thereof.

In any or all embodiments, the dispersant is present in an amount ranging from 3 wt % to 20 wt %.

In any or all embodiments, the water-dispersible granule further comprises a binding agent.

In any or all embodiments, the binding agent is present in an amount ranging from 5 wt % to 30 wt %.

In any or all embodiments, the binding agent is present in an amount ranging from 10 wt % to 25 wt %.

In any or all embodiments, the binding agent is selected from a compound having a melting point above 100° C. and that is fully dissolved in water during the granulation process.

In any or all embodiments, the water-dispersible granule further comprises one or more inert carriers, diluents, or combinations thereof.

In any or all embodiments, the inert carrier or diluent is included in an amount sufficient to make up a weight balance of the water-dispersible granule to a total of 100 wt %.

In any or all embodiments, the inert carrier or diluent is selected from starch, wood flour, cellulose, chemically-modified cellulose, or a mineral material.

In any or all embodiments, the mineral material is selected from clay, mica, perlite, talc, gypsum, silica, alumina, chalk, diatomaceous earth, or combinations thereof.

In any or all embodiments, the water-dispersible granule further comprises an antifoam.

In any or all embodiments, the antifoam is an emulsion of silicone oil.

In any or all embodiments, the antifoam is present in an amount ranging from 0.01 wt % to 1 wt %.

In any or all embodiments, the particles of the first agriculturally active compound are milled prior to granulation such that the particles have a volume-weighted median particle size, as measured by light scattering after dilution and dispersion of the WDG into water, ranging from greater than 0.01 microns to 10 microns.

In any or all embodiments, the particles of the first agriculturally active compound are milled prior to granulation such that the particles have a volume-weighted median particle size, as measured by light scattering after dilution and dispersion of the WDG into water, ranging from about 1 micron or less to about 15 microns.

In any or all embodiments, the particles of the first agriculturally active compound are milled prior to granulation such that the particles have a volume-weighted median particle size, as measured by light scattering after dilution and dispersion of the WDG into water, ranging from about 1 micron to about 15 microns.

In any or all embodiments, the particles of the first agriculturally active compound are milled prior to granulation such that the particles have a volume-weighted median particle size, as measured by light scattering after dilution and dispersion of the WDG into water, ranging from about 1 micron to about 7 microns.

In any or all embodiments, the particles of the first agriculturally active compound are milled prior to granulation such that the particles have a volume-weighted median particle size, as measured by light scattering after dilution and dispersion of the WDG into water, ranging from greater than 0.01 microns to 5 microns.

In any or all embodiments, the particles of the first agriculturally active compound are milled prior to granulation such that the particles have a volume-weighted median particle size, as measured by light scattering after dilution and dispersion of the WDG into water, ranging from greater than 0.01 microns to 2 microns.

In any or all embodiments, the particles of the first agriculturally active compound are milled prior to granulation such that the particles have a volume-weighted median particle size, as measured by light scattering after dilution and dispersion of the WDG into water is about 15 microns or less.

In any or all embodiments, the particles of the first agriculturally active compound are milled prior to granulation such that the particles have a volume-weighted median particle size, as measured by light scattering after dilution and dispersion of the WDG into water is about 7 microns or less.

In any or all embodiments, the particles of the first agriculturally active compound are milled prior to granulation such that the particles have a volume-weighted median particle size, as measured by light scattering after dilution and dispersion of the WDG into water is about 1 micron.

In any or all embodiments, the water-dispersible granule comprises:
(a) particles of a first agriculturally active compound having a structure

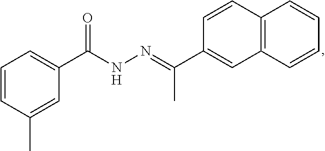 [SMILES: C/C(=N\NC(=O)c1cccc(C)c1)c1ccc2ccccc2c1]

the particles being present in an amount ranging from 5 wt % to 85 wt %;
(b) 0.5 wt % to 15 wt % of a dust-suppressant selected from a surfactant, a wax, a natural oil, a chemically-modified natural oil, a low-volatility organic solvent, or a combination thereof; and
(c) 3 wt % to 20 wt % of a high molecular weight dispersant;
wherein the particles of the first agriculturally active compound have a volume-weighted median particle below 2 microns.

Also disclosed herein are embodiments of a composition comprising a water-dispersible granule according to any or all of the above embodiments; and an additional agriculturally active compound.

In any or all embodiments, the additional agriculturally active compound is a fungicide, pesticide, herbicide, insecticide, molluscicide, nematocide or a combination thereof.

In any or all embodiments, the additional agriculturally active compound is a fungicide selected from a benzimidazole fungicide, a dicarboximide fungicide, a phenylpyrrole fungicide, an anilinopyrimidine fungicide, a hydroxyanilide fungicide, a carboxamide fungicide, a phenyl amide fungicide, a phosphonate fungicide, a cinnamic acid fungicide, an oxysterol binding protein inhibitor (OSBPI) fungicide, a triazole carboxamide fungicide, a carbamate fungicide, a Group 27 fungicide, a benzamide fungicide, a demethylation-inhibiting piperazine fungicide, a demethylation inhibiting pyrimidine fungicide, a demethylation inhibiting azole fungicide, a morpholine fungicide, a Group U6 fungicide, a Group 50 fungicide, a strobilurin fungicide, quinoline fungicide, an inorganic fungicide, a copper ammonium complex fungicide, a sulfur fungicide, a lime sulfur fungicide, an ethylenebisdithiocarbamate (EBDC) fungicide, an EBDC-like fungicide, an aromatic hydrocarbon fungicide, a chloronitrile fungicide, a phthalimide fungicide, a Qol fungicide, a Qil fungicide, a guanidine fungicide, a polyoxin fungicide, a Group 29 fungicide, a thiazolidine fungicide, or a combination thereof.

In any or all embodiments, the agriculturally active compound is a fungicide selected from benomyl, thiabendazole, thiophanate-methyl, iprodione, vinclozolin, fludioxonil, cyprodinil, pyrimethanil, fenhexamid, fenpyrazamine, boscalid, carboxin, fluopyram, flutolanil, fluxapyroxad, inpyrfluxam, isofetamid, oxycarboxin, penthiopyrad, pydiflumetofen, solatenol (benzovindiflupyr), mefenoxam, metalaxyl, oxadixyl, aluminum tris, Phosphorous Acid, dimethomorph, mandipropamid, oxathiapiprolin, ethaboxam, cymoxanil, propamocarb, fluopicolide, triforine, fenarimol, imazalil, triflumizole, cyproconazole, difenoconazole, fenbuconazole, flutriafol, mefentrifluconazole, metconazole, ipconazole, myclobutanil, propiconazole, prothioconazole, tebuconazole, tetraconazole, triadimefon, triadimenol, triticonazole, piperalin, spiroxamine, cyflufenamid, metrafenone, pyriofenone, azoxystrobin, famoxadone, fenamidone, fluoxastrobin, kresoxim-methyl, mandestrobin, picoxystrobin, pyraclostrobin, trifloxystrobin, quinoxyfen, bordeaux, copper ammonium complex, copper hydroxide, copper oxide, copper oxychloride, copper sulfate, sulfur, Ca polysulfides, mancozeb, maneb, metiram, ferbam, thiram, ziram, dicloran (DCNA), etridizole, pentachloronitrobenzene, chlorothalonil, captan, dodine, cyazofamid, polyoxin, fluazinam, flutianil, or a combination thereof.

In any or all embodiments, the composition further comprises water.

In any or all embodiments, the water-dispersible granule is present in the composition in an amount sufficient to enhance the biological effect of the additional agriculturally active compound, such that the total amount of the additional agriculturally active compound in the composition that is applied to crops or agricultural produce is lower than would typically be required and/or recommended to provide the same biological effect in a composition that does not comprise the water-dispersible granule.

In any or all embodiments, the additional agriculturally active compound is a fungicide, pesticide, herbicide, insecticide, molluscicide, nematocide or a combination thereof.

In any or all embodiments, the additional agriculturally active compound is a fungicide selected from a benzimidazole fungicide, a dicarboximide fungicide, a phenylpyrrole fungicide, an anilinopyrimidine fungicide, a hydroxyanilide fungicide, a carboxamide fungicide, a phenyl amide fungicide, a phosphonate fungicide, a cinnamic acid fungicide, an oxysterol binding protein inhibitor (OSBPI) fungicide, a triazole carboxamide fungicide, a carbamate fungicide, a Group 27 fungicide, a benzamide fungicide, a demethylation-inhibiting piperazine fungicide, a demethylation inhibiting pyrimidine fungicide, a demethylation inhibiting azole fungicide, a morpholine fungicide, a Group U6 fungicide, a Group 50 fungicide, a strobilurin fungicide, quinoline fungicide, an inorganic fungicide, a copper ammonium complex fungicide, a sulfur fungicide, a lime sulfur fungicide, an ethylenebisdithiocarbamate (EBDC) fungicide, an EBDC-like fungicide, an aromatic hydrocarbon fungicide, a chloronitrile fungicide, a phthalimide fungicide, a Qol fungicide, a Qil fungicide, a guanidine fungicide, a polyoxin fungicide, a Group 29 fungicide, a thiazolidine fungicide, or a combination thereof.

In any or all embodiments, the additional agriculturally active compound is a fungicide selected from benomyl, thiabendazole, thiophanate-methyl, iprodione, vinclozolin, fludioxonil, cyprodinil, pyrimethanil, fenhexamid, fenpyrazamine, boscalid, carboxin, fluopyram, flutolanil, fluxapyroxad, inpyrfluxam, isofetamid, oxycarboxin, penthiopyrad, pydiflumetofen, solatenol (benzovindiflupyr), mefenoxam, metalaxyl, oxadixyl, aluminum tris, Phosphorous Acid, dimethomorph, mandipropamid, oxathiapiprolin, ethaboxam, cymoxanil, propamocarb, fluopicolide, triforine, fenarimol, imazalil, triflumizole, cyproconazole, difenoconazole, fenbuconazole, flutriafol, mefentrifluconazole, metconazole, ipconazole, myclobutanil, propiconazole, prothioconazole, tebuconazole, tetraconazole, triadimefon, triadimenol, triticonazole, piperalin, spiroxamine, cyflufenamid, metrafenone, pyriofenone, azoxystrobin, famoxadone, fenamidone, fluoxastrobin, kresoxim-methyl, mandestrobin, picoxystrobin, pyraclostrobin, trifloxystrobin, quinoxyfen, bordeaux, copper ammonium complex, copper hydroxide, copper oxide, copper oxychloride, copper sulfate, sulfur, Ca polysulfides, mancozeb, maneb, metiram, ferbam, thiram, ziram, dicloran (DCNA), etridizole, pentachloronitrobenzene, chlorothalonil, captan, dodine, cyazofamid, polyoxin, fluazinam, flutianil, or a combination thereof.

Also disclosed herein are embodiments of a method of using the composition according to any or all of the above embodiments, comprising applying the composition to a plant, a part of a plant, a seed, soil where a plant is or will be growing, or soil where a seed has been or will be sown.

Also disclosed herein are embodiments of a method for controlling or preventing fungal growth, comprising applying the composition according to any or all of the above embodiments to a site that has a fungal growth or that is at risk of developing a fungal growth.

Also disclosed herein are embodiments of a method for controlling or preventing fungal growth, comprising: combining the composition according to any or all of the above embodiments with water to form a fine particle suspension comprising particles of the first agriculturally active compound; and applying the fine particle suspension to a site that has a fungal growth or that is at risk of developing a fungal growth.

In any or all embodiments, the method further comprises combining the water-dispersible granule and the additional agriculturally active compound to form the composition.

In any or all embodiments, combining the water-dispersible granule and the agriculturally active compound comprises adding an amount of the agriculturally active compound to the water-dispersible granule that is less than an amount of the agriculturally active compound that is recommended for use in the absence of the water-dispersible granule.

Also disclosed herein are embodiments of a method for making a dispersion comprising the water-dispersible granule according to any or all of the above embodiments, the method comprising: combining the water-dispersible granule with water and an additional agriculturally active compound to provide a mixture, wherein each of the water-dispersible granule and the additional agriculturally active compound is included at a concentration sufficient for providing a biological effect when the mixture is applied to agricultural crops or produce.

In any or all embodiments, the concentration of the water-dispersible granule in the mixture ranges from 0.01 wt % to 10 wt %.

In any or all embodiments, the method further comprises adding an adjuvant to the mixture.

In any or all embodiments, the additional agriculturally active compound is selected from an acaricide, a fungicide, an herbicide, an insecticide, a molluscicide, a nematocide, or a combination thereof.

In any or all embodiments, the additional agriculturally active compound is selected from a benzimidazole fungicide, a dicarboximide fungicide, a phenylpyrrole fungicide, an anilinopyrimidine fungicide, a hydroxyanilide fungicide, a carboxamide fungicide, a phenyl amide fungicide, a phosphonate fungicide, a cinnamic acid fungicide, an oxysterol binding protein inhibitor (OSBPI) fungicide, a triazole carboxamide fungicide, a carbamate fungicide, a Group 27 fungicide, a benzamide fungicide, a demethylation-inhibiting piperazine fungicide, a demethylation inhibiting pyrimidine fungicide, a demethylation inhibiting azole fungicide, a morpholine fungicide, a Group U6 fungicide, a Group 50 fungicide, a strobilurin fungicide, quinoline fungicide, an inorganic fungicide, a copper ammonium complex fungicide, a sulfur fungicide, a lime sulfur fungicide, an ethylenebisdithiocarbamate (EBDC) fungicide, an EBDC-like fungicide, an aromatic hydrocarbon fungicide, a chloronitrile fungicide, a phthalimide fungicide, a Oil fungicide, a guanidine fungicide, a polyoxin fungicide, a Group 29 fungicide, a thiazolidine fungicide, or a combination thereof.

In any or all embodiments, the additional agriculturally active compound is selected from benomyl, thiabendazole, thiophanate-methyl, iprodione, vinclozolin, fludioxonil, cyprodinil, pyrimethanil, fenhexamid, fenpyrazamine, boscalid, carboxin, fluopyram, flutolanil, fluxapyroxad, inpyrfluxam, isofetamid, oxycarboxin, penthiopyrad, pydiflumetofen, solatenol (benzovindiflupyr), mefenoxam, metalaxyl, oxadixyl, aluminum tris, Phosphorous Acid, dimethomorph, mandipropamid, oxathiapiprolin, ethaboxam, cymoxanil, propamocarb, fluopicolide, triforine, fenarimol, imazalil, triflumizole, cyproconazole, difenoconazole, fenbuconazole, flutriafol, mefentrifluconazole, metconazole, ipconazole, myclobutanil, propiconazole, prothioconazole, tebuconazole, tetraconazole, triadimefon, triadimenol, triticonazole, piperalin, spiroxamine, cyflufenamid, metrafenone, pyriofenone, azoxystrobin, famoxadone, fenamidone, fluoxastrobin, kresoxim-methyl, mandestrobin, picoxystrobin, pyraclostrobin, trifloxystrobin, quinoxyfen, bordeaux, copper ammonium complex, copper hydroxide, copper oxide, copper oxychloride, copper sulfate, sulfur, Ca polysulfides, mancozeb, maneb, metiram, ferbam, thiram, ziram, dicloran (DCNA), etridizole, pentachloronitrobenzene, chlorothalonil, captan, dodine, cyazofamid, polyoxin, fluazinam, flutianil, or a combination thereof.

### VI. Examples

### Example 1

Preparation of a Stable and Efficacious Granule by Extrusion

A sufficient quantity of the first active compound is air-milled to yield at least 100 g of material having a particle size below 1.5 microns median diameter, as measured on a Malvern Mastersizer 3000. 40 g of this powder are combined with 25 g of Tamol SN which serves as dispersant and binder, with 1 g of dust suppressant surfactant Surfonic L24-7, with 34 g of starch powder as inert filler, and with 0.1 g of antifoam SAG 1572. This composition is mixed with 50 g of water in a planetary mixer to obtain a thick paste. The paste is extruded through a screen with 1 mm openings to produce granules that are dried in a vacuum oven overnight at 60° C. Sub-samples are stored at several different temperatures and are periodically assessed for pH, appearance, dispersibility and suspension stability. It is expected that the formulation will have excellent handling properties, excellent physical stability and biological efficacy comparable to that of an aqueous suspension having particles of the first active compound at a similar size.

### Example 2

Preparation of a Stable and Efficacious Granule by Pan Granulation

40 g of the first active compound, milled as above to obtain a particle size below 1.5 microns median diameter, is combined with 25 g of Tamol SN as dispersant and binder, 34 g of Celite 545 diatomaceous earth as inert filler, and 1 g of dust suppressant surfactant Surfonic L24-7 are combined in a ribbon blender. The powder is placed on a rotating, inclined, flat-bottom pan and water is sprayed to form granules that are dried in a vacuum oven overnight at 60° C. Sub-samples are stored at several different temperatures and are periodically assessed for pH, appearance, dispersibility and suspension stability. It is expected that the formulation will have excellent physical stability, excellent handling properties, and biological efficacy comparable to that of an aqueous suspension having particles of the first active compound at a similar size.

### Example 3

Preparation of a Stable and Efficacious Granule by Fluidized Bed Granulation

255 g of the first active compound, milled as above to obtain a particle size below 1.5 microns median diameter, is placed in the chamber of a fluidized bed granulator and fluidized with an inlet air temperature of 70° C. 15 g of dispersant and binder Tamol SN and 15 g of binder Star-Dri 15 are sprayed into the chamber as a solution of 40 wt % total solids in water, followed by a spray of sufficient water to product acceptable granules. The air flow is then continued to evaporate the water, after which 15 g of dust suppressant surfactant Surfonic L24-7 is sprayed into the chamber. Sub-samples are stored at several different temperatures and are periodically assessed for pH, appearance, dispersibility and suspension stability. It is expected that the formulation will have excellent handling properties, excellent physical stability and biological efficacy comparable to that of an aqueous suspension having particles of the first active compound at a similar size.

### Example 4

Efficacy as a Function of Particle Size

Method: Three different aqueous suspension concentrates with 30 wt % NGXT-1915 were prepared containing 2.5 wt % tristyrylphenol ethoxylate surfactant, 2.0 wt % ethyleneoxide-propyleneoxide block co-polymeric dispersant, 5.0 wt % propylene glycol freeze protectant, 0.1 wt % silicone oil antifoam, 52.4% distilled water, and after milling were added 8.0 wt % viscosity modifier gel comprising 2.0% xanthan and 1.0% biocide in water. For the three samples, the milling conditions were controlled to achieve a range of particle sizes. Specifically, milling was performed using ceramic milling media in a water-jacketed stirred container, and the duration of milling was varied. The samples were diluted in water and bioassayed in the greenhouse at a rate of 20 ppm NGXT-1915 in pairwise combinations with either of the commercial fungicides Amistar (0.03 L/ha), Imtrex (0.35 L/ha), Proline (0.125 L/ha) or Balaya (0.2 L/ha). Each pairwise combination was used to challenge each of four commercially important pathogenic fungi: Botrytis cinerea (on tomato plants), Zymoseptoria tritici (on wheat plants), Puccinia triticina (on wheat plants) and Phakopsora pachyrhizi (on soybean plants cultivar Siverka). Seeds were sown in 9 cm diameter pots to a depth of 1 to 2 cm using Petersfield potting compost (75% medium grade peat, 12% screened sterilized loam, 3% medium grade vermiculite, 10% grit (5 mm screened, lime free), 1.5 kg PG mix per m\hat{ }3, lime to pH 5.5-6.0 and wetting agent (Vitax Ultrawet 200 ml per m\hat{ }3) and germinated/grown at 23C under a 16 hr day/8 hr night light regime. Plants were treated two to three weeks after sowing when they were at the BBCH 11 growth stage (first pair of true leaves (unifoliate) unfolded. A track sprayer was used to treat the plants with the commercial fungicides and NGXT-1915 using a water volume of 200 L/ha. Plants were inoculated with the appropriate fungi (pathogen) 24 hours after treatment. Four replicates were used for each combination of fungicide, pathogen and formulation. Each plant was evaluated once the disease symptoms were fully expressed between seven to twenty days (depending on the pathogen) for % control of the disease. Appropriate controls were used for all experiments, including an inoculation ‘check’ wherein plants were inoculated with their specific pathogen to assess disease levels. Also, each commercial fungicide was tested on its own as a part of each treatment, this being a ‘control’ benchmark against which the experimental compounds were evaluated. Percentage disease control for each treated plant was calculated to be the average disease severity for the inoculated but untreated plants (‘check’) minus the average disease severity for the treated plants, divided by the ‘check’. Percentage synergy for each combination of formulation plus fungicide (test combination) was calculated to be the disease control for the plants treated only with the fungicide (‘control’) minus the disease control for the test combination, divided by 100% minus the ‘control’. Synergy represents the amount of benefit achieved by adding the NGXT-1915 formulations to the fungicides, expressed as a percentage of the maximum possible benefit, so that 100% would mean that disease control was complete, and 0% would mean that there was no benefit to the combination.

### Results:

The particle sizes of the milled samples were measured using a laser light scattering instrument and the median volume-weighted particle diameters were respectively 1.0, 7.0 and 15 microns with decreasing duration of milling. In the discussion below, for simplicity these samples are designated A1, B7 and C15.

Zymoseptoria tritici: with Amistar there was no consistent synergy, with Imtrex the synergy was 28%, 28%, 4.6% respectively for A1, B7 and C15, with Proline the synergy was 26%, 25%, 61% respectively for A1, B7 and C15, with Balaya the synergy was 51%, 40%, 36% respectively for A1, B7 and C15

Phakopsora pachyrhizi: with Amistar the synergy was 30% for A1 and no synergy for B7 or C15, with Imtrex and Proline there was no significant synergy, with Balaya the synergy was 40%, 33% and 20% respectively for A1, B7 and C15 Puccinia triticina: with Amistar there was no significant synergy, with Imtrex the synergy was 29%, 3% and no synergy respectively for A1, B7 and C15, with Proline or Balaya there was no significant synergy

Botrytis cinerea: with Amistar there was no significant synergy, with Imtrex the synergy was 18%, 6% and no synergy for respectively A1, B7 and C15, with Proline the synergy was 33%, 14% and 10% respectively for A1, B7 and C15, with Balaya there was no significant synergy.

Conclusions: The compositions of the suspension concentrate samples were chosen to achieve physical properties at minimum suitable for the greenhouse assays. The components ensured efficient spray deposition and leaf coverage to enable the assessment of the effect of particle size on biological efficacy. Although the particles were not in this case formulated into a water dispersible granule format, it would be routine for one skilled in the art to perform this formulation without changing the particle size or changing the biological efficacy. Therefore we conclude that the findings regarding particle size apply to water dispersible granules. The specific method used in this example to control particle size could be used directly to achieve a specific particle for a granule formulation, by milling in aqueous suspension prior to granulation, or an alternative method could be used such as air-jet milling, without altering the conclusion that particle size has a surprising influence on biological efficacy.

In the cases where there is synergy, if we group results by fungicide the following can be highlighted:
a) In combinations with Imtrex, B7 is always better than C15, and A1 is essentially identical to (1 instance) or better than B7 (3 instances), i.e. A1>B7>C15.
b) In combinations with Balaya, B7>C15.
c) In combinations with Amistar, only against Phakopsora pachyrhizi is there synergy and a trend apparent, where again A1>B7>C15.
d) In combinations with Proline, in one instance A1>B7>C15 and in another instance C15>A1=B7.

In the cases where there is synergy, if we instead group results by pathogen the following can be highlighted:
a) Against Zymoseptoria tritici, with Imtrex A1=B7>C15, with Proline C15>A1=B7, with Balaya A1>137>C15.
b) Against Phakopsora pachyrhizi, with Amistar only A1 has synergy, with Balaya A1>B7>C15.
c) Against Puccinia triticina, with Imtrex A1>B7>C15.
d) Against Botrytis cinerea with both Imtrex and Proline A1>B7>C15 Within this series of experiments there is one apparent contra-example of Proline against Zymoseptoria tritici (based upon a possible outlier value for C15), whereas seven other examples establish the pattern. Overall the suspension concentrate with median particle size 1 micron is more biologically efficacious than the suspension concentrate with median particle size 7 microns, which is more biologically efficacious than the suspension concentrate with median particle size 15 microns. This pattern is valid against all of the pathogens tested here. Of the fungicides tested here the effect is most consistent with Imtrex and Balaya but there are examples with other fungicides.

We conclude further that in a water dispersible granule formulation, if the median particle size is about 1 micron (in this case and also in the case measured after dispersion into water suitable for spray application) the biological efficacy is higher than if the median particle size is about 7 microns, and that if the median particle size is 7 microns the biological efficacy is higher than if the median particle size is about 15 microns.

APPENDIX 1

| | | | CHEMICAL OR | | | |
|---|---|---|---|---|---|---|
| | TARGET SITE | GROUP | BIOLOGICAL | COMMON | | FRAC |
| MOA | AND CODE | NAME | GROUP | NAME | COMMENTS | CODE |
| A: | A1 | PA - fungicides | acylalanines | benalaxyl | Resistance and cross | 4 |
| nucleic acids | RNA polymerase I | (PhenylAmides) | | benalaxyl-M | resistance well | |
| metabolism | | | | (=kiralaxyl) | known in various | |
| | | | | furalaxyl | Oomycetes but mechanism | |
| | | | | metalaxyl | unknown. | |
| | | | | metalaxyl-M | High risk. | |
| | | | | (=mefenoxam) | See FRAC Phenylamide | |
| | | | oxazolidinones | oxadixyl | Guidelines for resistance | |
| | | | butyrolactones | ofurace | management | |
| | A2 | hydroxy- | hydroxy- | bupirimate | Medium risk. Resistance and | 8 |
| | adenosin- | (2-amino-) | (2-amino-) | dimethirimol | cross resistance known in | |
| | deaminase | pyrimidines | pyrimidines | ethirimol | powdery mildews. | |
| | | | | | Resistance management | |
| | | | | | required. | |
| | A3 | heteroaromatics | isoxazoles | hymexazole | Resistance not known. | 32 |
| | DNA/RNA synthesis | | isothiazolones | octhilinone | | |
| | (proposed) | | | | | |
| | A4 | carboxylic acids | carboxylic acids | oxolinic acid | Bactericide. | 31 |
| | DNA topoisomerase | | | | Resistance known. | |
| | type II (gyrase) | | | | Risk in fungi unknown. | |
| | | | | | Resistance management | |
| | | | | | required. | |
| | A5 | DHODHI- | phenyl-propanol | ipflufenoquin | Medium to high risk. | 52 |
| | inhibition of | fungicides | | | | |
| | dihydroorotate | | | | | |
| | dehydrogenase | | | | | |
| | within de novo | | | | | |
| | pyrimidine | | | | | |
| | biosynthesis | | | | | |
| B: | B1 | MBC - | benzimidazoles | benomyl | Resistance common in many | 1 |
| Cytoskeleton | tubulin | fungicides | | carbendazim | fungal species. Several target | |
| and motor | polymerization | (Methyl | | fuberidazole | site mutations, mostly | |
| protein | | Benzimidazole | | thiabendazole | E198A/G/K, F200Y in | |
| | | Carbamates) | thiophanates | thiophanate | β-tubulin gene. | |
| | | | | thiophanate- | Positive cross resistance | |
| | | | | methy [symbol] | between the group members. | |
| | | | | | Negative cross resistance to | |
| | | | | | N-phenyl carbamates. | |
| | | | | | High risk. | |
| | | | | | See FRAC Benzimidazole | |
| | | | | | Guidelines for resistance | |
| | | | | | management. | |
| | B2 | N-phenyl | N-phenyl | diethofencarb | Resistance known. Target site | 10 |
| | tubulin | carbamates | carbamates | | mutation E198K. Negative | |
| | polymerization | | | | cross resistance to | |
| | | | | | benzimidazoles. | |
| | | | | | High risk. | |
| | | | | | Resistance management | |
| | | | | | required. | |
| | B3 | benzamides | toluamides | zoxamide | Low to medium risk. | 22 |
| | tubulin | thiazole | ethylamino-thiazole- | ethaboxam | Resistance management | |
| | polymerization | carboxamide | carboxamide | | required. | |
| | B4 | phenylureas | phenylureas | pencycuron | Resistance not known. | 20 |
| | cell division | | | | | |
| | (unknown site) | | | | | |
| | B5 | benzamides | pyridinylmethyl- | fluopicolide | Resistant isolates detected in | 43 |
| | delocalisation of | | benzamides | fluopimomide | grapevine downy mildew. | |
| | spectrin-like | | | | Medium risk. | |
| | proteins | | | | Resistance management | |
| | | | | | required | |
| | B6 | cyanoacrylates | aminocyanoacrylates | phenamacril | Resistance known in | 47 |
| | actin/myosin/fimbrin | | | | Fusarium | |
| | function | | | | graminearum. | |
| | | | | | Target site mutations in the | |
| | | | | | gene coding for myosin-5 | |
| | | | | | found in lab studies. | |
| | | | | | Medium to high risk. | |
| | | | | | Resistance management | |
| | | | | | required. | |
| | | aryl-phenyl- | benzophenone | metrafenone | Less sensitive isolates | 50 |
| | | ketones | benzoylpyridine | pyriofenone | detected in powdery mildews | |
| | | | | | (Blumeria and Sphaerotheca) | |
| | | | | | Medium risk. | |
| | | | | | Resistance management | |
| | | | | | required. | |
| | | | | | Reclassified from U8 in 2018 | |
| | B7 | pyridazine | pyridazine | pyridachlometyl | High risk. | 53 |
| | tubulin dynamics | | | | | |
| | modulator | | | | | |
| C. | C1 | pyrimidinamines | pyrimidinamines | diflumetorim | Resistance not known. | 39 |
| respiration | complex I NADH | pyrazole-MET1 | pyrazole-5- | tolfenpyrad | | |
| | oxido-reductase | | carboxamides | | | |
| | | Quinazoline | quinazoline | fenazaquin | | |
| | C2 | SDHI | phenyl-benzamides | benodanil | Resistance known for several | 7 |
| | complex II: | (Succinate- | | flutolanil | fungal species in field | |
| | succinate-dehydro- | dehydrogenase | | mepronil | populations and lab mutants. | |
| | genase | inhibitors) | phenyl-oxo-ethyl | isofetamid | Target site mutations in sdh | |
| | | | thiophene amide | | gene, e.g. H/Y (or H/L) at 257, | |
| | | | pyridinyl-ethyl- | fluopyram | 267, 272 or P225L, dependent | |
| | | | benzamides | | on fungal species. | |
| | | | phenyl-cyclobutyl- | cyclobutrifluram | Resistance management | |
| | | | pyridineamide | | required. | |
| | | | furan- carboxamides | fenfuram | Medium to high risk. | |
| | | | oxathiin- | carboxin | See FRAC SDHI Guidelines | |
| | | | carboxamides | oxycarboxin | for resistance management. | |
| | | | thiazole- | thifluzamide | | |
| | | | carboxamides | | | |
| | | | pyrazole-4- | benzovindiflupyr | | |
| | | | carboxamides | bixafen | | |
| | | | | fluindapyr | | |
| | | | | fluxapyroxad | | |
| | | | | furametpyr | | |
| | | | | inpyrfluxam | | |
| | | | | isopyrazam | | |
| | | | | penflufen | | |
| | | | | penthiopyrad | | |
| | | | | sedaxane | | |
| | | | N-cyclopropyl-N- | isoflucypram | | |
| | | | benzyl-pyrazole- | | | |
| | | | carboxamides | | | |
| | | | N-methoxy-(phenyl- | pydiflumetofen | | |
| | | | ethyl)-pyrazole- | | | |
| | | | carboxamides | | | |
| | | | pyridine- | boscalid | | |
| | | | carboxamides | | | |
| | | | pyrazine- | pyraziflumid | | |
| | | | carboxamides | | | |
| C. | C3 | QoI-fungicides | methoxy-acrylates | azoxystrobin | Resistance known in various | 11 |
| respiration | complex III: | (Quinone outside | | coumoxystrobin | fungal species. Target site | |
| | cytochrome bc1 | Inhibitors) | | enoxastrobin | mutations in cyt b gene (G143A, | |
| | (ubiquinol oxidase) | | | flufenoxystrobin | F129L) and additional | |
| | at Qo site (cyt b | | | picoxystrobin | mechanisms. | |
| | gene) | | | pyraoxystrobin | Cross resistance shown | |
| | | | methoxy-acetamide | mandestrobin | between all members of the | |
| | | | methoxy-carbamates | pyraclostrobin | Code 11 fungicides. | |
| | | | | pyrametostrobin | High risk. | |
| | | | | triclopyricarb | See FRAC QoI Guidelines | |
| | | | oximino-acetates | kresoxim-methyl | for resistance management. | |
| | | | | trifloxystrobin | | |
| | | | oximino-acetamides | dimoxystrobin | | |
| | | | | fenaminstrobin | | |
| | | | | metominostrobin | | |
| | | | | orysastrobin | | |
| | | | oxazolidine-diones | famoxadone | | |
| | | | dihydro-dioxazines | fluoxastrobin | | |
| | | | imidazolinones | fenamidone | | |
| | | | benzyl-carbamates | pyribencarb | | |
| | | QoI-fungicides | tetrazolinones | metyltetraprole | Resistance not known. Not | 11A |
| | | (Quinone outside | | | cross resistant with Code 11 | |
| | | Inhibitors; | | | fungicides on G143A mutants. | |
| | | Subgroup A) | | | High risk. | |
| | | | | | See FRAC QoI Guidelines | |
| | | | | | for resistance management. | |
| C: | C4 | QiI - fungicides | cyano-imidazole | cyazofamid | Resistance risk unknown but | 21 |
| respiration | complex III: | (Quinone inside | sulfamoyl-triazole | amisulbrom | assumed to be medium to high | |
| (continued) | cytochrome bc1 | Inhibitors) | picolinamides | fenpicoxamid | (mutations at target site known | |
| | (ubiquinone | | | florylpicoxamid | in model organisms). | |
| | reductase) at Qi site | | | | Resistance management | |
| | | | | | required. | |
| | | | | | No spectrum overlap with the | |
| | | | | | Oomycete-fungicides | |
| | | | | | cyazofamid and amisulbrom | |
| | C5 | | dinitrophenyl- | binapacryl | Resistance not known. | 29 |
| | uncouplers of | | crotonates | meptyldinocap | Also acaricidal activity. | |
| | oxidative phos- | | | dinocap | | |
| | phorylation | | 2,6-dinitro-anilines | fluazinam | Low risk. However, resistance | |
| | | | | | claimed in Botrytis in Japan. | |
| | | | (pyr.-hydrazones) | (ferimzone) | Reclassified to U 14 in 2012. | |
| | C6 | organo tin | tri-phenyl tin | fentin acetate | Some resistance cases | 30 |
| | inhibitors of | compounds | compounds | fentin chloride | known. Low to medium risk. | |
| | oxidative phos- | | | fentin hydroxide | | |
| | phorylation, ATP | | | | | |
| | synthase | | | | | |
| | C7 | thiophene- | thiophene- | silthiofam | Resistance reported. Risk low. | 38 |
| | ATP transport | carboxamides | carboxamides | | | |
| | (proposed) | | | | | |
| | C8 | QoSI fungicides | triazolo-pyrimidylamine | ametoctradin | Not cross resistant to QoI | 45 |
| | complex III: | (Quinone outside | | | fungicides. | |
| | cytochrome bc1 | Inhibitor, | | | Resistance risk assumed to | |
| | (ubiquinone | stigmatellin | | | be medium to high | |
| | reductase) at | binding type) | | | (single site inhibitor). | |
| | Qo site, stigmatellin | | | | Resistance management | |
| | binding sub-site | | | | required. | |
| D: | D1 | AP - fungicides | anilino-pyrimidines | cyprodinil | Resistance known in Botrytis | 9 |
| amino acids | methionine | (Anilino- | | mepanipyrim | and Venturia, sporadically in | |
| and protein | biosynthesis | Pyrimidines) | | pyrimethanil | Oculimacula. | |
| synthesis | (proposed) | | | | Medium risk. | |
| | (cgs gene) | | | | See FRAC Anilinopyrimidine | |
| | | | | | Guidelines | |
| | | | | | for resistance management. | |
| | D2 | enopyranuronic | enopyranuronic acid | blasticidin-S | Low to medium risk. | 23 |
| | protein synthesis | acid antibiotic | antibiotic | | Resistance management | |
| | (ribosome, | | | | required. | |
| | termination step) | | | | | |
| | D3 | hexopyranosyl | hexopyranosyl | kasugamycin | Resistance known in fungal | 24 |
| | protein synthesis | antibiotic | antibiotic | | and bacterial (P. glumae) | |
| | (ribosome, initiation | | | | pathogens. Medium risk. | |
| | step) | | | | Resistance management | |
| | | | | | required. | |
| | D4 | glucopyranosyl | glucopyranosyl | streptomycin | Bactericide. Resistance | 25 |
| | protein synthesis | antibiotic | antibiotic | | known. High risk. | |
| | (ribosome, initiation | | | | Resistance management | |
| | step) | | | | required. | |
| | D5 | tetracycline | tetracycline | oxytetracycline | Bactericide. Resistance | 41 |
| | protein synthesis | antibiotic | antibiotic | | known. High risk. | |
| | (ribosome, | | | | Resistance management | |
| | elongation step) | | | | required. | |
| E: | E1 | aza- | aryloxyquinoline | quinoxyfen | Resistance to quinoxyfen | 13 |
| signal | signal transduction | naphthalenes | quinazolinone | proquinazid | known. | |
| transduction | (mechanism | | | | Medium risk. | |
| | unknown) | | | | Resistance management | |
| | | | | | required. Cross resistance | |
| | | | | | found in Erysiphe (Uncinula) | |
| | | | | | necator but not in Blumeria | |
| | | | | | graminis. | |
| | E2 | PP-fungicides | phenylpyrroles | fenpiclonil | Resistance found sporadically, | 12 |
| | MAP/Histidine- | (PhenylPyrroles) | | fludioxonil | mechanism speculative. | |
| | Kinase in osmotic | | | | Low to medium risk. | |
| | signal transduction | | | | Resistance management | |
| | (os-2, HOG1) | | | | required. | |
| | E3 | dicarboximides | dicarboximides | chlozolinate | Resistance common in Botrytis | 2 |
| | MAP/Histidine- | | | dimethachlone | and some other pathogens. | |
| | Kinase in osmotic | | | iprodione | Several mutations in OS-1, | |
| | signal transduction | | | procymidone | mostly I365S. | |
| | (os-1, Daf1) | | | vinclozolin | Cross resistance common | |
| | | | | | between the group members. | |
| | | | | | Medium to high risk. | |
| | | | | | See FRAC Dicarboximide | |
| | | | | | Guidelines | |
| | | | | | for resistance management | |

| | | |
|---|---|---|
| F: lipid | F1 | formerly dicarboximides |

| | | | | | | |
|---|---|---|---|---|---|---|
| synthesis or | F2 | phosphoro- | phosphoro- | edifenphos | Resistance known in specific | 6 |
| transport/ | phospholipid | thiolates | thiolates | iprobenfos (IBP) | fungi. | |
| membrane | biosynthesis, | | | pyrazophos | Low to medium risk. | |
| integrity or | methyltransferase | Dithiolanes | dithiolanes | isoprothiolane | Resistance management | |
| function | | | | | required if used for risky | |
| | | | | | pathogens. | |
| | F3 | AH-fungicides | aromatic hydrocarbons | biphenyl | Resistance known in some | 14 |
| | cell peroxidation | (Aromatic | | chloroneb | fungi. | |
| | (proposed) | Hydrocarbons) | | dicloran | Low to medium risk. | |
| | | (chlorophenyls, | | quintozene (PCNB) | Cross resistance patterns | |
| | | nitroanilines) | | tecnazene (TCNB) | complex due to different | |
| | | | | tolclofos-methyl | activity spectra. | |
| | | heteroaromatics | 1,2,4-thiadiazoles | etridiazole | | |
| | F4 | Carbamates | carbamates | iodocarb | Low to medium risk. | 28 |
| | cell membrane | | | propamocarb | Resistance management | |
| | permeability, fatty | | | prothiocarb | required. | |
| | acids (proposed) | | | | | |

| | |
|---|---|
| F5 | formerly CAA-fungicides |
| F6 | formerly Bacillus amyloliquefaciens |
| microbial disrupters | strains (FRAC Code 44); |
| of pathogen cell | reclassified to BM02 in 2020 |
| membranes | |
| F7 | formerly extract from Melaleuca |
| cell membrane | alternifolia (tea tree oil) and plant |
| disruption | oils (eugenol, geraniol, thymol) FRAC Code 46, |
| | reclassified to BM01 in 2021 |

| | | | | | | |
|---|---|---|---|---|---|---|
| | F8 | Polyene | amphoteric macrolide | natamycin | Resistance not known. | 48 |
| | ergosterol binding | | antifungal antibiotic | (pimaricin) | Agricultural, food and topical | |
| | | | from Streptomyces | | medical uses. | |
| | | | natalensis or | | | |
| | | | S. chattanoogensis | | | |
| | F9 | OSBPI | piperidinyl-thiazole- | oxathiapiprolin | Resistance risk assumed to be | 49 |
| | lipid homeostasis | oxysterol binding | isoxazolines | fluoxapiprolin | medium to high (single site | |
| | and transfer/storage | protein | | | inhibitor). Resistance | |
| | | homologue | | | management required. | |
| | | inhibition | | | (Previously U15). | |
| | F10 | protein fragment | polypeptide | polypeptide | Resistance not known. | 51 |
| | interaction with lipid | | | ASFBIOF01-02 | | |
| | fraction of the cell | | | | | |
| | membrane, with | | | | | |
| | multiple effects on | | | | | |
| | cell membrane | | | | | |
| | integrity | | | | | |
| G: sterol | G1 | DMI-fungicides | piperazines | triforine | There are big differences in | 3 |
| biosynthesis | C14- demethylase | (DeMethylation | pyridines | pyrifenox | the activity spectra of DMI | |
| in membranes | in sterol | Inhibitors) | | pyrisoxazole | fungicides. | |
| | biosynthesis | (SBI: Class I) | pyrimidines | fenarimol | Resistance is known in various | |
| | (erg11/cyp51) | | | nuarimol | fungal species. Several | |
| | | | imidazoles | imazalil | resistance mechanisms are | |
| | | | | oxpoconazole | known incl. target site | |
| | | | | pefurazoate | mutations in cyp51 (erg 11) | |
| | | | | prochloraz | gene, e.g. V136A, Y137F, | |
| | | | | triflumizole | A379G, I381V; cyp51 | |
| | | | triazoles | azaconazole | promotor; ABC transporters | |
| | | | triazolinthiones | bitertanol | and others. | |
| | | | | bromuconazole | Generally wise to accept that | |
| | | | | cyproconazole | cross resistance is present | |
| | | | | difenoconazole | between DMI fungicides active | |
| | | | | diniconazole | against the same fungus. | |
| | | | | epoxiconazole | DMI fungicides are Sterol | |
| | | | | etaconazole | Biosynthesis Inhibitors (SBIs), | |
| | | | | fenbuconazole | but show no cross resistance | |
| | | | | fluquinconazole | to other SBI classes. | |
| | | | | flusilazole | Medium risk. | |
| | | | | flutriafol | See FRAC SBI Guidelines | |
| | | | | hexaconazole | for resistance management. | |
| | | | | imibenconazole | | |
| | | | | ipconazole | | |
| | | | | mefentrifluconazole | | |
| | | | | metconazole | | |
| | | | | myclobutanil | | |
| | | | | penconazole | | |
| | | | | propiconazole | | |
| | | | | simeconazole | | |
| | | | | tebuconazole | | |
| | | | | tetraconazole | | |
| | | | | triadimefon | | |
| | | | | triadimenol | | |
| | | | | triticonazole | | |
| | | | | prothioconazole | | |
| | G2 | amines | morpholines | aldimorph | Decreased sensitivity for | 5 |
| | Δ¹⁴-reductase | (“morpholines”) | | dodemorph | powdery mildews. | |
| | and | (SBI: Class II) | | fenpropimorph | Cross resistance within the | |
| | Δ⁸→Δ⁷⁻ | | | tridemorph | group generally found but not | |
| | isomerase | | piperidines | fenpropidin | to other | |
| | in sterol | | | piperalin | SBI classes | |
| | biosynthesis | | spiroketal-amines | spiroxamine | Low to medium risk. | |
| | (erg24, erg2) | | | | See FRAC SBI Guidelines | |
| | | | | | for resistance management | |
| | G3 | KRI fungicides | hydroxyanilides | fenhexamid | Low to medium risk. | 17 |
| | 3-keto reductase, | (KetoReductase | amino-pyrazolinone | fenpyrazamine | Resistance management | |
| | C4- de-methylation | Inhibitors) | | | required. | |
| | (erg27) | (SBI: Class III) | | | | |
| | G4 | (SBI class IV) | thiocarbamates | pyributicarb | Resistance not known, | 18 |
| | squalene-epoxidase | | allylamines | naftifine | fungicidal and herbicidal | |
| | in sterol | | | terbinafine | activity. | |
| | biosynthesis | | | | Medical fungicides only. | |
| | (erg1) | | | | | |

| | | | | |
|---|---|---|---|---|
| H: cell wall | H3 | Formerly glucopyranosyl | reclassified to U18 | 26 |
| biosynthesis | | antibiotic (validamycin) | | |

| | | | | | | |
|---|---|---|---|---|---|---|
| | H4 | polyoxins | peptidyl pyrimidine | polyoxin | Resistance known. | 19 |
| | chitin synthase | | nucleoside | | Medium risk. | |
| | | | | | Resistance management | |
| | | | | | required. | |
| | H5 | CAA-fungicides | cinnamic acid amides | dimethomorph | Resistance known in | 40 |
| | cellulose synthase | (Carboxylic Acid | | flumorph | Plasmopara viticola but not in | |
| | | Amides) | | pyrimorph | Phytophthora infestans. | |
| | | | valinamide | benthiavalicarb | Cross resistance between all | |
| | | | carbamates | iprovalicarb | members of the CAA group. | |
| | | | | valifenalate | Low to medium risk. | |
| | | | mandelic acid amides | mandipropamid | See FRAC CAA Guidelines for | |
| | | | | | resistance management. | |
| I: melanin | I1 | MBI-R | isobenzo-furanone | fthalide | Resistance not known. | 16.1 |
| synthesis in | reductase in | (Melanin | pyrrolo-quinolinone | pyroquilon | | |
| cell wall | melanin | Biosynthesis | triazolobenzo- | tricyclazole | | |
| | biosynthesis | Inhibitors - | thiazole | | | |
| | | Reductase) | | | | |
| | I2 | MBI-D | cyclopropane- | carpropamid | Resistance known. | 16.2 |
| | dehydratase in | (Melanin | carboxamide | | Medium risk. | |
| | melanin | Biosynthesis | carboxamide | diclocymet | Resistance management | |
| | biosynthesis | Inhibitors - | propionamide | fenoxanil | required. | |
| | | Dehydratase) | | | | |
| | I3 | MBI-P | trifluoroethyl- | tolprocarb | Resistance not known. | 16.3 |
| | polyketide synthase | (Melanin | carbamate | | Additional activity against | |
| | in melanin | Biosynthesis | | | bacteria and fungi through | |
| | biosynthesis | Inhibitors - | | | induction of host plant defence | |
| | | Polyketide | | | | |
| | | synthase) | | | | |
| P: host plant | P 01 | benzo- | benzo- | acibenzolar-S-methyl | Resistance not known. | P 01 |
| defence | salicylate-related | thiadiazole | thiadiazole | | | |
| induction | | (BTH) | (BTH) | | | |
| | P 02 | benzisothiazole | benzisothiazole | probenazole | Resistance not known. | P 02 |
| | salicylate-related | | | (also antibacterial and | | |
| | | | | antifungal activity) | | |
| | P 03 | thiadiazole- | thiadiazole- | tiadinil | Resistance not known. | P 03 |
| | salicylate-related | carboxamide | carboxamide | isotianil | | |
| | P 04 | natural | polysaccharides | laminarin | Resistance not known. | P 04 |
| | polysaccharide | compound | | | | |
| | elicitors | | | | | |
| | P 05 | plant extract | complex mixture, | extract from Reynoutria | Resistance not known. | P 05 |
| | anthraquinone | | ethanol extract | sachalinensis (giant | | |
| | elicitors | | (anthraquinones, | knotweed) | | |
| | | | resveratrol) | | | |
| | P 06 | microbial | bacterial | Bacillus mycoides | Resistance not known. | P 06 |
| | microbial elicitors | | Bacillus spp. | isolate J | | |
| | | | fungal | cell walls of Saccharomyces | | |
| | | | Saccharomyces | cerevisiae | | |
| | | | spp. | strain LAS117 | | |
| | P 07 | phosphonates | ethyl phosphonates | fosetyl-Al | Few resistance cases | P07 |
| | phosphonates | | | phosphorous acid and | reported in few | |
| | | | | salts | pathogens. | |
| | | | | | Low risk. | |
| | | | | | Reclassified from U33 in | |
| | | | | | 2018 | |
| | P 08 | isothiazole | isothiazolylmethyl | dichlobentiazox | activates SAR both up- | P 08 |
| | salicylate-related | | ether | | and downstream of SA. | |
| | | | | | Resistance not known. | |
| U: | unknown | cyanoacetamide- | cyanoacetamide- | cymoxanil | Resistance claims described. | 27 |
| Unknown | | oxime | oxime | | Low to medium risk. | |
| mode of | | | | | Resistance management | |
| action | | | | | required. | |

| | |
|---|---|
| (U numbers | formerly phosphonates (FRAC code 33), |
| not | reclassified to P 07 in 2018 |

| | | | | | | |
|---|---|---|---|---|---|---|
| appearing | unknown | phthalamic acids | phthalamic acids | tecloftalam | Resistance not known. | 34 |
| in the list | | | | (Bactericide) | | |
| derive from | unknown | benzotriazines | benzotriazines | triazoxide | Resistance not known. | 35 |
| reclassified | unknown | benzene- | benzene- | flusulfamide | Resistance not known. | 36 |
| fungicides) | unknown | pyridazinones | pyridazinones | diclomezine | Resistance not known. | 37 |

formerly methasulfocarb (FRAC code 42),
reclassified to M 12 in 2018

| | | | | | | |
|---|---|---|---|---|---|---|
| | unknown | phenyl- | phenyl- | cyflufenamid | Resistance in Sphaerotheca. | U 06 |
| | | acetamide | acetamide | | Resistance management | |
| | | | | | required | |
| | cell membrane | guanidines | guanidines | dodine | Resistance known in | U 12 |
| | disruption | | | | Venturia inaequalis. | |
| | (proposed) | | | | Low to medium risk. | |
| | | | | | Resistance management | |
| | | | | | recommended. | |
| | unknown | thiazolidine | cyano-methylene- | flutianil | Resistance in Sphaerotheca and | U 13 |
| | | | thiazolidines | | Podosphaera xanthii. | |
| | | | | | Resistance management | |
| | | | | | required. | |
| | unknown | pyrimidinone- | pyrimidinone- | ferimzone | Resistance not known | U 14 |
| | | hydrazones | hydrazones | | (previously C5). | |
| | complex III: | 4-quinolyl- | 4-quinolyl- | tebufloquin | Not cross resistant to QoI. | U 16 |
| | cytochrome bc1, | acetate | acetates | | Resistance risk unknown but | |
| | unknown binding | | | | assumed to be medium. | |
| | site (proposed) | | | | Resistance management | |
| | | | | | required. | |
| | Unknown | tetrazolyloxime | tetrazolyloximes | picarbutrazox | Resistance not known. | U 17 |
| | | | | | Not cross resistant to | |
| | | | | | PA, QoI, CAA. | |
| | Unknown | glucopyranosyl | glucopyranosyl | validamycin | Resistance not known. | U 18 |
| | (Inhibition of | antibiotic | antibiotics | | Induction of host plant defense | |
| | trehalase) | | | | by trehalose proposed | |
| | | | | | (previously H3). | |
| Not | Unknown | diverse | diverse | mineral oils, | Resistance not known. | NC |
| specified | | | | organic oils, | | |
| | | | | inorganic salts, | | |
| | | | | material of | | |
| | | | | biological origin | | |
| M: | multi-site | inorganic | inorganic | copper | Also applies to organic copper | M 01 |
| Chemicals | contact | (electrophiles) | | (different salts) | complexes | |
| with multi-site | activity | inorganic | inorganic | sulphur | generally considered as a low | M 02 |
| activity | | (electrophiles) | | | risk group without any signs of | |
| | | dithiocarbamates | dithio-carbamates | amobam | resistance developing to the | M 03 |
| | | and relatives | and relatives | ferbam | fungicides. | |
| | | (electrophiles) | | mancozeb | reclassified from U42 in 2018 | |
| | | | | maneb | | |
| | | | | metiram | | |
| | | | | propineb | | |
| | | | | thiram | | |
| | | | | zinc thiazole | | |
| | | | | zineb | | |
| | | | | ziram | | |
| | | phthalimides | phthalimides | captan | | M 04 |
| | | (electrophiles) | | captafol | | |
| | | | | folpet | | |
| | | chloronitriles | chloronitriles | chlorothalonil | | M 05 |
| | | (phthalonitriles) | (phthalonitriles) | | | |
| | | (unspecified | | | | |
| | | mechanism) | | | | |
| | | sulfamides | sulfamides | dichlofluanid | | M 06 |
| | | (electrophiles) | | tolylfluanid | | |
| | | bis-guanidines | bis-guanidines | guazatine | | M 07 |
| | | (membrane | | iminoctadine | | |
| | | disruptors, | | | | |
| | | detergents) | | | | |
| | | triazines | triazines | anilazine | | M 08 |
| | | (unspecified | | | | |
| | | mechanism) | | | | |
| | | quinones | quinones | dithianon | | M 09 |
| | | (anthraquinones) | (anthraquinones) | | | |
| | | (electrophiles) | | | | |
| | | quinoxalines | quinoxalines | chinomethionat/ | | M 10 |
| | | (electrophiles) | | quinomethionate | | |
| | | maleimide | maleimide | fluoroimide | | M 11 |
| | | (electrophiles) | | | | |
| | | thiocarbamate | thiocarbamate | methasulfocarb | | M 12 |
| | | (electrophiles) | | | | |

| | | | CHEMICAL OR | | | |
|---|---|---|---|---|---|---|
| | TARGET | GROUP | BIOLOGICAL | COMMON | | FRAC |
| MOA | SITE | NAME | GROUP | NAME | COMMENTS | CODE |
| BM: | multiple effects | plant extract | polypeptide (lectin) | extract from the | Resistance not known. | BM 01 |
| Biologicals | on ion membrane | | | cotyledons of | (previously M12). | |
| with | transporters; | | | lupine plantlets | | |
| multiple | chelating effects | | | (“BLAD”) | | |
| modes | affects fungal | plant extract | phenols, | extract from | Resistance not known. | |
| of | spores and germ | | sesquiterpenes, | Swinglea glutinosa | | |
| action: | tubes, | | triterpenoids, | | | |
| Plant | induced plant | | coumarins | | | |
| extracts | defense | | | | | |
| | cell membrane | plant extract | terpene | extract from | Resistance not known. | |
| | disruption, cell wall, | | hydrocarbons, | Melaleuca | (previously F7) | |
| | induced plant | | terpene alcohols and | alternifolia | | |
| | defense | | terpene phenols | (tea tree oil) | | |
| | mechanisms | | | plant oils | | |
| | | | | (mixtures): | | |
| | | | | eugenol, geraniol, | | |
| | | | | thymol | | |
| BM: | multiple effects | microbial | fungal | T. atroviride | nomenclature change from | BM 02 |
| Biologicals | described | (strains | Trichoderma spp. | strain I-1237 | Gliocladium catenulatum to | |
| with | (examples, not all | of living | | strain LU132 | Clonostachys rosea | |
| multiple | apply to all | microbes or | | strain SC1 | Resistance not known. | |
| modes | biological groups): | extract, | | strain SKT-1 | Bacillus amyloliquefaciens | |
| of | competition, | metabolites) | | strain 77B | reclassified from F6, | |
| action: | mycoparasitism, | | | T. asperellum | Code 44 in 2020 | |
| Microbial | antibiosis, | | | strain T34 | synonyms for Bacillus | |
| (living | membrane | | | strain kd | amyloliquefaciens are Bacillus | |
| microbes, | disruption by | | | T. harzianum | subtilis and B. subtilis var. | |
| extracts | fungicidal | | | strain T-22 | amyloliquefaciens (previous | |
| or | lipopeptides, | | | T. virens | taxonomic classification). | |
| metabolites) | lytic enzymes, | | | strain G-41 | | |
| | induced plant | | fungal | C. rosea | | |
| | defence | | Clonostachys spp. | strain J1446 | | |
| | | | | strain CR-7 | | |
| | | | fungal | C. minitans | | |
| | | | Coniothyrium spp. | strain CON/M/91-08 | | |
| | | | fungal | H. uvarum | | |
| | | | Hanseniaspora spp. | strain BC18Y | | |
| | | | fungal | T. flavus | | |
| | | | Talaromyces spp. | strain SAY-Y-94-01 | | |
| | | | fungal | S. cerevisae | | |
| | | | Saccharomyces spp. | strain LAS02 | | |
| | | | | strain DDSF623 | | |
| | | | bacterial | B. amyloliquefaciens | | |
| | | | Bacillus spp. | strain QST713 | | |
| | | | | strain FZB24 | | |
| | | | | strain MBI600 | | |
| | | | | strain D747 | | |
| | | | | strain F727 | | |
| | | | | strain AT-332 | | |
| | | | | B. subtilis | | |
| | | | | strain AFS032321 | | |
| | | | | strain Y1336 | | |
| | | | | strain HAI-0404 | | |
| | | | bacterial | PHC25279 | | |
| | | | Erwinia spp. | | | |
| | | | (peptide) | | | |
| | | | bacterial | G. cerinus | | |
| | | | Gluconobacter spp. | strain BC18B | | |
| | | | bacterial | P. chlororaphis | | |
| | | | Pseudomonas spp. | strain AFS009 | | |
| | | | bacterial | S. griseovirides | | |
| | | | Streptomyces spp. | strain K61 | | |
| | | | | S. lydicus | | |
| | | | | strain WYEC108 | | |

[symbol]

indicates data missing or illegible when filed

APPENDIX 2

| MODE OF ACTION | CHEMICAL CLASSIFICATION | ACTIVE |
|---|---|---|
| Inhibition of Acetyl CoA | Cyclohexanediones (DIMs) | Alloxydim |
| Carboxylase | | |
| Inhibition of Acetyl CoA | Cyclohexanediones (DIMs) | Butroxydim |
| Carboxylase | | |
| Inhibition of Acetyl CoA | Cyclohexanediones (DIMs) | Clethodim |
| Carboxylase | | |
| Inhibition of Acetyl CoA | Cyclohexanediones (DIMs) | Cloproxydim |
| Carboxylase | | |
| Inhibition of Acetyl CoA | Cyclohexanediones (DIMs) | Cycloxydim |
| Carboxylase | | |
| Inhibition of Acetyl CoA | Cyclohexanediones (DIMs) | Profoxydim |
| Carboxylase | | |
| Inhibition of Acetyl CoA | Cyclohexanediones (DIMs) | Sethoxydim |
| Carboxylase | | |
| Inhibition of Acetyl CoA | Cyclohexanediones (DIMs) | Tepraloxydim |
| Carboxylase | | |
| Inhibition of Acetyl CoA | Cyclohexanediones (DIMs) | Tralkoxydim |
| Carboxylase | | |
| Inhibition of Acetyl CoA | Aryloxyphenoxy-propionates | Clodinafop-propargyl |
| Carboxylase | (FOPs) | |
| Inhibition of Acetyl CoA | Aryloxyphenoxy-propionates | Clofop |
| Carboxylase | (FOPs) | |
| Inhibition of Acetyl CoA | Aryloxyphenoxy-propionates | Cyhalofop-butyl |
| Carboxylase | (FOPs) | |
| Inhibition of Acetyl CoA | Aryloxyphenoxy-propionates | Diclofop-methyl |
| Carboxylase | (FOPs) | |
| Inhibition of Acetyl CoA | Aryloxyphenoxy-propionates | Fenoxaprop-ethyl |
| Carboxylase | (FOPs) | |
| Inhibition of Acetyl CoA | Aryloxyphenoxy-propionates | Fenthiaprop |
| Carboxylase | (FOPs) | |
| Inhibition of Acetyl CoA | Aryloxyphenoxy-propionates | Fluazifop-butyl |
| Carboxylase | (FOPs) | |
| Inhibition of Acetyl CoA | Aryloxyphenoxy-propionates | Haloxyfop-methyl |
| Carboxylase | (FOPs) | |
| Inhibition of Acetyl CoA | Aryloxyphenoxy-propionates | Isoxapyrifop |
| Carboxylase | (FOPs) | |
| Inhibition of Acetyl CoA | Aryloxyphenoxy-propionates | Metamifop |
| Carboxylase | (FOPs) | |
| Inhibition of Acetyl CoA | Aryloxyphenoxy-propionates | Quizalofop-ethyl |
| Carboxylase | (FOPs) | |
| Inhibition of Acetyl CoA | Phenylpyrazoline | Pinoxaden |
| Carboxylase | | |
| Inhibition of Acetolactate | Pyrimidinyl benzoates | Bispyribac-sodium |
| Synthase | | |
| Inhibition of Acetolactate | Pyrimidinyl benzoates | Pyribenzoxim (prodrug of |
| Synthase | | bispyribac) |
| Inhibition of Acetolactate | Pyrimidinyl benzoates | Pyriftalid |
| Synthase | | |
| Inhibition of Acetolactate | Pyrimidinyl benzoates | Pyriminobac-methyl |
| Synthase | | |
| Inhibition of Acetolactate | Pyrimidinyl benzoates | Pyrithiobac-sodium |
| Synthase | | |
| Inhibition of Acetolactate | Sulfonanilides | Pyrimisulfan |
| Synthase | | |
| Inhibition of Acetolactate | Sulfonanilides | Triafamone |
| Synthase | | |
| Inhibition of Acetolactate | Triazolopyrimidine - Type 1 | Cloransulam-methyl |
| Synthase | | |
| Inhibition of Acetolactate | Triazolopyrimidine - Type 1 | Diclosulam |
| Synthase | | |
| Inhibition of Acetolactate | Triazolopyrimidine - Type 1 | Florasulam |
| Synthase | | |
| Inhibition of Acetolactate | Triazolopyrimidine - Type 1 | Flumetsulam |
| Synthase | | |
| Inhibition of Acetolactate | Triazolopyrimidine - Type 1 | Metosulam |
| Synthase | | |
| Inhibition of Acetolactate | Triazolopyrimidine - Type 2 | Penoxsulam |
| Synthase | | |
| Inhibition of Acetolactate | Triazolopyrimidine - Type 2 | Pyroxsulam |
| Synthase | | |
| Inhibition of Acetolactate | Sulfonylureas | Amidosulfuron |
| Synthase | | |
| Inhibition of Acetolactate | Sulfonylureas | Azimsulfuron |
| Synthase | | |
| Inhibition of Acetolactate | Sulfonylureas | Bensulfuron-methyl |
| Synthase | | |
| Inhibition of Acetolactate | Sulfonylureas | Chlorimuron-ethyl |
| Synthase | | |
| Inhibition of Acetolactate | Sulfonylureas | Chlorsulfuron |
| Synthase | | |
| Inhibition of Acetolactate | Sulfonylureas | Cinosulfuron |
| Synthase | | |
| Inhibition of Acetolactate | Sulfonylureas | Cyclosulfamuron |
| Synthase | | |
| Inhibition of Acetolactate | Sulfonylureas | Ethametsulfuron-methyl |
| Synthase | | |
| Inhibition of Acetolactate | Sulfonylureas | Ethoxysulfuron |
| Synthase | | |
| Inhibition of Acetolactate | Sulfonylureas | Flazasulfuron |
| Synthase | | |
| Inhibition of Acetolactate | Sulfonylureas | Flucetosulfuron |
| Synthase | | |
| Inhibition of Acetolactate | Sulfonylureas | Flupyrsulfuron-methyl-Na |
| Synthase | | |
| Inhibition of Acetolactate | Sulfonylureas | Foramsulfuron |
| Synthase | | |
| Inhibition of Acetolactate | Sulfonylureas | Halosulfuron-methyl |
| Synthase | | |
| Inhibition of Acetolactate | Sulfonylureas | Imazosulfuron |
| Synthase | | |
| Inhibition of Acetolactate | Sulfonylureas | Iodosulfuron-methyl-Na |
| Synthase | | |
| Inhibition of Acetolactate | Sulfonylureas | Mesosulfuron-methyl |
| Synthase | | |
| Inhibition of Acetolactate | Sulfonylureas | Metazosulfuron |
| Synthase | | |
| Inhibition of Acetolactate | Sulfonylureas | Metsulfuron-methyl |
| Synthase | | |
| Inhibition of Acetolactate | Sulfonylureas | Nicosulfuron |
| Synthase | | |
| Inhibition of Acetolactate | Sulfonylureas | Orthosulfamuron |
| Synthase | | |
| Inhibition of Acetolactate | Sulfonylureas | Oxasulfuron |
| Synthase | | |
| Inhibition of Acetolactate | Sulfonylureas | Primisulfuron-methyl |
| Synthase | | |
| Inhibition of Acetolactate | Sulfonylureas | Propyrisulfuron |
| Synthase | | |
| Inhibition of Acetolactate | Sulfonylureas | Prosulfuron |
| Synthase | | |
| Inhibition of Acetolactate | Sulfonylureas | Pyrazosulfuron-ethyl |
| Synthase | | |
| Inhibition of Acetolactate | Sulfonylureas | Rimsulfuron |
| Synthase | | |
| Inhibition of Acetolactate | Sulfonylureas | Sulfometuron-methyl |
| Synthase | | |
| Inhibition of Acetolactate | Sulfonylureas | Sulfosulfuron |
| Synthase | | |
| Inhibition of Acetolactate | Sulfonylureas | Triasulfuron |
| Synthase | | |
| Inhibition of Acetolactate | Sulfonylureas | Tribenuron-methyl |
| Synthase | | |
| Inhibition of Acetolactate | Sulfonylureas | Thifensulfuron-methyl |
| Synthase | | |
| Inhibition of Acetolactate | Sulfonylureas | Trifloxysulfuron-Na |
| Synthase | | |
| Inhibition of Acetolactate | Sulfonylureas | Triflusulfuron-methyl |
| Synthase | | |
| Inhibition of Acetolactate | Sulfonylureas | Tritosulfuron |
| Synthase | | |
| Inhibition of Acetolactate | Imidazolinones | Imazamethabenz-methyl |
| Synthase | | |
| Inhibition of Acetolactate | Imidazolinones | Imazamox |
| Synthase | | |
| Inhibition of Acetolactate | Imidazolinones | Imazapic |
| Synthase | | |
| Inhibition of Acetolactate | Imidazolinones | Imazapyr |
| Synthase | | |
| Inhibition of Acetolactate | Imidazolinones | Imazaquin |
| Synthase | | |
| Inhibition of Acetolactate | Imidazolinones | Imazethapyr |
| Synthase | | |
| Inhibition of Acetolactate | Triazolinones | Flucarbazone-Na |
| Synthase | | |
| Inhibition of Acetolactate | Triazolinones | Propoxycarbazone-Na |
| Synthase | | |
| Inhibition of Acetolactate | Triazolinones | Thiencarbazone-methyl |
| Synthase | | |
| Inhbition of Photosynthesis at | Triazines | Atraton |
| PSII - Serine 264 Binders | | |
| Inhbition of Photosynthesis at | Triazines | Atrazine |
| PSII - Serine 264 Binders | | |
| Inhbition of Photosynthesis at | Triazines | Ametryne |
| PSII - Serine 264 Binders | | |
| Inhbition of Photosynthesis at | Triazines | Aziprotryne = aziprotryn |
| PSII - Serine 264 Binders | | |
| Inhbition of Photosynthesis at | Triazines | Chlorazine |
| PSII - Serine 264 Binders | | |
| Inhbition of Photosynthesis at | Triazines | CP 17029 |
| PSII - Serine 264 Binders | | |
| Inhbition of Photosynthesis at | Triazines | Cyanazine |
| PSII - Serine 264 Binders | | |
| Inhbition of Photosynthesis at | Triazines | Cyprazine |
| PSII - Serine 264 Binders | | |
| Inhbition of Photosynthesis at | Triazines | Desmetryne |
| PSII - Serine 264 Binders | | |
| Inhbition of Photosynthesis at | Triazines | Dimethametryn |
| PSII - Serine 264 Binders | | |
| Inhbition of Photosynthesis at | Triazines | Dipropetryn |
| PSII - Serine 264 Binders | | |
| Inhbition of Photosynthesis at | Triazines | Eglinazine-ethyl |
| PSII - Serine 264 Binders | | |
| Inhbition of Photosynthesis at | Triazines | Ipazine |
| PSII - Serine 264 Binders | | |
| Inhbition of Photosynthesis at | Triazines | Methoprotryne = methoprotryn |
| PSII - Serine 264 Binders | | |
| Inhbition of Photosynthesis at | Triazines | procyazine |
| PSII - Serine 264 Binders | | |
| Inhbition of Photosynthesis at | Triazines | Proglinazine-ethyl |
| PSII - Serine 264 Binders | | |
| Inhbition of Photosynthesis at | Triazines | Prometon |
| PSII - Serine 264 Binders | | |
| Inhbition of Photosynthesis at | Triazines | Prometryne |
| PSII - Serine 264 Binders | | |
| Inhbition of Photosynthesis at | Triazines | Propazine |
| PSII - Serine 264 Binders | | |
| Inhbition of Photosynthesis at | Triazines | Sebuthylazine |
| PSII - Serine 264 Binders | | |
| Inhbition of Photosynthesis at | Triazines | Secbumeton |
| PSII - Serine 264 Binders | | |
| Inhbition of Photosynthesis at | Triazines | Simetryne |
| PSII - Serine 264 Binders | | |
| Inhbition of Photosynthesis at | Triazines | Simazine |
| PSII - Serine 264 Binders | | |
| Inhbition of Photosynthesis at | Triazines | Terbumeton |
| PSII - Serine 264 Binders | | |
| Inhbition of Photosynthesis at | Triazines | Terbuthylazine |
| PSII - Serine 264 Binders | | |
| Inhbition of Photosynthesis at | Triazines | Terbutryne |
| PSII - Serine 264 Binders | | |
| Inhbition of Photosynthesis at | Triazines | Trietazine |
| PSII - Serine 264 Binders | | |
| Inhbition of Photosynthesis at | Triazolinone | Amicarbazone |
| PSII - Serine 264 Binders | | |
| Inhbition of Photosynthesis at | Triazinones | Ethiozin |
| PSII - Serine 264 Binders | | |
| Inhbition of Photosynthesis at | Triazinones | Hexazinone |
| PSII - Serine 264 Binders | | |
| Inhbition of Photosynthesis at | Triazinones | Isomethiozin |
| PSII - Serine 264 Binders | | |
| Inhbition of Photosynthesis at | Triazinones | Metamitron |
| PSII - Serine 264 Binders | | |
| Inhbition of Photosynthesis at | Triazinones | Metribuzin |
| PSII - Serine 264 Binders | | |
| Inhbition of Photosynthesis at | Uracils | Bromacil |
| PSII - Serine 264 Binders | | |
| Inhbition of Photosynthesis at | Uracils | Isocil |
| PSII - Serine 264 Binders | | |
| Inhbition of Photosynthesis at | Uracils | Lenacil |
| PSII - Serine 264 Binders | | |
| Inhbition of Photosynthesis at | Uracils | Terbacil |
| PSII - Serine 264 Binders | | |
| Inhbition of Photosynthesis at | Phenlcarbamates | Chlorprocarb |
| PSII - Serine 264 Binders | | |
| Inhbition of Photosynthesis at | Phenlcarbamates | Desmedipham |
| PSII - Serine 264 Binders | | |
| Inhbition of Photosynthesis at | Phenlcarbamates | Phenisopham |
| PSII - Serine 264 Binders | | |
| Inhbition of Photosynthesis at | Phenlcarbamates | Phenmedipham |
| PSII - Serine 264 Binders | | |
| Inhbition of Photosynthesis at | Pyridazinone | Chloridazon (=pyrazon) |
| PSII - Serine 264 Binders | | |
| Inhbition of Photosynthesis at | Pyridazinone | Brompyrazon |
| PSII - Serine 264 Binders | | |
| Inhbition of Photosynthesis at | Ureas | Benzthiazuron |
| PSII - Serine 264 Binders | | |
| Inhbition of Photosynthesis at | Ureas | Bromuron |
| PSII - Serine 264 Binders | | |
| Inhbition of Photosynthesis at | Ureas | Buturon |
| PSII - Serine 264 Binders | | |
| Inhbition of Photosynthesis at | Ureas | Chlorbromuron |
| PSII - Serine 264 Binders | | |
| Inhbition of Photosynthesis at | Ureas | Chlorotoluron |
| PSII - Serine 264 Binders | | |
| Inhbition of Photosynthesis at | Ureas | Chloroxuron |
| PSII - Serine 264 Binders | | |
| Inhbition of Photosynthesis at | Ureas | Difenoxuron |
| PSII - Serine 264 Binders | | |
| Inhbition of Photosynthesis at | Ureas | Dimefuron |
| PSII - Serine 264 Binders | | |
| Inhbition of Photosynthesis at | Ureas | Diuron |
| PSII - Serine 264 Binders | | |
| Inhbition of Photosynthesis at | Ureas | Ethidimuron |
| PSII - Serine 264 Binders | | |
| Inhbition of Photosynthesis at | Ureas | Fenuron |
| PSII - Serine 264 Binders | | |
| Inhbition of Photosynthesis at | Ureas | Fluometuron |
| PSII - Serine 264 Binders | | |
| Inhbition of Photosynthesis at | Ureas | Fluothiuron |
| PSII - Serine 264 Binders | | |
| Inhbition of Photosynthesis at | Ureas | Isoproturon |
| PSII - Serine 264 Binders | | |
| Inhbition of Photosynthesis at | Ureas | Isouron |
| PSII - Serine 264 Binders | | |
| Inhbition of Photosynthesis at | Ureas | Linuron |
| PSII - Serine 264 Binders | | |
| Inhbition of Photosynthesis at | Ureas | Metobenzuron |
| PSII - Serine 264 Binders | | |
| Inhbition of Photosynthesis at | Ureas | Metobromuron |
| PSII - Serine 264 Binders | | |
| Inhbition of Photosynthesis at | Ureas | Methabenzthiazuron |
| PSII - Serine 264 Binders | | |
| Inhbition of Photosynthesis at | Ureas | Metoxuron |
| PSII - Serine 264 Binders | | |
| Inhbition of Photosynthesis at | Ureas | Monolinuron |
| PSII - Serine 264 Binders | | |
| Inhbition of Photosynthesis at | Ureas | Monuron |
| PSII - Serine 264 Binders | | |
| Inhbition of Photosynthesis at | Ureas | Neburon |
| PSII - Serine 264 Binders | | |
| Inhbition of Photosynthesis at | Ureas | Parafluron |
| PSII - Serine 264 Binders | | |
| Inhbition of Photosynthesis at | Ureas | Siduron |
| PSII - Serine 264 Binders | | |
| Inhbition of Photosynthesis at | Ureas | Tebuthiuron |
| PSII - Serine 264 Binders | | |
| Inhbition of Photosynthesis at | Ureas | Thiazafluron |
| PSII - Serine 264 Binders | | |
| Inhbition of Photosynthesis at | Amides | Chloranocryl = dicryl |
| PSII - Serine 264 Binders | | |
| Inhbition of Photosynthesis at | Amides | Pentanochlor |
| PSII - Serine 264 Binders | | |
| Inhbition of Photosynthesis at | Amides | Propanil |
| PSII - Serine 264 Binders | | |
| Inhbition of Photosynthesis at | Nitriles | Bromofenoxim |
| PSII - Histidine 215 Binders | | |
| Inhbition of Photosynthesis at | Nitriles | Bromoxynil |
| PSII - Histidine 215 Binders | | |
| Inhbition of Photosynthesis at | Nitriles | Ioxynil |
| PSII - Histidine 215 Binders | | |
| Inhbition of Photosynthesis at | Phenyl-pyridazines | Pyridate |
| PSII - Histidine 215 Binders | | |
| Inhbition of Photosynthesis at | Benzothiadiazinone | Bentazon |
| PSII - Histidine 215 Binders | | |
| PS I Electron Diversion | Pyridiniums | Cyperquat |
| PS I Electron Diversion | Pyridiniums | Diquat |
| PS I Electron Diversion | Pyridiniums | Morfamquat |
| PS I Electron Diversion | Pyridiniums | Paraquat |
| Inhibition of | Diphenyl ethers | Lactofen |
| Protoporphyrinogen Oxidase | | |
| Inhibition of | Diphenyl ethers | Acifluorfen |
| Protoporphyrinogen Oxidase | | |
| Inhibition of | Diphenyl ethers | Bifenox |
| Protoporphyrinogen Oxidase | | |
| Inhibition of | Diphenyl ethers | Chlornitrofen |
| Protoporphyrinogen Oxidase | | |
| Inhibition of | Diphenyl ethers | Fomesafen |
| Protoporphyrinogen Oxidase | | |
| Inhibition of | Diphenyl ethers | Fluorodifen |
| Protoporphyrinogen Oxidase | | |
| Inhibition of | Diphenyl ethers | Fluoroglycofen-ethyl |
| Protoporphyrinogen Oxidase | | |
| Inhibition of | Diphenyl ethers | Fluoronitrofen |
| Protoporphyrinogen Oxidase | | |
| Inhibition of | Diphenyl ethers | Nitrofen |
| Protoporphyrinogen Oxidase | | |
| Inhibition of | Diphenyl ethers | Oxyfluorfen |
| Protoporphyrinogen Oxidase | | |
| Inhibition of | Diphenyl ethers | Chlomethoxyfen |
| Protoporphyrinogen Oxidase | | |
| Inhibition of | Phenylpyrazoles | Pyraflufen-ethyl |
| Protoporphyrinogen Oxidase | | |
| Inhibition of | N-Phenyl-oxadiazolones | Oxadiargyl |
| Protoporphyrinogen Oxidase | | |
| Inhibition of | N-Phenyl-oxadiazolones | Oxadiazon |
| Protoporphyrinogen Oxidase | | |
| Inhibition of | N-Phenyl-triazolinones | Azafenidin |
| Protoporphyrinogen Oxidase | | |
| Inhibition of | N-Phenyl-triazolinones | Carfentrazone-ethyl |
| Protoporphyrinogen Oxidase | | |
| Inhibition of | N-Phenyl-triazolinones | Sulfentrazone |
| Protoporphyrinogen Oxidase | | |
| Inhibition of | N-Phenyl-imides (procide | Fluthiacet-methyl |
| Protoporphyrinogen Oxidase | acitive form) | |
| Inhibition of | N-Phenyl-imides | Butafenacil |
| Protoporphyrinogen Oxidase | | |
| Inhibition of | N-Phenyl-imides | Saflufenacil |
| Protoporphyrinogen Oxidase | | |
| Inhibition of | N-Phenyl-imides | Pentoxazone |
| Protoporphyrinogen Oxidase | | |
| Inhibition of | N-Phenyl-imides | Chlorphthalim |
| Protoporphyrinogen Oxidase | | |
| Inhibition of | N-Phenyl-imides | Cinidon-ethyl |
| Protoporphyrinogen Oxidase | | |
| Inhibition of | N-Phenyl-imides | Flumiclorac-pentyl |
| Protoporphyrinogen Oxidase | | |
| Inhibition of | N-Phenyl-imides | Flumioxazin |
| Protoporphyrinogen Oxidase | | |
| Inhibition of | N-Phenyl-imides | Flumipropyn |
| Protoporphyrinogen Oxidase | | |
| Inhibition of | N-Phenyl-imides | Trifludimoxazin |
| Protoporphyrinogen Oxidase | | |
| Inhibition of | N-Phenyl-imides | Tiafenacil |
| Protoporphyrinogen Oxidase | | |
| Inhibition of | Other | Pyraclonil |
| Protoporphyrinogen Oxidase | | |
| Inhibition of Phytoene | Phenyl ethers | Beflubutamid |
| Desaturase | | |
| Inhibition of Phytoene | Phenyl ethers | Diflufenican |
| Desaturase | | |
| Inhibition of Phytoene | Phenyl ethers | Picolinafen |
| Desaturase | | |
| Inhibition of Phytoene | N-Phenyl heterocycles | Flurochloridone |
| Desaturase | | |
| Inhibition of Phytoene | N-Phenyl heterocycles | Norflurazon |
| Desaturase | | |
| Inhibition of Phytoene | Diphenyl heterocycles | Fluridone |
| Desaturase | | |
| Inhibition of Phytoene | Diphenyl heterocycles | Flurtamone |
| Desaturase | | |
| Inhibition of Hydroxyphenyl | Triketones | Mesotrione |
| Pyruvate Dioxygenase | | |
| Inhibition of Hydroxyphenyl | Triketones | Sulcotrione |
| Pyruvate Dioxygenase | | |
| Inhibition of Hydroxyphenyl | Triketones | Tembotrione |
| Pyruvate Dioxygenase | | |
| Inhibition of Hydroxyphenyl | Triketones | Tefuryltrione |
| Pyruvate Dioxygenase | | |
| Inhibition of Hydroxyphenyl | Triketones | Bicyclopyrone |
| Pyruvate Dioxygenase | | |
| Inhibition of Hydroxyphenyl | Triketones | Fenquinotrione |
| Pyruvate Dioxygenase | | |
| Inhibition of Hydroxyphenyl | Triketones (procide) | Benzobicyclon |
| Pyruvate Dioxygenase | | |
| Inhibition of Hydroxyphenyl | Pyrazoles (procide) | Benzofenap |
| Pyruvate Dioxygenase | | |
| Inhibition of Hydroxyphenyl | Pyrazoles | Pyrasulfotole |
| Pyruvate Dioxygenase | | |
| Inhibition of Hydroxyphenyl | Pyrazoles | Topramezone |
| Pyruvate Dioxygenase | | |
| Inhibition of Hydroxyphenyl | Pyrazoles (procide) | Pyrazolynate |
| Pyruvate Dioxygenase | | |
| Inhibition of Hydroxyphenyl | Pyrazoles (procide) | Pyrazoxyfen |
| Pyruvate Dioxygenase | | |
| Inhibition of Hydroxyphenyl | Pyrazoles | Tolpyralate |
| Pyruvate Dioxygenase | | |
| Inhibition of Hydroxyphenyl | Isoxazoles | Isoxaflutole |
| Pyruvate Dioxygenase | | |
| Inhibition of Homogentisate | Phenoxypyridazine | Cyclopyrimorate |
| Solanesyltransferase | | |
| Inhibition of Deoxy-D-Xyulose | Isoxazolidinone | Clomazone |
| Phosphate Synthase | | |
| Inhibition of Deoxy-D-Xyulose | Isoxazolidinone | Bixlozone |
| Phosphate Synthase | | |
| Inhibition of Enolpyruvyl | Glycine | Glyphosate |
| Shikimate Phosphate | | |
| Synthase | | |
| Inhibition of Glutamine | Phosphinic acids | Glufosinate-ammonium |
| Synthetase | | |
| Inhibition of Glutamine | Phosphinic acids | Bialaphos/bilanafos |
| Synthetase | | |
| Inhibition of Dihydropteroate | Carbamate | Asulam |
| Synthase | | |
| Inhibition of Microtubule | Dinitroanilines | Benefin = benfluralin |
| Assembly | | |
| Inhibition of Microtubule | Dinitroanilines | Butralin |
| Assembly | | |
| Inhibition of Microtubule | Dinitroanilines | Dinitramine |
| Assembly | | |
| Inhibition of Microtubule | Dinitroanilines | Ethalfluralin |
| Assembly | | |
| Inhibition of Microtubule | Dinitroanilines | Fluchloralin |
| Assembly | | |
| Inhibition of Microtubule | Dinitroanilines | Isopropalin |
| Assembly | | |
| Inhibition of Microtubule | Dinitroanilines | Nitralin |
| Assembly | | |
| Inhibition of Microtubule | Dinitroanilines | Prodiamine |
| Assembly | | |
| Inhibition of Microtubule | Dinitroanilines | Profluralin |
| Assembly | | |
| Inhibition of Microtubule | Dinitroanilines | Oryzalin |
| Assembly | | |
| Inhibition of Microtubule | Dinitroanilines | Pendimethalin |
| Assembly | | |
| Inhibition of Microtubule | Dinitroanilines | Trifluralin |
| Assembly | | |
| Inhibition of Microtubule | Pyridines | Dithiopyr |
| Assembly | | |
| Inhibition of Microtubule | Pyridines | Thiazopyr |
| Assembly | | |
| Inhibition of Microtubule | Phosphoroamidates | Butamifos |
| Assembly | | |
| Inhibition of Microtubule | Phosphoroamidates | DMPA |
| Assembly | | |
| Inhibition of Microtubule | Benzoic acid | Chlorthal-dimethyl = DCPA |
| Assembly | | |
| Inhibition of Microtubule | Benzamides | Propyzamide = pronamide |
| Assembly | | |
| Inhibition of Microtubule | Carbamates | Barban |
| Organization | | |
| Inhibition of Microtubule | Carbamates | Carbetamide |
| Organization | | |
| Inhibition of Microtubule | Carbamates | Chlorbufam |
| Organization | | |
| Inhibition of Microtubule | Carbamates | Chlorpropham |
| Organization | | |
| Inhibition of Microtubule | Carbamates | Propham |
| Organization | | |
| Inhibition of Microtubule | Carbamates | Swep |
| Organization | | |
| Inhibition of Cellulose | Triazolocarboxamide | Flupoxam |
| Synthesis | | |
| Inhibition of Cellulose | Benzamides | Isoxaben |
| Synthesis | | |
| Inhibition of Cellulose | Alkylazines | Triaziflam |
| Synthesis | | |
| Inhibition of Cellulose | Alkylazines | Indaziflam |
| Synthesis | | |
| Inhibition of Cellulose | Nitriles | Dichlobenil |
| Synthesis | | |
| Inhibition of Cellulose | Nitriles | Chlorthiamid |
| Synthesis | | |
| Uncouplers | Dinitrophenols | Dinosam |
| Uncouplers | Dinitrophenols | Dinoseb |
| Uncouplers | Dinitrophenols | DNOC |
| Uncouplers | Dinitrophenols | Dinoterb |
| Uncouplers | Dinitrophenols | Etinofen |
| Uncouplers | Dinitrophenols | Medinoterb |
| Inhibition of Very Long-Chain | Azolyl-carboxamides | Cafenstrole |
| Fatty Acid Synthesis | | |
| Inhibition of Very Long-Chain | Azolyl-carboxamides | Fentrazamide |
| Fatty Acid Synthesis | | |
| Inhibition of Very Long-Chain | Azolyl-carboxamides | Ipfencarbazone |
| Fatty Acid Synthesis | | |
| Inhibition of Very Long-Chain | α-Thioacetamides | Anilofos |
| Fatty Acid Synthesis | | |
| Inhibition of Very Long-Chain | α-Thioacetamides | Piperophos |
| Fatty Acid Synthesis | | |
| Inhibition of Very Long-Chain | Isoxazolines | Pyroxasulfone |
| Fatty Acid Synthesis | | |
| Inhibition of Very Long-Chain | Isoxazolines | Fenoxasulfone |
| Fatty Acid Synthesis | | |
| Inhibition of Very Long-Chain | Oxiranes | Indanofan |
| Fatty Acid Synthesis | | |
| Inhibition of Very Long-Chain | Oxiranes | Tridiphane |
| Fatty Acid Synthesis | | |
| Inhibition of Very Long-Chain | α-Chloroacetamides | Acetochlor |
| Fatty Acid Synthesis | | |
| Inhibition of Very Long-Chain | α-Chloroacetamides | Alachlor |
| Fatty Acid Synthesis | | |
| Inhibition of Very Long-Chain | α-Chloroacetamides | Allidochlor = CDAA |
| Fatty Acid Synthesis | | |
| Inhibition of Very Long-Chain | α-Chloroacetamides | Butachlor |
| Fatty Acid Synthesis | | |
| Inhibition of Very Long-Chain | α-Chloroacetamides | Butenachlor |
| Fatty Acid Synthesis | | |
| Inhibition of Very Long-Chain | α-Chloroacetamides | Delachlor |
| Fatty Acid Synthesis | | |
| Inhibition of Very Long-Chain | α-Chloroacetamides | Diethatyl-ethyl |
| Fatty Acid Synthesis | | |
| Inhibition of Very Long-Chain | α-Chloroacetamides | Dimethachlor |
| Fatty Acid Synthesis | | |
| Inhibition of Very Long-Chain | α-Chloroacetamides | Dimethenamid |
| Fatty Acid Synthesis | | |
| Inhibition of Very Long-Chain | α-Chloroacetamides | Metazachlor |
| Fatty Acid Synthesis | | |
| Inhibition of Very Long-Chain | α-Chloroacetamides | Metolachlor |
| Fatty Acid Synthesis | | |
| Inhibition of Very Long-Chain | α-Chloroacetamides | Pethoxamid |
| Fatty Acid Synthesis | | |
| Inhibition of Very Long-Chain | α-Chloroacetamides | Pretilachlor |
| Fatty Acid Synthesis | | |
| Inhibition of Very Long-Chain | α-Chloroacetamides | Propachlor |
| Fatty Acid Synthesis | | |
| Inhibition of Very Long-Chain | α-Chloroacetamides | Propisochlor |
| Fatty Acid Synthesis | | |
| Inhibition of Very Long-Chain | α-Chloroacetamides | Prynachlor |
| Fatty Acid Synthesis | | |
| Inhibition of Very Long-Chain | α-Chloroacetamides | Thenylchlor |
| Fatty Acid Synthesis | | |
| Inhibition of Very Long-Chain | α-Oxyacetamides | Mefenacet |
| Fatty Acid Synthesis | | |
| Inhibition of Very Long-Chain | α-Oxyacetamides | Flufenacet |
| Fatty Acid Synthesis | | |
| Inhibition of Very Long-Chain | Thiocarbamates | Butylate |
| Fatty Acid Synthesis | | |
| Inhibition of Very Long-Chain | Thiocarbamates | Cycloate |
| Fatty Acid Synthesis | | |
| Inhibition of Very Long-Chain | Thiocarbamates | Dimepiperate |
| Fatty Acid Synthesis | | |
| Inhibition of Very Long-Chain | Thiocarbamates | EPTC |
| Fatty Acid Synthesis | | |
| Inhibition of Very Long-Chain | Thiocarbamates | Esprocarb |
| Fatty Acid Synthesis | | |
| Inhibition of Very Long-Chain | Thiocarbamates | Molinate |
| Fatty Acid Synthesis | | |
| Inhibition of Very Long-Chain | Thiocarbamates | Orbencarb |
| Fatty Acid Synthesis | | |
| Inhibition of Very Long-Chain | Thiocarbamates | Pebulate |
| Fatty Acid Synthesis | | |
| Inhibition of Very Long-Chain | Thiocarbamates | Prosulfocarb |
| Fatty Acid Synthesis | | |
| Inhibition of Very Long-Chain | Thiocarbamates | Thiobencarb (=Benthiocarb) |
| Fatty Acid Synthesis | | |
| Inhibition of Very Long-Chain | Thiocarbamates | Tiocarbazil |
| Fatty Acid Synthesis | | |
| Inhibition of Very Long-Chain | Thiocarbamates | Tri-allate |
| Fatty Acid Synthesis | | |
| Inhibition of Very Long-Chain | Thiocarbamates | Vernolate |
| Fatty Acid Synthesis | | |
| Inhibition of Very Long-Chain | Benzofurans | Benfuresate |
| Fatty Acid Synthesis | | |
| Inhibition of Very Long-Chain | Benzofurans | Ethofumesate |
| Fatty Acid Synthesis | | |
| Auxin Mimics | Pyridine-carboxylates | Picloram |
| Auxin Mimics | Pyridine-carboxylates | Clopyralid |
| Auxin Mimics | Pyridine-carboxylates | Aminopyralid |
| Auxin Mimics | Pyridine-carboxylates | Halauxifen |
| Auxin Mimics | Pyridine-carboxylates | Florpyrauxifen |
| Auxin Mimics | Pyridyloxy-carboxylates | Triclopyr |
| Auxin Mimics | Pyridyloxy-carboxylates | Fluroxypyr |
| Auxin Mimics | Phenoxy-carboxylates | 2,4,5-T |
| Auxin Mimics | Phenoxy-carboxylates | 2,4-D |
| Auxin Mimics | Phenoxy-carboxylates | 2,4-DB |
| Auxin Mimics | Phenoxy-carboxylates | Clomeprop |
| Auxin Mimics | Phenoxy-carboxylates | Dichlorprop |
| Auxin Mimics | Phenoxy-carboxylates | Fenoprop |
| Auxin Mimics | Phenoxy-carboxylates | Mecoprop |
| Auxin Mimics | Phenoxy-carboxylates | MCPA |
| Auxin Mimics | Phenoxy-carboxylates | MCPB |
| Auxin Mimics | Benzoates | Dicamba |
| Auxin Mimics | Benzoates | Chloramben |
| Auxin Mimics | Benzoates | TBA |
| Auxin Mimics | Quinoline-carboxylates | Quinclorac |
| Auxin Mimics | Quinoline-carboxylates | Quinmerac |
| Auxin Mimics | Pyrimidine-carboxylates | Aminocyclopyrachlor |
| Auxin Mimics | Other | Benazolin-ethyl |
| Auxin Mimics | Phenyl carboxylates | Chlorfenac = fenac |
| Auxin Mimics | Phenyl carboxylates | Chlorfenprop |
| Auxin Transport Inhibitor | Aryl-carboxylates | Naptalam |
| Auxin Transport Inhibitor | Aryl-carboxylates | Diflufenzopyr-sodium |
| Inhibition of Fatty Acid | Benzyl ether | Cinmethylin |
| Thioesterase | | |
| Inhibition of Fatty Acid | Benzyl ether | Methiozolin |
| Thioesterase | | |
| Inhibition of Serine-Threonine | Other | Endothal |
| Protein Phosphatase | | |
| Inhibition of Solanesyl | Diphenyl ether | Aclonifen |
| Diphosphate Synthase | | |
| Inhibition of Lycopene | Triazole | Amitrole |
| Cyclase | | |
| Unknown | | Bromobutide |
| Unknown | | Cumyluron |
| Unknown | | Difenzoquat |
| Unknown | | DSMA |
| Unknown | | Dymron = Daimuron |
| Unknown | | Etobenzanid |
| Unknown | Arylaminopropionic acid | Flamprop-m |
| Unknown | | Fosamine |
| Unknown | | Methyldymron |
| Unknown | | Monalide |
| Unknown | | MSMA |
| Unknown | | Oleic acid |
| Unknown | | Oxaziclomefone |
| Unknown | | Pelargonic acid |
| Unknown | | Pyributicarb |
| Unknown | | Quinoclamine |
| Unknown | Acetamides | Diphenamid |
| Unknown | Acetamides | Naproanilide |
| Unknown | Acetamides | Napropamide |
| Unknown | Benzamide | Tebutam |
| Unknown | Phosphorodithioate | Bensulide |
| Unknown | Chlorocarbonic acids | Dalapon |
| Unknown | Chlorocarbonic acids | Flupropanate |
| Unknown | Chlorocarbonic acids | TCA |
| Unknown | Trifluoromethanesulfonanilides | Mefluidide |
| Unknown | Trifluoromethanesulfonanilides | Perfluidone |
| Unknown | | CAMA |
| Unknown | | Cacodylic acid |

APPENDIX 3

| | Sub-group, class or | |
|---|---|---|
| Main Group and Primary Site of | exemplifying Active | |
| Action | Ingredient | Active Ingredients |
| 1 | 1A | Alanycarb, Aldicarb, Bendiocarb, Benfuracarb, Butocarboxim, |
| Acetylcholinesterase (AChE) | Carbamates | Butoxycarboxim, Carbaryl, Carbofuran, Carbosulfan, |
| inhibitors | | Ethiofencarb, Fenobucarb, Formetanate, Furathiocarb, |
| Nerve action | | Isoprocarb, Methiocarb, Methomyl, Metolcarb, Oxamyl, |
| {Strong evidence that action at this | | Pirimicarb, Propoxur, Thiodicarb, Thiofanox, |
| protein is responsible for insecticidal | | Triazamate, Trimethacarb, XMC, Xylylcarb |
| effects} | 1B | Acephate, Azamethiphos, Azinphos-ethyl, Azinphos- |
| | Organophosphates | methyl, Cadusafos, Chlorethoxyfos, Chlorfenvinphos, |
| | | Chlormephos, Chlorpyrifos, Chlorpyrifos-methyl, |
| | | Coumaphos, Cyanophos, Demeton-S-methyl, Diazinon, |
| | | Dichlorvos/DDVP, Dicrotophos, Dimethoate, |
| | | Dimethylvinphos, Disulfoton, EPN, Ethion, Ethoprophos, |
| | | Famphur, Fenamiphos, Fenitrothion, Fenthion, |
| | | Fosthiazate, Heptenophos, Imicyafos, Isofenphos, |
| | | Isopropyl O-(methoxyaminothio-phosphoryl) salicylate, |
| | | Isoxathion, Malathion, Mecarbam, Methamidophos, |
| | | Methidathion, Mevinphos, Monocrotophos, Naled, |
| | | Omethoate, Oxydemeton-methyl, Parathion, Parathion- |
| | | methyl, Phenthoate, Phorate, Phosalone, Phosmet, |
| | | Phosphamidon, Phoxim, Pirimiphos- methyl, Profenofos, |
| | | Propetamphos, Prothiofos, Pyraclofos, Pyridaphenthion, |
| | | Quinalphos, Sulfotep, Tebupirimfos, Temephos, Terbufos, |
| | | Tetrachlorvinphos, Thiometon, Triazophos, Trichlorfon, |
| | | Vamidothion |
| 2 | 2A | Chlordane, Endosulfan |
| GABA-gated chloride channel blockers | Cyclodiene | |
| Nerve action | Organochlorines | |
| {Strong evidence that action at this | 2B | Ethiprole, Fipronil |
| protein is responsible for insecticidal | Phenylpyrazoles (Fiproles) | |
| effects} | | |
| 3 | 3A | Acrinathrin, Allethrin, d-cis-trans Allethrin, d- trans Allethrin, |
| Sodium channel modulators | Pyrethroids Pyrethrins | Bifenthrin, Bioallethrin, Bioallethrin S-cyclopentenyl isomer, |
| Nerve action | | Bioresmethrin, Cycloprothrin, Cyfluthrin, beta- Cyfluthrin, |
| {Strong evidence that action at this | | Cyhalothrin, lambda-Cyhalothrin, gamma-Cyhalothrin, |
| protein is responsible for insecticidal | | Cypermethrin, alpha- Cypermethrin, beta-Cypermethrin, |
| effects} | | theta- cypermethrin, zeta-Cypermethrin, Cyphenothrin, |
| | | (1R)-trans-isomers], Deltamethrin, Empenthrin (EZ)-(1R)- |
| | | isomers], Esfenvalerate, Etofenprox, Fenpropathrin, |
| | | Fenvalerate, Flucythrinate, Flumethrin, tau-Fluvalinate, |
| | | Halfenprox, Imiprothrin, Kadethrin, Permethrin, Phenothrin |
| | | [(1R)-trans-isomer], Prallethrin, Pyrethrins (pyrethrum), |
| | | Resmethrin, Silafluofen, Tefluthrin, Tetramethrin, |
| | | Tetramethrin [(1R)-isomers], Tralomethrin, Transfluthrin, |
| | 3B | DDT |
| | DDT | Methoxychlor |
| | Methoxychlor | |
| 4 | 4A | Acetamiprid, Clothianidin, Dinotefuran, |
| Nicotinic acetylcholine receptor | Neonicotinoids | Imidacloprid, Nitenpyram, Thiacloprid, Thiamethoxam, |
| (nAChR) competitive modulators | 4B | Nicotine |
| Nerve action | Nicotine | |
| {Strong evidence that action at one or | 4C | Sulfoxaflor |
| more of this class of protein is | Sulfoximines | |
| responsible for insecticidal effects} | 4D | Flupyradifurone |
| | Butenolides | |
| | 4E | Triflumezopyrim |
| | Mesoionics | |
| | 4F | Flupyrimin |
| | Pyridylidenes | |
| 5 | Spinosyns | Spinetoram, Spinosad |
| Nicotinic acetylcholine receptor | | |
| (nAChR) allosteric modulators - Site I | | |
| Nerve action | | |
| {Strong evidence that action at one or | | |
| more of this class of protein is | | |
| responsible for insecticidal effects} | | |
| 6 | Avermectins, | Abamectin, Emamectin benzoate, Lepimectin, Milbemectin |
| Glutamate-gated chloride | Milbemycins | |
| channel (GluCl) allosteric | | |
| modulators | | |
| Nerve and muscle action | | |
| {Strong evidence that action at one or | | |
| more of this class of protein is | | |
| responsible for insecticidal effects} | | |
| 7 | 7A | Hydroprene, Kinoprene, Methoprene |
| Juvenile hormone mimics | Juvenile hormone | |
| Growth regulation | analogues | |
| {Target protein responsible for biological | 7B | Fenoxycarb |
| activity is unknown, or uncharacterized} | Fenoxycarb | |
| | 7C | Pyriproxyfen |
| | Pyriproxyfen | |
| 8 * | 8A | Methyl bromide and other alkyl halides |
| Miscellaneous non-specific (multi- | Alkyl halides | |
| site) inhibitors | 8B | Chloropicrin |
| | Chloropicrin | |
| | 8C | Cryolite (Sodium aluminum fluoride), Sulfuryl fluoride |
| | Fluorides | |
| | 8D | Borax, Boric acid, Disodium octaborate, Sodium borate, |
| | Borates | Sodium metaborate |
| | 8E | Tartar emetic |
| | Tartar emetic | |
| | 8F | Dazomet, Metam |
| | Methyl isothiocyanate | |
| | generators | |
| 9 | 9B | Pymetrozine, Pyrifluquinazon |
| Chordotonal organ TRPV | Pyridine azomethine | |
| channel modulators Nerve action | derivatives | |
| {Strong evidence that action at one or | 9D | Afidopyropen |
| more of this class of proteins is | Pyropenes | |
| responsible for insecticidal effects} | | |
| 10 | 10A | Clofentezine, Diflovidazin, Hexythiazox |
| Mite growth inhibitors affecting | Clofentezine Diflovidazin | |
| CHS1 | Hexythiazox | |
| Growth regulation | 10B | Etoxazole |
| {Strong evidence that action at one or | Etoxazole | |
| more of this class of proteins is | | |
| responsible for insecticidal effects} | | |
| 11 | 11A | Bacillus thuringiensis subsp. israelensis Bacillus |
| Microbial disruptors of insect midgut | Bacillus thuringiensis and | thuringiensis subsp. aizawai Bacillus thuringiensis |
| membranes | the insecticidal proteins | subsp. kurstaki Bacillus thuringiensis subsp. |
| (Includes transgenic crops expressing | they produce | tenebrionis |
| Bacillus thuringiensis toxins, however | | B.t. crop proteins: (* Please see footnote) Cry1Ab, Cry1Ac, |
| specific guidance for resistance | | Cry1Fa, Cry1A.105, Cry2Ab, Vip3A, mCry3A, Cry3Ab, |
| management of transgenic crops is not | | Cry3Bb, Cry34Ab1/Cry35Ab1 |
| based on rotation of modes of action) | | |
| | 11B | Bacillus sphaericus |
| | Bacillus sphaericus | |
| 12 | 12A | Diafenthiuron |
| Inhibitors of mitochondrial ATP | Diafenthiuron | |
| synthase | 12B | Azocyclotin, Cyhexatin, Fenbutatin oxide |
| Energy metabolism | Organotin miticides | |
| {Compounds affect the function of this | 12C | Propargite |
| protein, but it is not clear that this | Propargite | |
| is what leads to biological activity} | 12D | Tetradifon |
| | Tetradifon | |
| 13 * | Pyrroles Dinitrophenols | Chlorfenapyr DNOC |
| Uncouplers of oxidative | Sulfluramid | Sulfluramid |
| phosphorylation via disruption of | | |
| the proton gradient | | |
| Energy metabolism | | |
| 14 | Nereistoxin analogues | Bensultap, Cartap hydrochloride, Thiocyclam, |
| Nicotinic acetylcholine receptor | | Thiosultap-sodium |
| (nAChR) channel blockers | | |
| Nerve action | | |
| {Compounds affect the function of this | | |
| protein, but it is not clear that this | | |
| is what leads to biological activity} | | |
| 15 | Benzoylureas | Bistrifluron, Chlorfluazuron, Diflubenzuron, Flucycloxuron, |
| Inhibitors of chitin biosynthesis | | Flufenoxuron, Hexaflumuron, Lufenuron, Novaluron, |
| affecting CHS1 | | Noviflumuron, Teflubenzuron, Triflumuron |
| Growth regulation | | |
| {Strong evidence that action at one or | | |
| more of this class of proteins is | | |
| responsible for insecticidal effects} | | |
| 16 | Buprofezin | Buprofezin |
| Inhibitors of chitin biosynthesis, type 1 | | |
| Growth regulation | | |
| {Target protein responsible for biological | | |
| activity is unknown, or uncharacterized} | | |
| 17 | Cyromazine | Cyromazine |
| Moulting disruptors, Dipteran | | |
| Growth regulation | | |
| {Target protein responsible for biological | | |
| activity is unknown, or uncharacterized} | | |
| 18 | Diacylhydrazines | Chromafenozide, Halofenozide, Methoxyfenozide, |
| Ecdysone receptor agonists | | Tebufenozide |
| Growth regulation | | |
| {Strong evidence that action at this | | |
| protein is responsible for insecticidal | | |
| effects} | | |
| 19 | Amitraz | Amitraz |
| Octopamine receptor agonists | | |
| Nerve action | | |
| {Good evidence that action at one or | | |
| more of this class of protein is | | |
| responsible for insecticidal effects} | | |
| 20 | 20A | Hydramethylnon |
| Mitochondrial complex III electron | Hydramethylnon | |
| transport inhibitors - Qo site | 20B | Acequinocyl |
| Energy metabolism | Acequinocyl | |
| {Good evidence that action at this | 20C | Fluacrypyrim |
| protein complex is responsible for | Fluacrypyrim | |
| insecticidal effects} | 20D | Bifenazate |
| | Bifenazate | |
| 21 | 21A | Fenazaquin, Fenpyroximate, Pyridaben, Pyrimidifen, |
| Mitochondrial complex I electron | METI acaricides and | Tebufenpyrad, Tolfenpyrad |
| transport inhibitors | insecticides | |
| Energy metabolism | 21B | Rotenone (Derris) |
| {Good evidence that action at this | Rotenone | |
| protein complex is responsible for | | |
| insecticidal effects} | | |
| 22 | 22A | Indoxacarb |
| Voltage-dependent sodium | Oxadiazines | |
| channel blockers | 22B | Metaflumizone |
| Nerve action | Semicarbazones | |
| {Good evidence that action at this | | |
| protein complex is responsible for | | |
| insecticidal effects} | | |
| 23 | Tetronic and Tetramic acid | Spirodiclofen, Spiromesifen, Spiropidion, Spirotetramat |
| Inhibitors of acetyl CoA carboxylase | derivatives | |
| Lipid synthesis, growth regulation | | |
| {Good evidence that action at this | | |
| protein is responsible for insecticidal | | |
| effects} | | |
| 24 | 24A | Aluminium phosphide, Calcium phosphide, Phosphine, Zinc |
| Mitochondrial complex IV electron | Phosphides | phosphide |
| transport inhibitors | 24B | Calcium cyanide, Potassium cyanide, Sodium cyanide |
| Energy metabolism | Cyanides | |
| {Good evidence that action at this | | |
| protein complex is responsible for | | |
| insecticidal effects} | | |
| 25 | 25A | Cyenopyrafen, Cyflumetofen |
| Mitochondrial complex II electron | Beta-ketonitrile | |
| transport inhibitors | derivatives | |
| Energy metabolism | 25B | Pyflubumide |
| {Good evidence that action at this | Carboxanilides | |
| protein complex is responsible for | | |
| insecticidal effects} | | |
| 28 | Diamides | Chlorantraniliprole, Cyantraniliprole, Cyclaniliprole |
| Ryanodine receptor modulators | | Flubendiamide, Tetraniliprole |
| Nerve and muscle action | | |
| {Strong evidence that action at this | | |
| protein complex is responsible for | | |
| insecticidal effects} | | |
| 29 | Flonicamid | Flonicamid |
| Chordotonal organ modulators - | | |
| undefined target site | | |
| Nerve action | | |
| (Modulation of chordotonal organ | | |
| function has been clearly demonstrated, | | |
| but the specific target protein(s) | | |
| responsible for biological activity are | | |
| distinct from Group 9 and remain | | |
| undefined) | | |
| 30 | Meta-diamides Isoxazolines | Broflanilide |
| GABA-gated chloride channel allosteric | | Fluxametamide, Isocyloseram |
| modulators | | |
| Nerve action | | |
| {Strong evidence that action at this | | |
| protein complex is responsible for | | |
| insecticidal effects} | | |
| 31 | Granuloviruses (GVs) | Cydia pomonella GV |
| Baculoviruses | | Thaumatotibia leucotreta GV |
| Host-specific occluded | Nucleopolyhedroviruse s | Anticarsia gemmatalis MNPV |
| pathogenic viruses | (NPVs) | Helicoverpa armigera NPV |
| (Midgut epithelial columnar cell | | |
| membrane target site - undefined) | | |
| 32 | GS-omega/kappa | GS-omega/kappa HXTX-Hv1a peptide |
| Nicotinic Acetylcholine Receptor | HXTX-Hv1a peptide | |
| (nAChR) Allosteric Modulators - Site II | | |
| Nerve action | | |
| {Strong evidence that action at one or | | |
| more of this class of protein is | | |
| responsible for insecticidal effects} | | |
| 33 | Acynonapyr | Acynonapyr |
| Calcium-activated potassium | | |
| channel (KCa2) modulators | | |
| Nerve action | | |
| {Strong evidence that action at this | | |
| protein is responsible for insecticidal | | |
| effects} | | |
| 34 | Flometoquin | Flometoquin |
| Mitochondrial complex III electron | | |
| transport inhibitors - Qi site | | |
| Energy metabolism | | |
| {Modulation of this protein complex has | | |
| been clearly demonstrated and the specific | | |
| target site responsible for biological | | |
| activity is distinct from Group 20} | | |
| UN* | Azadirachtin | Azadirachtin |
| Compounds of unknown or uncertain | Benzoximate | Benzoximate |
| MoA | Benzpyrimoxan | Benzpyrimoxan |
| {Target protein responsible for biological | Bromopropylate | Bromopropylate |
| activity is unknown, or uncharacterized} | Chinomethionat | Chinomethionat |
| | Dicofol | Dicofol |
| | Lime sulfur | Lime sulfur |
| | Mancozeb | Mancozeb |
| | Pyridalyl | Pyridalyl |
| | Sulfur | Sulfur |
| UNB* | | Burkholderia spp |
| Bacterial agents (non-Bt) of unknown or | | Wolbachia pipientis (Zap) |
| uncertain MoA | | |
| {Target protein responsible for biological | | |
| activity is unknown or uncharacterized} | | |
| UNE* | | Chenopodium ambrosioides near ambrosioides |
| Botanical essence including | | extract |
| synthetic, extracts and unrefined | | Fatty acid monoesters with glycerol or |
| oils with unknown or uncertain MoA | | propanediol Neem oil |
| {Target protein responsible for biological | | |
| activity is unknown, or uncharacterized} | | |
| UNF* | | Beauveria bassiana strains |
| Fungal agents of unknown or uncertain MoA | | Metarhizium anisopliae strain F52 |
| {Target protein responsible for biological | | Paecilomyces fumosoroseus Apopka strain 97 |
| activity is unknown, or uncharacterized} | | |
| UNM* | | Diatomaceous earth |
| Non-specific mechanical and physical | | Mineral oil |
| disruptors | | |
| {Target protein responsible for biological | | |
| activity is unknown, or uncharacterized} | | |

In view of the many possible embodiments to which the principles of the present disclosure may be applied, it should be recognized that the illustrated embodiments are only preferred examples and should not be taken as limiting the scope of the present disclosure. Rather, the scope is defined by the following claims. We therefore claim as our invention all that comes within the scope and spirit of these claims.

We claim:

1. A water-dispersible granule, comprising:
particles of a first agriculturally active compound having a structure 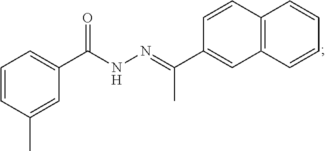 [SMILES: C/C(=N\NC(=O)c1cccc(C)c1)c1ccc2ccccc2c1]
and a dispersant;
wherein the particles of the first active compound have a volume-weighted median particle size ranging from greater than 0.01 microns to 20 microns.

2. The water-dispersible granule of claim 1, further comprising a dust suppressant.

3. The water-dispersible granule of claim 1, wherein the particles of the first agriculturally active compound are present in an amount ranging from 5 wt % to 90 wt %.

4. The water-dispersible granule of claim 2, wherein the dust suppressant is present in an amount ranging from 0.5 wt % to 15 wt %.

5. The water-dispersible granule of any claim 1, wherein the dispersant is present in an amount ranging from 1 wt % to 30 wt %.

6. The water-dispersible granule of claim 1, wherein the particles of the first agriculturally active compound are present in an amount ranging from 30 wt % to 85 wt %.

7. The water-dispersible granule of claim 6, wherein the particles of the first agriculturally active compound are present in an amount ranging from 30 wt % to 40 wt %.

8. The water-dispersible granule of claim 6, wherein the particles of the first agriculturally active compound are present in an amount ranging from 70 wt % to 85 wt %.

9. The water-dispersible granule of claim 2, wherein the dust suppressant is a liquid or a low-melting point solid.

10. The water-dispersible granule of claim 2, wherein the dust suppressant is selected from a surfactant, a wax, a natural oil, a chemically-modified natural oil, a low-volatility organic solvent, or a combination thereof.

11. The water-dispersible granule of claim 1, wherein the dispersant is a high molecular weight dispersant.

12. The water-dispersible granule of claim 1, wherein the dispersant has a molecular weight ranging from 400 Daltons to 2,000,000 Daltons.

13. The water-dispersible granule of claim 1, wherein the dispersant has a molecular weight ranging from 1,000 Daltons to 100,000 Daltons.

14. The water-dispersible granule of claim 1, wherein the dispersant is an anionic dispersant, a cationic dispersant, a non-ionic dispersant, or a combination thereof.

15. The water-dispersible granule of claim 14, wherein the dispersant is an anionic dispersant.

16. The water-dispersible granule of claim 14, wherein the dispersant is a nonionic dispersant.

17. The water-dispersible granule of claim 1, wherein the dispersant is selected from a homo-polymeric dispersant, a random or statistical copolymer, a block copolymer, or a combination thereof.

18. The water-dispersible granule of claim 1, wherein the dispersant is selected from polyacrylic acid, polyvinyl alcohol, polyvinyl pyrrolidone, polystyrene sulfonate, polyvinyl sulfonate, polyethyleneimine, polyethylene glycol/polyisobutylene succinic acid, vinylpyrrolidone/vinylcaprolactam, polyethyleneoxide/polypropyleneoxide, fatty acid/polyethyleneoxide, polyethoxylated alcohols, polyethoxylated diamines, naphthalene sulfonate formaldehyde condensate, lignosulfonate, ethoxylated lignosulfonate, or a combination thereof.

19. The water-dispersible granule of claim 1, wherein the dispersant is present in an amount ranging from 3 wt % to 20 wt %.

20. The water-dispersible granule of claim 1, further comprising a binding agent.

21. The water-dispersible granule of claim 20, wherein the binding agent is present in an amount ranging from 5 wt % to 30 wt %.

22. The water-dispersible granule of claim 20, wherein the binding agent is present in an amount ranging from 10 wt % to 25 wt %.

23. The water-dispersible granule of claim 20, wherein the binding agent is selected from a compound having a melting point above 100° C. and that is fully dissolved in water during the granulation process.

24. The water-dispersible granule of claim 1, further comprising one or more inert carriers, diluents, or combinations thereof.

25. The water-dispersible granule of claim 24, wherein the inert carrier or diluent is included in an amount sufficient to make up a weight balance of the water-dispersible granule to a total of 100 wt %.

26. The water-dispersible granule of claim 24, wherein the inert carrier or diluent is selected from starch, wood flour, cellulose, chemically-modified cellulose, or a mineral material.

27. The water-dispersible granule of claim 26, wherein the mineral material is selected from clay, mica, perlite, talc, gypsum, silica, alumina, chalk, diatomaceous earth, or combinations thereof.

28. The water-dispersible granule of claim 1, further comprising an antifoam.

29. The water-dispersible granule of claim 28, wherein the antifoam is an emulsion of silicone oil.

30. The water-dispersible granule of claim 28, wherein the antifoam is present in an amount ranging from 0.01 wt % to 1 wt %.

31. The water-dispersible granule of claim 1, wherein the particles of the first agriculturally active compound are milled prior to granulation such that the particles have a volume-weighted median particle size, as measured by light scattering after dilution and dispersion of the WDG into water, ranging from greater than 0.01 microns to about 15 microns.

32. The water-dispersible granule of claim 1, wherein the particles of the first agriculturally active compound are milled prior to granulation such that the particles have a volume-weighted median particle size, as measured by light scattering after dilution and dispersion of the WDG into water, ranging from greater than 0.01 microns to 10 microns.

33. The water-dispersible granule of claim 1, wherein the particles of the first agriculturally active compound are milled prior to granulation such that the particles have a volume-weighted median particle size, as measured by light scattering after dilution and dispersion of the WDG into water, of less than about 7 microns.

34. The water-dispersible granule of claim 1, wherein the particles of the first agriculturally active compound are milled prior to granulation such that the particles have a volume-weighted median particle size, as measured by light scattering after dilution and dispersion of the WDG into water, ranging from greater than 0.01 microns to 5 microns.

35. The water-dispersible granule of claim 31, wherein the particles of the first agriculturally active compound are milled prior to granulation such that the particles have a volume-weighted median particle size, as measured by light scattering after dilution and dispersion of the WDG into water, ranging from greater than 0.01 microns to 2 microns.

36. The water-dispersible granule of claim 1, wherein the particles of the first agriculturally active compound are milled prior to granulation such that the particles have a volume-weighted median particle size, as measured by light scattering after dilution and dispersion of the WDG into water, is about 1 micron.

37. A water-dispersible granule, comprising:
(a) particles of a first agriculturally active compound having a structure 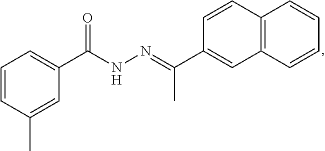 [SMILES: C/C(=N\NC(=O)c1cccc(C)c1)c1ccc2ccccc2c1]
the particles being present in an amount ranging from 5 wt % to 85 wt %; and
(b) 3 wt % to 20 wt % of a high molecular weight dispersant;
wherein the particles of the first agriculturally active compound have a volume-weighted median particle below 2 microns.

38. The water-dispersible granule of claim 37, further comprising 0.5 wt % to 15 wt % of a dust-suppressant selected from a surfactant, a wax, a natural oil, a chemically-modified natural oil, a low-volatility organic solvent, or a combination thereof.

39. The water-dispersible granule of claim 37, having a volume-weighted median particle size, as measured by light scattering after dilution and dispersion of the WDG into water, of about 1 micron.

40. A composition comprising:
the water-dispersible granule of claim 1; and
an additional agriculturally active compound.

41. The composition of claim 40, wherein the additional agriculturally active compound is a fungicide, pesticide, herbicide, insecticide, molluscicide, nematocide or a combination thereof.

42. The composition of claim 40, wherein the additional agriculturally active compound is a fungicide selected from a benzimidazole fungicide, a dicarboximide fungicide, a phenylpyrrole fungicide, an anilinopyrimidine fungicide, a hydroxyanilide fungicide, a carboxamide fungicide, a phenyl amide fungicide, a phosphonate fungicide, a cinnamic acid fungicide, an oxysterol binding protein inhibitor (OSBPI) fungicide, a triazole carboxamide fungicide, a carbamate fungicide, a Group 27 fungicide, a benzamide fungicide, a demethylation-inhibiting piperazine fungicide, a demethylation inhibiting pyrimidine fungicide, a demethylation inhibiting azole fungicide, a morpholine fungicide, a Group U6 fungicide, a Group 50 fungicide, a strobilurin fungicide, quinoline fungicide, an inorganic fungicide, a copper ammonium complex fungicide, a sulfur fungicide, a lime sulfur fungicide, an ethylenebisdithiocarbamate (EBDC) fungicide, an EBDC-like fungicide, an aromatic hydrocarbon fungicide, a chloronitrile fungicide, a phthalimide fungicide, a Qol fungicide, a Oil fungicide, a guanidine fungicide, a polyoxin fungicide, a Group 29 fungicide, a thiazolidine fungicide, or a combination thereof.

43. The composition of claim 40, wherein the agriculturally active compound is a fungicide selected from benomyl, thiabendazole, thiophanate-methyl, iprodione, vinclozolin, fludioxonil, cyprodinil, pyrimethanil, fenhexamid, fenpyrazamine, boscalid, carboxin, fluopyram, flutolanil, fluxapyroxad, inpyrfluxam, isofetamid, oxycarboxin, penthiopyrad, pydiflumetofen, solatenol (benzovindiflupyr), mefenoxam, metalaxyl, oxadixyl, aluminum tris, Phosphorous Acid, dimethomorph, mandipropamid, oxathiapiprolin, ethaboxam, cymoxanil, propamocarb, fluopicolide, triforine, fenarimol, imazalil, triflumizole, cyproconazole, difenoconazole, fenbuconazole, flutriafol, mefentrifluconazole, metconazole, ipconazole, myclobutanil, propiconazole, prothioconazole, tebuconazole, tetraconazole, triadimefon, triadimenol, triticonazole, piperalin, spiroxamine, cyflufenamid, metrafenone, pyriofenone, azoxystrobin, famoxadone, fenamidone, fluoxastrobin, kresoxim-methyl, mandestrobin, picoxystrobin, pyraclostrobin, trifloxystrobin, quinoxyfen, bordeaux, copper ammonium complex, copper hydroxide, copper oxide, copper oxychloride, copper sulfate, sulfur, Ca polysulfides, mancozeb, maneb, metiram, ferbam, thiram, ziram, dicloran (DCNA), etridizole, pentachloronitrobenzene, chlorothalonil, captan, dodine, cyazofamid, polyoxin, fluazinam, flutianil, or a combination thereof.

44. The composition of claim 40, further comprising water.

45. The composition of claim 44, wherein the water-dispersible granule is present in the composition in an amount sufficient to enhance the biological effect of the additional agriculturally active compound, such that the total amount of the additional agriculturally active compound in the composition that is applied to crops or agricultural produce is lower than would typically be required and/or recommended to provide the same biological effect in a composition that does not comprise the water-dispersible granule.

46. The composition of claim 45, wherein the additional agriculturally active compound is a fungicide, pesticide, herbicide, insecticide, molluscicide, nematocide or a combination thereof.

47. The composition of claim 45, wherein the additional agriculturally active compound is a fungicide selected from a benzimidazole fungicide, a dicarboximide fungicide, a phenylpyrrole fungicide, an anilinopyrimidine fungicide, a hydroxyanilide fungicide, a carboxamide fungicide, a phenyl amide fungicide, a phosphonate fungicide, a cinnamic acid fungicide, an oxysterol binding protein inhibitor (OSBPI) fungicide, a triazole carboxamide fungicide, a carbamate fungicide, a Group 27 fungicide, a benzamide fungicide, a demethylation-inhibiting piperazine fungicide, a demethylation inhibiting pyrimidine fungicide, a demethylation inhibiting azole fungicide, a morpholine fungicide, a Group U6 fungicide, a Group 50 fungicide, a strobilurin fungicide, quinoline fungicide, an inorganic fungicide, a copper ammonium complex fungicide, a sulfur fungicide, a lime sulfur fungicide, an ethylenebisdithiocarbamate (EBDC) fungicide, an EBDC-like fungicide, an aromatic hydrocarbon fungicide, a chloronitrile fungicide, a phthalimide fungicide, a Qol fungicide, a Oil fungicide, a guanidine fungicide, a polyoxin fungicide, a Group 29 fungicide, a thiazolidine fungicide, or a combination thereof.

48. The composition of claim 45, wherein the additional agriculturally active compound is a fungicide selected from benomyl, thiabendazole, thiophanate-methyl, iprodione, vinclozolin, fludioxonil, cyprodinil, pyrimethanil, fenhexamid, fenpyrazamine, boscalid, carboxin, fluopyram, flutolanil, fluxapyroxad, inpyrfluxam, isofetamid, oxycarboxin, penthiopyrad, pydiflumetofen, solatenol (benzovindiflupyr), mefenoxam, metalaxyl, oxadixyl, aluminum tris, Phosphorous Acid, dimethomorph, mandipropamid, oxathiapiprolin, ethaboxam, cymoxanil, propamocarb, fluopicolide, triforine, fenarimol, imazalil, triflumizole, cyproconazole, difenoconazole, fenbuconazole, flutriafol, mefentrifluconazole, metconazole, ipconazole, myclobutanil, propiconazole, prothioconazole, tebuconazole, tetraconazole, triadimefon, triadimenol, triticonazole, piperalin, spiroxamine, cyflufenamid, metrafenone, pyriofenone, azoxystrobin, famoxadone, fenamidone, fluoxastrobin, kresoxim-methyl, mandestrobin, picoxystrobin, pyraclostrobin, trifloxystrobin, quinoxyfen, bordeaux, copper ammonium complex, copper hydroxide, copper oxide, copper oxychloride, copper sulfate, sulfur, Ca polysulfides, mancozeb, maneb, metiram, ferbam, thiram, ziram, dicloran (DCNA), etridizole, pentachloronitrobenzene, chlorothalonil, captan, dodine, cyazofamid, polyoxin, fluazinam, flutianil, or a combination thereof.

49. A method of using the composition of claim 40, comprising applying the composition to a plant, a part of a plant, a seed, soil where a plant is or will be growing, or soil where a seed has been or will be sown.

50. A method for controlling or preventing fungal growth, comprising applying the composition of claim 40 to a site that has a fungal growth or that is at risk of developing a fungal growth.

51. A method for controlling or preventing fungal growth, comprising:
combining the composition of claim 40 with water to form a fine particle suspension comprising particles of the first agriculturally active compound; and
applying the fine particle suspension to a site that has a fungal growth or that is at risk of developing a fungal growth.

52. The method of claim 51, wherein the method further comprises combining the water-dispersible granule and the additional agriculturally active compound to form the composition.

53. The method of claim 52, wherein combining the water-dispersible granule and the agriculturally active compound comprises adding an amount of the agriculturally active compound to the water-dispersible granule that is less than an amount of the agriculturally active compound that is recommended for use in the absence of the water-dispersible granule.

54. A method for making a dispersion comprising the water-dispersible granule according to claim 1, the method comprising:
combining the water-dispersible granule with water and an additional agriculturally active compound to provide a mixture, wherein each of the water-dispersible granule and the additional agriculturally active compound is included at a concentration sufficient for providing a biological effect when the mixture is applied to agricultural crops or produce.

55. The method of claim 54, wherein the concentration of the water-dispersible granule in the mixture ranges from 0.01 wt % to 10 wt %.

56. The method of claim 54, wherein the method further comprises adding an adjuvant to the mixture.

57. The method of claim 54, wherein the additional agriculturally active compound is selected from an acaricide, a fungicide, an herbicide, an insecticide, a molluscicide, a nematocide, or a combination thereof.

58. The method of claim 54, wherein the additional agriculturally active compound is selected from a benzimidazole fungicide, a dicarboximide fungicide, a phenylpyrrole fungicide, an anilinopyrimidine fungicide, a hydroxyanilide fungicide, a carboxamide fungicide, a phenyl amide fungicide, a phosphonate fungicide, a cinnamic acid fungicide, an oxysterol binding protein inhibitor (OSBPI) fungicide, a triazole carboxamide fungicide, a carbamate fungicide, a Group 27 fungicide, a benzamide fungicide, a demethylation-inhibiting piperazine fungicide, a demethylation inhibiting pyrimidine fungicide, a demethylation inhibiting azole fungicide, a morpholine fungicide, a Group U6 fungicide, a Group 50 fungicide, a strobilurin fungicide, quinoline fungicide, an inorganic fungicide, a copper ammonium complex fungicide, a sulfur fungicide, a lime sulfur fungicide, an ethylenebisdithiocarbamate (EBDC) fungicide, an EBDC-like fungicide, an aromatic hydrocarbon fungicide, a chloronitrile fungicide, a phthalimide fungicide, a Oil fungicide, a guanidine fungicide, a polyoxin fungicide, a Group 29 fungicide, a thiazolidine fungicide, or a combination thereof.

59. The method of claim 54, wherein the additional agriculturally active compound is selected from benomyl, thiabendazole, thiophanate-methyl, iprodione, vinclozolin, fludioxonil, cyprodinil, pyrimethanil, fenhexamid, fenpyrazamine, boscalid, carboxin, fluopyram, flutolanil, fluxapyroxad, inpyrfluxam, isofetamid, oxycarboxin, penthiopyrad, pydiflumetofen, solatenol (benzovindiflupyr), mefenoxam, metalaxyl, oxadixyl, aluminum tris, Phosphorous Acid, dimethomorph, mandipropamid, oxathiapiprolin, ethaboxam, cymoxanil, propamocarb, fluopicolide, triforine, fenarimol, imazalil, triflumizole, cyproconazole, difenoconazole, fenbuconazole, flutriafol, mefentrifluconazole, metconazole, ipconazole, myclobutanil, propiconazole, prothioconazole, tebuconazole, tetraconazole, triadimefon, triadimenol, triticonazole, piperalin, spiroxamine, cyflufenamid, metrafenone, pyriofenone, azoxystrobin, famoxadone, fenamidone, fluoxastrobin, kresoxim-methyl, mandestrobin, picoxystrobin, pyraclostrobin, trifloxystrobin, quinoxyfen, bordeaux, copper ammonium complex, copper hydroxide, copper oxide, copper oxychloride, copper sulfate, sulfur, Ca polysulfides, mancozeb, maneb, metiram, ferbam, thiram, ziram, dicloran (DCNA), etridizole, pentachloronitrobenzene, chlorothalonil, captan, dodine, cyazofamid, polyoxin, fluazinam, flutianil, or a combination thereof.
